(19) United States
(12) Patent Application Publication
(10) Pub. No.: US 2024/0317779 A1
(43) Pub. Date: Sep. 26, 2024

(54) METAL COMPLEXES HAVING 4-H,6-H OR 8-H DIHYDROAZULENYL LIGANDS AND USE THEREOF

(71) Applicant: UMICORE AG & CO. KG, Hanau-Wolfgang (DE)

(72) Inventors: Tobias VOLLGRAFF, Marburg (DE); Joerg SUNDERMEYER, Marburg (DE); Angelino DOPPIU, Seligenstadt (DE)

(73) Assignee: UMICORE AG & CO. KG, Hanau-Wolfgang (DE)

(21) Appl. No.: 18/262,516

(22) PCT Filed: Feb. 4, 2022
(86) PCT No.: PCT/EP2022/052717

§ 371 Date: Jul. 21, 2023

(30) Foreign Application Priority Data
Feb. 18, 2021 (EP) 21158012.1

(51) Int. Cl. C07F 1/02; B01J 31/16; C07F 1/08; C07F 3/06; C07F 15/00; C07F 15/02; C07F 15/06

(52) U.S. Cl. CPC C07F 1/02; B01J 31/1616; C07F 1/08; C07F 3/06; C07F 15/0053; C07F 15/008; C07F 15/0086; C07F 15/025; C07F 15/065

(57) ABSTRACT

The invention relates to a method for preparing compounds of the general formula M^{A}Yₙ(AzuH) (I), where M^{A}=alkali metal, Y=neutral ligand, n=0, 1, 2, 3, or 4. AzuH is azulene (bicyclo[5.3.0]decapentaene) or an azulene derivative that bears a hydride anion H− in the 4, 6 or 8 position in addition to an H atom. The invention additionally provides compounds obtainable by this method, and a method using such compounds for preparation of complexes of metals of groups 6 to 12. The invention further relates to complexes of middle and later transition metals (groups 6 to 12) which each have at least one H-dihydroazulenyl anion (AzuH)¹−, and to the use of all the aforementioned transition metal complexes as precatalysts or catalysts or electron transfer reagents in a chemical reaction or as precursor compounds for production of a layer containing a metal M, or of a metal layer consisting of the metal M, especially on at least one surface of a substrate. The invention also provides a substrate obtainable by such a method. 25

Homoleptic and heteroleptic metal complexes having anionic ligands derived from bicyclo[5.3.0]decapentaene (azulene) or mono or polysubstituted azulene, i.e., azulene derivatives, and methods for the production thereof are known.

Azulene and azulene derivatives, which, for example, have an alkyl or aryl substituent instead of an H atom in the 4 position, belong to the ortho-anellated aromatic ring systems. They are present as neutral zwitterions.

Anionic ligands derived from azulene or azulene derivatives can be prepared, for example, by the addition of an alkali metal organyl, e.g., methyllithium or phenyllithium, in the 4, 6 or 8 position of an azulene molecule or an azulene derivative. The respective product is an alkali metal dihydroazulenide which, in the 4, 6 or 8 position, bears an organyl group, e.g., a methyl group or a phenyl group, in addition to an H atom. Therefore, an RCH group is present in the C4, C6 or C8 position of the amide scaffold, wherein R is an organyl group.

It should be noted that azulene has a comparable electrophilicity in the 4, 6 and 8 position. Therefore, the formation of regioisomers can occur. Since azulene also has a C₂ᵥ symmetry, the products of the addition reaction are an alkali metal-4-organo-dihydroazulenide and/or an alkali metal-6-organo-dihydroazulenide. The anion in question can be referred to as 4-organo-dihydroazulenyl anion or as 6-organo-dihydroazulenyl anion. More precisely, this is a 3α,4-organo-dihydroazulenyl anion or a 3α,6-organo-dihydroazulenyl anion.

If, instead of an alkali metal organyl, an alkali metal hydride, e.g., lithium hydride, is added nucleophilically in the 4, 6 or 8 position of an azulene molecule or of an azulene derivative, the addition reaction results in an alkali metal diahydroazulenide, which is an H atom and a hydride anion H⁻ in the 4, 6 or 8 position, being present in each case. Therefore, a CH₂ group is present in the C4, C6 or C8 position of the azulene scaffold. In the case of azulene, the respective anion can be referred to as 4-H-dihydroazulenyl anion or as 6-H-dihydroazulenyl anion. More specifically, it is the 3α,4-H-dihydroazulenyl anion or the 3α,6-H-dihydroazulenyl anion.

Irrespective of the substitution pattern, the conjugated pi system is limited to the five-membered ring by the addition of hydride. As a rule, the blue color that is typical for azulene is lost.

Dihydroazulenyl anions, i.e., organo-dihydroazulenyl anions, and H-dihydroazulenyl anions are cyclopentadienyl-like monoanions or derivatives of the cyclopentadienyl anion. Just like the the cyclopentadienyl anion (Cp⁻), they are therefore suitable inter alia as ligands for the preparation of metallocene-type sandwich complexes. With regard to preparation and storage, lithium dihydroazulenides have some advantages in particular with respect to lithium cyclopentadienide (LiCp).

A disadvantage of the chemistry of the cyclopentadienyl ligand, one of the most important ligands of organometallic chemistry, is that it is oil based. The provision of LiCp first comprises the thermal cracking of dicyclopentadiene into its monomer cyclopentadiene in the presence of a catalyst, e.g., iron powder. After this first step, cyclopentadiene must be used quickly or stored in the freezer. Otherwise, it rapidly dimerizes to dicyclopentadiene. In a second step, cyclopentadiene is reacted with a strong base, for example a lithium alkyl, typically the relatively cost-intensive n-butyllithium.

Examples of transition metal complexes which have dihydroazulenyl anions, i.e., cyclopentadienyl-like monoanions or cyclopentadienyl derivatives as ligands, are described inter alia in an overview article by M. R. Churchill. (Prog. Inorg. Chem. 1970, 54-98, chapter IV., section C.)

Knox and Pauson (J. Chem. Soc. 1961, 4610-4615) achieved the in situ preparation of lithium 3α,4-dihydroazulenide in the context of the synthesis of the complex bis(3α,4-dihydroazulenyl) iron(II), which was obtained as a mixture of three isomers. The lithium azulenide was produced by adding a hydride anion to azulene using LiAlH₄ (equimolar) as a hydrogenation reagent. Namely based on a specification by Hafner and Weldes (Liebigs Ann. Chem. 1957, 606, 90-99) for the synthesis of lithium 4-methyl dihydroazulenide.

The long 60-day reaction time and in particular the production of aluminum trihydride (AlH₃) as by-product are disadvantages of the synthesis described by Knox and Pauson. Due to the high reactivity of the strong Lewis acid AlH₃ originally used compared to the LiAlH₄, the strong Lewis acid AlH₃ can enter into further reactions, for example with respect to metal precursor compounds, such as iron(II)chloride. The formation of adducts with lithium 3α,4-dihydroazulenide and/or the ethereal solvent, such as H₃Al×Oet2₂ is also possible. Etherates of the general formula H₃Al x ether are typically present as high-polymer insoluble (AlH)₃)ₓ after a certain time. Therefore, the reaction reported by Knox and Pauson of the in situ lithium-3α,4-dihydroazulenide is disadvantageous in terms of purity and yield of the desired derived products, e.g., metallocene-type complexes. This is because, in this case, products contaminated with H₃Al x ether or (AlH₃)ₓ, in particular metal complexes, are inevitably obtained which cannot be purified or can only be purified with difficulty.

In addition, (AlH₃)ₓ fundamentally has the potential to be a hazard. This is because it decomposes into its components above 100° C., is extremely sensitive to moisture and oxidation and burns explosively in air. Consequently, increased preparatory effort is required, in particular with regard to the safety measures to be met.

Only recently, the group around Edelmann (J. Richter, P. Liebling, F. T. Silmann, Inorg. Chim. Acta 2018, 475, 18-27) published their results relating to the synthesis of metallocene complexes of the early transition metals titanium and zirconium and the lanthanide neodymium, which have dihydroazulenyl ligands. The lithium dihydroazulenides used in the context of the metal complex syntheses, namely lithium-4-methyl dihydroazulenide, lithium-7-isopropyl-1,4,8-trimethyldihydroazulenide and lithium-7-iso-propyl-1,4-dimethyl-8-phenyldihydroazulenide, were prepared analogously to the method of Hafner and Weldes (Liebigs Ann. Chem. 1957, 606, 90-99), i.e., starting from azulene or 7-iso-propyl-1,4-dimethylazulene (guaiazulene) and methyllithium or phenyllithium. However, on order to obtain solvent-free products, the isolated lithium dihydroazulenides were washed with n-pentane instead of diethyl ether. In addition, lithium-7-iso-propyl-1,4-dimethyldihydroazulenide was produced in situ by adding a hydride anion in the 8 position of guaiazulene. Here, in contrast to the specification of Knox and Pauson (J. Chem. Soc. 1961, 4610-4615), the hydrogenation reagent LiAlH₄ was used in excess rather than in a stoichiometric amount.

According to Edelmann and employees, only two heteroleptic sandwich complexes of zirconium(IV) were able to be prepared in isomerically pure form, specifically in a low yield of 19% and 30%. The authors summarize that dihydroazulenyl anions and similar anions derived from azulene appear promising as ligands for the preparation of metallocenes of early transition metals and of the lanthanides. However, according to the synthesis protocols that they describe, the metallocene complexes are only obtainable in most cases as isomer mixtures. The synthetic value of dihydroazulenyl ligands for the organometallic chemistry or mono- and bis-dihydroazulenyl complexes derived therefrom can therefore be significantly reduced.

In summary, it can be determined that the previously described chemistry of dihydroazulenyl ligands, i.e., of organo-dihydroazulenyl ligands, and H-dihydroazulenyl ligands, are almost completely limited to the group 4 d-electron-poor early transition metals, i.e., titanium(IV) and zirconium(IV), and the lanthanides, i.e., neodymium(III), with the d-electron configuration d⁰. Extremely few complexes of dihydroazulenyl ligands with transition metals having a d-electron configuration greater than d⁰, i.e., d^{a}, where a=1 to 10, are known. The only previously known example of a homoleptic bis-dihydroazulenyl transition metal complex, i.e., without an additional chlorine ligand or the like, is the aforementioned d⁶ metal complex bis(3α,4-dihydroazulenyl)iron(II), i.e., Fe(azuleneH)₂ having two H-dihydroazulenyl ligands (azuleneH)¹⁻, obtained by Knox and Pauson as isomer mixture. The d⁶-Cr(0) complex Cr(azuleneH)₂ described three years later by Fischer and Müller (J. Organomet. Chem. 1964, 1, 464-470) has one azulenium chromium(0)-azuleniate unit, i.e., only one H-dihydroazulenyl ligand (azuleneH)¹⁻.

A disadvantage of the process control described above, in particular with regard to a further use of the metal complex comprising the at least one dihydroazulenyl ligand obtainable therewith, is that the metal complexes obtained are present in many cases as mixtures of three or even six isomers that cannot be separated from one another. In the few cases in which an isomerically pure preparation is possible, these are, for example, mixed zirconocenes, namely zirconocene dichlorides (J. Richter, P. Liebig, F. T Inorg. Chim. Acta 2018, 475, 18-27). The presence of chloride ligands can limit the possibilities for further use of these metal complexes.

A further disadvantage of the aforementioned synthesis routes is the use of lithium organyls in the context of the preparation of the lithium dihydroazulenides. Disadvantages of organolithium compounds are, in particular, their high reduction capacity, which they have due to their high electropositive character and their nucleophilicity, the associated loss of selectivity and the strong exothermicity of the reactions in which they are involved.

In the case of the synthesis of lithium dihydroazulenides using LiAlH₄ as the hydride transfer agent, AlH₃ is disadvantageously produced as by-product. As described above, its quantitative separation represents a challenge that is hardly to be overcome. This applies in particular to the production of such lithium dihydroazulenides on an industrial scale.

Overall, the synthesis routes known from the literature for the production of metal complexes with H-dihydroazulenyl ligands are to be classed as unsatisfactory from a technological, ecological and (atom)economic perspective. In addition, the selection of metal complexes, in particular the middle transition metals (groups 6, 7, and 8) and the late transition metals (groups 9, 10, 11 and 12), which comprise at least one H-dihydroazulenyl ligand and are obtainable in high (isomeric) purity and good yield, is extremely limited.

The invention is therefore based on the object of overcoming these and further disadvantages of the prior art and providing a method with which alkali metal-H-dihydroazulenides, i.e., alkali metal-4-H-dihydroazulenides and/or alkali metal-6-H-dihydroazulenides and/or alkali metal-8-H-dihydrozulenlides, can be produced easily, reproducibly and comparatively inexpensively with high purity and a good yield. In particular, the purity of these compounds should satisfy the requirements for precursor compounds for the preparation of transition metal complexes with high purity and a good yield. The method is also to be distinguished by the fact that it can also be carried out on an industrial scale, with a comparable yield and purity of the target compounds, and that the formation of by-products that are difficult to separate off and/or are dangerous is avoided or the separability of such by-products is easily and reliably facilitated. In addition, a method for preparing metal complexes of middle and late transition metals using the aforementioned alkali metal-H-dihydroazulenides is to be provided. By means of this method, metal complexes having at least one 4-H-, 6-H- or 8-H-dihydroazulenyl ligands can be prepared easily, reproducibly and comparatively inexpensively with high (isomer) purity and a good yield. The present invention also provides metal complexes of middle and late transition metals having at least one 4-H-, 6-H- or 8-H-dihydroazulenyl ligands, and the use thereof.

The main features of the invention are defined in the claims.

The object is achieved by a method for preparing compounds according to the general formula

M^{A}Yₙ(AzuH) (I),
wherein
   M^{A} is an alkali metal,
   Y is a neutral ligand which is bonded or coordinated to M^{A} via at least one donor atom, wherein H₂O is excluded,
   n=0, 1, 2, 3, or 4
and
   AzuH=azulene or an azulene derivative that bears a hydride anion in the 4, 6 or 8 position in addition to an H atom,
wherein
Azu=azulene according to the formula

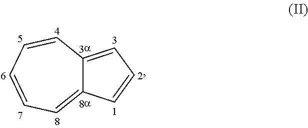

or
Azu=an azulene derivative having an azulene scaffold according to formula II consisting of a five-membered ring and a seven-membered ring,
wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom, comprising the following steps:
A. providing
i. zulene or an azulene derivative having an azulene scaffold according to formula II consisting of a five-membered ring and a seven-membered ring,
wherein
   at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
   at least one carbon atom of the azulene scaffold, selected from the group consisting of the carbon atoms C4, C6 and C8, bears an H atom,
and
ii. at least one hydridic reducing agent Z,
B. reacting the azulene or the azulene derivative with the at least one hydridic reducing agent Z in an, in particular aprotic polar, solvent S_{P},
and
   when at least one alkali metal aluminum tetrahydride M^{A}AlH₄ is used as a first hydridic reducing agent Z₁—
C. providing
i. at least one second hydridic reducing agent Z₂ selected from the group consisting of alkali metal hydrides M^{A}H
and/or
ii. at least one electron pair donor E,
wherein the electron pair donor E has at least one donor atom,
wherein H₂O is excluded,
and
D. optionally adding a neutral ligand Y, if Y is not equal to S P and Y is not equal to E.

Compounds according to the general formula M^{A}Yₙ(AzuH) (I) are generally used in the present case as alkali metal-H-dihydroazulenide, unless a particular regioisomer is meant, such as alkali metal-3α,4-H-dihydroazulenide. The compounds according to the general formula I each have one H-dihydroazulenyl anion (AzuH)¹⁻, which is a simple hydrogenated, specifically in the 4, 6 or 8 position, azulene or azulene derivative. The respective H-dihydroazulenyl anion (AzuH)¹⁻ has a hydride anion H⁻ in the 4, 6 or 8 position in addition to an H atom. Therefore, a CH₂ group is present in the C4, C6 or C8 position of the azulene scaffold. The H-dihydroazulenyl anion represents a derivative of the cyclopentadienyl anion or a cyclopentadienyl-like monoanion. The H-dihydroazulenyl anion can be a 3α,4-H-dihydroazulenyl, a 8.8α-H-dihydroazulenyl, a 3α,6-H-dihydroazulenyl or a 6,8α-H-dihydroazulenyl anion, or a mixture of two or more regioisomers.

The R^{F} radicals can be partially or fully substituted independently of one another. In this case, one or more hydrogen atoms of the respective alkyl, alkenyl, alkynyl or benzyl radical, arene or heteroarene can be replaced, for example, by a halogen atom, i.e., fluorine, chlorine, bromine or iodine.

The solvent S_{P} can also be a solvent mixture comprising two or more solvents. One embodiment of the method provides that the solvent S_{P} comprises or is at least one aprotic polar solvent. In a further embodiment of the method, the solvent S_{P} is an aprotic polar solvent or a mixture of at least two aprotic polar solvents. According to another embodiment, the solvents contained in a solvent mixture Se are miscible with one another.

In the context of the present invention, two solvents are referred to as miscible if they are miscible at least during the respective reaction, that is, are not present as two phases.

The sequence in which a reaction vessel is charged with the reactants, in particular the azulene or the azulene derivative and the at least one hydridic reducing agent Z, is freely selectable. This also includes the possibility of carrying out steps A. and B. and the optional steps C. and D., i.e., all the steps relating to the preparation of the respective target compound, in a single step, i.e., introducing all reactants and solvents simultaneously or virtually simultaneously into the reaction vessel.

The terms “reaction container” and “reaction vessel” in the context of the present invention are used synonymously and are not limited to a volume, material composition, equipment, or form. Suitable reaction vessels include, for example, glass flasks, enameled reactors, stirred tank reactors, pressure vessels, tube reactors, microreactors, and flow reactors.

According to the present invention, the expression “hydridic reducing agent” means a reducing agent comprising at least one hydridic M^{R}-H functionality and can thus function as a hydride donor. Here, M^{R} is in particular selected from the group consisting of alkali metals, aluminum and boron.

The method described herein for preparing a compound according to the general formula M^{A}Yₙ (AzuH) (I) can be carried out as a discontinuous method or as a continuous method.

M^{A}Yₙ(AzuH) (I)-type compounds can be obtained in isomerically pure form or as a mixture of two or three isomers using the method described here—depending on the reactant provided in step A., i.e., which is either unsubstituted azulene or an azulene derivative, i.e., mono- or polysubstituted azulene. The isomer according to the general formula M^{A}Yₙ(AzuH) (I) obtainable by means of this method is specifically an alkali metal 3α,4-H-dihydroazulenide and/or an alkali metal 8,8α-H-dihydroazulenide and/or an alkali metal-3α,6-H-dihydroazulenide and/or an alkali metal 6,8α-H-dihydroazulenide. These can be present in adduct-free or solvent-free form, namely where n=0, or as adducts or solvates having one (n=1), two (n=2), three (n=3) or four (n=4) neutral ligands Y In solution, a solvation of the alkali metal ions M^{A}+ is regularly carried out, in particular when the solvent S_{P} is an ether or comprises at least one ether. In particular solvated lithium ions are then present in solution, wherein Y=an ether and n=4, e.g., Li(OC)₂H₅)₄ or Li(thf)₄. In addition, isolated M^{A}Yₙ(AzuH) (I)-type compounds obtainable according to this method can be present as adducts, wherein the respective metal cation M^{A+} is complexed. Here, either the solvent S_{P} used in the context of the method described here, especially containing an ether or consisting of one or more ethereal solvents, or the electron pair donor E functions as neutral ligand Y As an alternative or in addition to an, in particular ethereal, solvent S_{P} or an electron pair donor E, the addition of a neutral ligand Y can be provided in step D. This can be advantageous in particular if the desired M^{A}Yₙ(AzuH) (I)-type compound is obtained by means of the method described here as a viscous oil, which, in terms of further conversions, is difficult to handle. In such a case, the addition of a neutral ligand Y, in particular an aprotic polar solvent, can be provided in step D. The neutral ligand Y is advantageously selected from the group consisting of ethers (=alkoxyalkanes), thioethers and tertiary amines, in particular from the group consisting of ethers (=alkoxy alkanes) and thioethers. This is because a crystallization of the particular product can be brought about and/or accelerated in this way. In the case of a crown ether, care must be taken to ensure that an internal diameter of the selected crown ether and an ion radius of the respective metal cation M^{A}+ correspond to each other.

The term “alkoxyalkane” in the present case means any oxygen-containing ether, including for example glycol dialkyl ethers and crown ethers. The term “thioether” comprises both non-cyclic and cyclic thioethers.

The glycol dialkyl ethers are also understood to mean terminally dialkylated mono-, di- or trialkylene glycol dialkyl ethers. In one variant of the method, the glycol dialkyl ether provided as a neutral ligand Y is selected from the group consisting of a monoethylene glycol dialkyl ether, a diethylene glycol dialkyl ether, a triethylene glycol dialkyl ether, a monopropylene glycol dialkyl ether, a dipropylene glycol dialkyl ether, a tripropylene glycol dialkyl ether, a monooxomethylene dialkyl ether, a dioxomethylene dialkyl ether and a trioxomethylene dialkyl ether, the isomer mixtures thereof, and mixtures thereof.

In a further embodiment of the method, the glycol dialkyl ether provided as a neutral ligand Y is selected from the group consisting of ethylene glycol dimethyl ether CH₃—O—CH₂CH₂—O—CH₃, ethylene glycol diethyl ether CH₃CH₂—O—CH₂CH₂—O—CH₂CH₃, ethylene glycol di-n-propyl ether CH₃CH₂CH₂—O—CH₂CH₂—O—CH₂CH₂CH₃, ethylene glycol diisopropyl ether (CH₃)₂CH—O—CH₂CH₂O—CH(CH₃)₂, ethylene glycol di-n-butyl ether CH₃CH₂CH₂CH₂—O—CH₂CH₂—O—CH₂CH₂CH₂CH₃, ethylene glycol di-n-pentyl ether CH₃CH₂CH₂CH₂CH₂—O—CH₂CH₂—O—CH₂CH₂CH₂CH₂CH₃, ethylene glycol di-n-hexyl ether CH₃CH₂CH₂CH₂CH₂CH₂—O—CH₂CH₂—O—CH₂CH₂CH₂CH₂CH₂CH₃, ethylene glycol diphenyl ether C₆H₅—O—CH₂CH₂—O—C₆H₅ ethylene glycol dibenzyl ether C₆H₅CH₂—O—CH₂CH₂—O—CH₂C₆H₅, diethylene glycol dimethyl ether CH₃—O—CH₂CH₂—O—CH₂CH₂—O—CH₃, diethylene glycol diethyl ether CH₃CH₂—O—CH₂CH₂—O—CH₂CH₂—O—CH₂CH₃, diethylene glycol di-n-propyl ether CH₃CH₂CH₂—O—CH₂CH₂—O—CH₂CH₂—O—CH₂CH₂CH₃, diethylene glycol diisopropyl ether (CH₃)₂CH—O—CH₂CH₂—O—CH₂CH₂O—CH(CH₃)₂, diethylene glycol di-n-butyl ether CH₃CH₂CH₂CH₂—O—CH₂CH₂—O—CH₂CH₂—O—CH₂CH₂CH₂CH₃, diethylene glycol di-n-pentyl ether CH₃CH₂CH₂CH₂CH₂—O—CH₂CH₂—O—CH₂CH₂—O—CH₂CH₂CH₂CH₂CH₃, diethylene glycol di-n-hexyl ether CH₃CH₂CH₂CH₂CH₂CH₂—O—CH₂CH₂—O—CH₂CH₂—O—CH₂CH₂CH₂CH₂CH₂CH₃, diethylene glycol diphenyl ether C₆H₅—O—CH₂CH₂—O—CH₂CH₂—O—C₆H₅, diethylene glycol dibenzyl ether C₆H₅CH₂—O—CH₂CH₂—O—CH₂CH₂—O—CH₂C₆H₅, propylene glycol dimethyl ether CH₃—O—CH₂CH₂CH₂—O—CH₃, propylene glycol diethyl ether CH₃CH₂—O—CH₂CH₂CH₂—O—CH₂CH₃, propylene glycol di-n-propyl ether CH₃CH₂CH₂—O—CH₂CH₂CH₂—O—CH₂CH₂CH₃, propylene glycol di-n-butyl ether CH₃CH₂CH₂CH₂—O—CH₂CH₂CH₂—O—CH₂CH₂CH₂CH₃, propylene glycol di-n-pentyl ether CH₃CH₂CH₂CH₂CH₂—O—CH₂CH₂CH₂—O—CH₂CH₂CH₂CH₂CH₃, propylene glycol di-n-hexyl ether CH₃CH₂CH₂CH₂CH₂CH₂—O—CH₂CH₂CH₂—O—CH₂CH₂CH₂CH₂CH₂CH₃ propylene glycol diphenyl ether C₆H₅—O—CH₂CH₂CH₂—O—C₆H₅ propylene glycol dibenzyl ether C₆H₅CH₂—O—CH₂CH₂CH₂—O—CH₂C₆H₅, isopropylene glycol dimethyl ether CH₃—O—CH₂—CH(CH₃)—O—CH₃, isopropylene glycol diethyl ether CH₃CH₂—O—CH₂—CH(CH₃)—O—CH₂CH₃, isopropylene glycol di-n-propyl ether CH₃CH₂CH₂—O—CH₂—CH(CH₃)—O—CH₂CH₂CH₃, isopropylene glycol diisopropyl ether (CH₃)₂CH—O—CH₂—CH(CH₃)—O—CH(CH CH₃)₂, isopropylene glycol di-n-butyl ether CH₃CH₂CH₂CH₂—O—CH₂—CH(CH₃)—O—CH₂CH₂CH₂CH₃, isopropylene glycol di-n-pentyl ether CH₃CH₂CH₂CH₂CH₂—O—CH₂—CH(CH₃)—O—CH₂CH₂CH₂CH₂CH₃, isopropylene glycol di-n-hexyl ether CH₃CH₂CH₂CH₂CH₂CH₂—O—CH₂—CH(CH₃)—O—CH₂CH₂CH₂CH₂CH₂CH₃, isopropylene glycol diphenyl ether C₆H₅—O—CH₂—CH(CH₃)—O—C₆H₅, isopropylene glycol dibenzyl ether C₆H₅CH₂—O—CH₂—CH(CH₃)—O—CH₂C₆H₅, dipropylene glycol dimethyl ether CH₃₀CH₂CH₂CH₂OCH₂CH₂CH₂OCH₃ diisopropylene glycol di-n-propyl ether CH₃CH₂CH₂—O—CH₂CH(CH₃)OCH₂CH(CH₃)—O—CH₂CH₂CH₃, tripropylene glycol dimethyl ether CH₃₀CH₂CH₂CH₂OCH₂CH₂CH₂OCH₂CH₂CH₂OCH₃, dipropylene glycol dibutyl ether CH₃CH₂CH₂CH₂OCH₂CH₂CH₂OCH₂CH₂CH₂OCH₂CH₂CH₂CH₃, tripropylene glycol dibutyl ether CH₃CH₂CH₂CH₂OCH₂CH₂CH₂OCH₂CH₂CH₂OCH₂CH₂CH₂OCH₂CH₂CH₂CH₃ and mixtures thereof. The stated glycol ethers can also be used as isomer mixtures.

The tertiary amine can, for example, be diisopropylethylamine (DIPEA) or N,N,N′,N-tetramethylethylenediamine (TMEDA).

Crown ethers are macrocyclic polyethers whose ring is composed of multiple ethoxy units (—CH₂—CH₂—O—). They have the ability to complex cations with the formation of coronates. If the internal diameter of a crown ether and ion radius of a metal cation correspond, extremely stable complexes are formed. For example, the crown ether [18]-crown-6 is a very good ligand for a potassium ion, while, for example, the crown ether [15]-crown-5 is particularly well suited for complexing a sodium ion. A lithium ion can, for example, be complexed very well by the crown ether [12]-crown-4. Aza, phospha or thia derivatives of the crown ethers are available by exchanging the oxygen atoms for other heteroatoms, e.g., nitrogen, phosphorus or sulfur.

In another variant of the method, the neutral ligand Y is a crown ether selected from the group consisting of macrocyclic polyethers and aza, phospha and thia derivatives thereof, wherein an internal diameter of the crown ether and an ion radius of M^{A} correspond to one another.

A further embodiment of the method provides that
the solvent S_{P} and the neutral ligand Y
and/or
the neutral ligand Y and the electron pair donor E
and/or
the solvent S_{P} and the electron pair donor E
are miscible or identical.

According to yet another embodiment of the method, the solvent S_{P} and/or the neutral ligand Y is an ether. For example, the ether can be a non-cyclic or a cyclic ether selected from the group consisting of dialkyl ethers, cyclopentyl methyl ether, tetrahydrofuran, 2-methyltetrahydrofuran, 3-methyltetrahydrofuran, tetrahydropyran, 1,4-dioxane, and isomers thereof, and mixtures thereof, in particular from the group consisting of diethyl ether, methyl-tertbutyl ether, di-n-propyl ether, diisopropyl ether, di-n-butyl ether, diisobutyl ether, ditertbutyl ether, tetrahydrofuran, 2-methyltetrahydrofuran, 3-methyltetrahydrofuran, tetrahydropyran, 1,4-dioxane, and isomers thereof, and mixtures thereof.

An advantage of the method claimed here for the preparation of compounds according to the general formula M^{A}Yₙ(AzuH) (I) is that it can be carried out easily and reproducibly and, depending on the choice of reactants, sustainably and relatively cost-effectively. The target compounds are additionally obtained with high purity of at least 97%, advantageously more than 97%, in particular more than 98% or 99%, and with good yields, also space-time yields of 60%. In general, the end product may still contain residues of solvents or for example impurities from the reactants. It is known to the person skilled in the art that the content of impurities, such as solvents, can be determined by gas chromatography methods (GC), optionally with mass spectrometry coupling (GC-MS).

The term “space-time yield” refers here to a product quantity formed per space and time within a reaction container or reaction vessel.

In particular the preparation of compounds according to the general formula M^{A}Yₙ(AzuH) (I), where AzuH=GuaH=7-isopropyl-1,4-dimethyl-8-H-dihydroazulene, is advantageously to be assessed as sustainable. In this case, the target compounds comprising cyclopentadienyl-like ligands can be produced based on inexpensive renewable raw materials. The guide price of partially synthetic guaiazulene based on the natural substance guaiol and other azulene formers available by simple dehydration and dehydrogenation (T. Shono, N. Kise, T. Fujimo, N. Tenchaga, H. Morita, J. Org. Chem. 1992, 57, 26, 7175-7187; CH 314 487 A (B. Joos) Jan. 29, 1953) is € 74.70 per 25 g (Sigma Aldrich, 12/2020).

It is particularly advantageous that, during the reaction of the azulene or azulene derivative with the at least one hydridic reducing agent Z, such as, for example, lithium triethylborohydride, in most cases, except for example when using at least one alkali metal aluminum tetrahydride, M^{A}AlH₄-only by-products, such as, for example, triethylborane, are produced, which demonstrate very good solubility in the, in particular aprotic polar, solvent S_{P} used and thus easily differ from the respective target compound M^{A}Yₙ (AzuH) (I). The very good solubility of by-products, such as, for example, triethylborane, is given in particular in cyclic and non-cyclic ethers, such as, for example, Et₂O, dimethyl ether, diethyl ether, methyltertbutyl ether, di-n-propyl ether, diisopropyl ether, isomers thereof, and mixtures thereof. In contrast, the M^{A}Yₙ(AzuH) (I)-type alkali metal H-diazulenides obtainable by means of the method described here are insoluble or virtually insoluble in the, in particular aprotic polar, solvent S_{P}, in particular in non-cyclic ethers, such as, for example, Et₂O, dimethyl ether, diethyl ether, methyl-tertbutyl ether, di-n-propyl ether, diiso propyl ether, the isomers thereof and mixtures. Consequently, the product can be quantitatively separated by means of a simple filtration step and/or by centrifuging and/or decanting. The compound obtained in the form of a solid, a liquid or an oil according to the general formula M^{A}Yₙ(AzuH) (I) can be stored and/or or directly reacted with one or more other compounds, e.g., a metal complex having anionic leaving groups, e.g., a metal salt, e.g., FeCl₂RuCl₂, CoCl₂ or Pd(OAc)₂ or an organometal precursor having anionic leaving groups, such as [Rh(cod)Cl],₂(cod=1,5-cyclooctadiene), [PtMe₃I]₄, [(p-cymene)RuCl₂]₂, [CpCrCl₂] or [Ir(nbd)Cl]₂ (nbd=norbornadiene). Alternatively or additionally, the respective M^{A}Yₙ(AzuH) (I)-type product is subjected to an isomer separation and/or one or more purification steps, for example at least one washing step with an, in particular aprotic polar, solvent. The latter can be an ethereal or non-ethereal solvent. If S_{P} e.g., Et₂O was selected as solvent and if the product is present as Et₂O adduct, e.g., M^{A}(Et₂O)₂(AzuH) (I), it is recommended that Et₂O also be selected as the wash step. If, on the other hand, a solvent-free, in particular ether-free, product M^{A}Yₙ(AzuH) (I), where n=0, is desired, the solvent for the wash step should advantageously be an aprotic non-polar, for example selected from the group consisting of n-pentane, n-hexane, n-heptane, n-octane, n-nonane, n-decane, n-undecane, n-dodecane, n-tridecane, n-tetradecane, cyclopentane, cyclohexane, cycloheptane, 1-octene, 1-nonene, 1-decene, 1-undecene, 1-dodecene, benzene, toluene or xylene, the isomers thereof, and mixtures thereof. After washing with one of the aforementioned solvents, in particular a relatively low-boiling, such as, for example, n-pentane and/or n-hexane, the respective compound according to the general formula M^{A}Yₙ (AzuH) (I) is present with high purity of at least 97%, advantageously of more than 97%, especially of more than 98% or 99%, and with a good yield, as well as space-time yields, of 60%. This can be a solvent-free compound of the M^{A}Yₙ (AzuH) (I) type, where n=0 or, for example, an adduct, where Y=a crown ether and n=1. If the product according to the general formula M^{A}Yₙ (AzuH) (I) is produced as a solid, it is generally already present in pure form, in particular as an adduct, according to an NMR spectroscopy examination. Therefore, purification of the solid is not typically necessary before further use, provided that the adduct can be used without problems as reactant for the planned reaction.

According to one embodiment of the method, the alkali metal is M^{A} selected from the group consisting of Li, Na and K.

According to a further variant of the method, at least one hydridic reducing agent Z is selected from the group consisting of alkali metal hydrides M^{A}H, alkali metal borohydrides M^{A}BH₄, alkali metal trialkylborohydrides M^{A}[(R)^{C})₃BH], alkali metal aluminum tetrahydrides M^{A}AlH₄, alkali metal trialkylaluminum hydrides M^{A}[(R)^{D})₃AlH], alkali metal dihydridobis(dialkoxy) aluminates M^{A}[AlH₂(OR^{E})₂], and mixtures thereof, wherein
i. the radicals R^{C} and R^{D} are each selected independently of one another from the group consisting of primary, secondary, tertiary alkyl, alkenyl and alkynyl radicals having 1 to 10 carbon atoms,
wherein in each case two substituents R^{C} or two substituents R^{D} can optionally form a ring,
and
ii. the radicals OR^{E} are each independently of one another a corresponding base of a glycol ether R^{E}OH.

Another variant of the method provides that at least one hydridic reducing agent Z is selected from the group consisting of lithium hydride LiH, sodium hydride NaH, potassium hydride KH, lithium boron tetrahydride LiBH₄, sodium boron tetrahydride NaBH₄, potassium boron tetrahydride KBH₄, lithium trialkylborohydrides Li[(R^{C})₃BH], sodium trialkylborohydrides Na[(R^{C})₃BH], potassium trialkylborohydrides K[(R^{C})₃BH], lithium aluminum tetrahydride LiAlH₄, sodium aluminum tetrahydride NaAlH₄, potassium aluminum tetrahydride KAlH₄, lithium trialkylaluminum hydride Li[(R^{D})₃AlH], sodium trialkylaluminum hydride Na[(R^{D})₃AlH], potassium trialkylaluminum hydride K[(R^{D})₃AlH], Iithium-dihydrido-bis(dialkoxy)aluminates Li[AlH₂(OR^{E})₂], sodium dihydridobis(dialkoxy)aluminates Na[AlH₂(OR^{E})₂], potassium dihydridobis(dialkoxy)aluminates K[AlH₂(OR^{E})₂], and mixtures thereof.

Examples of lithium trialkylborohydrides Li[(R^{C})₃BH] are lithium triethylborohydride which can be used, for example, as a solution in tetrahydrofuran (1.0 M or 1.7 M), and lithium tri-sec.-butylborohydride solution, which is commercially available under the name L-Selectride® as a solution in tetrahydrofuran (1.0 M). Commercially available sodium trialkylborohydrides Na[(R^{C})₃BH] are, for example, sodium triethylborohydride (1.0 M in THF) and sodium tri-sec.-butylborohydride solution (N-Selectride® solution, 1.0 M in THF). Examples of commercially available potassium trialkylborohydrides K[(R^{C})₃BH] are the potassium triethylborohydride (1.0 M in THF) and potassium tri-sec.-butylborohydride (K-Selectride® solution, 1.0 M in THF).

Examples of alkali metal trialkylaluminum hydrides are compounds according to the general formula M^{A}[(R)^{D})₃AlH], where M^{A}=Li, Na or K and the radicals R^{D} are selected independently of one another from the group consisting of methyl, ethyl, propyl, butyl, pentyl, hexyl, and isomers thereof. For example, the use of Li[Et₃AlH], Na[iPr₃AlH] or K[MeEt₂AlH] can be provided.

The two OR^{E} radicals of an alkali metal dihydridobis(dialkoxy)aluminate according to the general formula M^{A}[AlH₂(OR^{E})₂] may be identical or different. In one variant of the method, it is provided that the glycol ethers R^{E}OH are selected independently of one another from the group consisting of monooxomethylene monoethers, monoethylene glycol monoethers, monopropylene glycol monoethers, and isomer mixtures thereof, and mixtures thereof.

According to another variant, the use of at least one alkali metal dihydrido-bis(dialkoxy)aluminate according to the general formula M^{A}[AlH₂(OR^{E})₂] is provided, wherein M^{A}=Li, Na or K and the radicals OR^{E} are each selected independently of one another from the group consisting of O—CH₂CH₂—O—CH₃, O—CH₂CH₂—O—CH₂CH₃, O—CH₂CH₂—O—CH₂CH₂CH₃, O—CH₂CH₂O—CH(CH₃)₂, O—CH₂CH₂—O—CH₂CH₂CH₂CH₃, O—CH₂CH₂—O—CH₂CH₂CH₂CH₂CH₃, O—CH₂CH₂—O—CH₂CH₂CH₂CH₂CH₂CH₃, O—CH₂CH₂—O—C₆H₅, O—CH₂CH₂—O—CH₂C₆H₅, O—CH₂CH₂CH₂—O—CH₃, O—CH₂CH₂CH₂—O—CH₂CH₃, O—CH₂CH₂CH₂—O—CH₂CH₂CH₃, O—CH₂CH₂CH₂O—CH(CH₃)₂, O—CH₂CH₂CH₂—O—CH₂CH₂CH₂CH₃, O—CH₂CH₂CH₂—O—CH₂CH₂CH₂CH₂CH₃, O—CH₂CH₂CH₂—O—CH₂CH₂CH₂CH₂CH₂CH₃, O—CH₂CH₂CH₂—O—C₆H₅, O—CH₂CH₂CH₂—O—CH₂C₆H₅, O—CH(CH₃)—CH₂—O—CH₃, O—CH(CH₃)—CH₂—O—CH₂CH₃, O—CH(CH₃)—CH₂—O—CH₂CH₂CH₃, O—CH(CH₃)—CH₂O—CH(CH₃)₂, O—CH(CH₃)—CH₂—OCH₂CH₂CH₂CH₃, O—CH(CH₃)—CH₂—O—CH₂CH₂CH₂CH₂CH₃, O—CH(CH₃)—CH₂—O—CH₂CH₂CH₂CH₂CH₂CH₃, O—CH(CH₃)—CH₂—O—C₆H₅, O—CH(CH₃)—CH₂—O—CH₂C₆H₅, O—CH(CH₃)—CH₂—O—C₄H₉, and O—CH(CH₃)—CH₂—O—C₃H₇ and isomers thereof, and mixtures thereof. One example of hydridic reducing agents of this type is commercially available sodium bis(2-methoxyethoxy) aluminum dihydride (Na[AlH)₂(OC)₂H₄OCH₃)₂), which is also known as synhydride, Red-AI® and Vitride®. This reducing agent is commercially available in the form of a viscous, toluenic solution, with an approximate weight fraction of >60 wt. % being stated. A further representative of this group of hydridic reducing agents is Na[AlH₂(OC)₂H₄OC₄H₉)₂].

One embodiment of the method provides that a molar ratio of Azu:Z is at least 1.00:2.00. It can therefore also be 1.00:1.00. In another embodiment of the method, the molar ratio of Azu:Z is between 1.00:2.00 and 2.00:1.00, advantageously between 1.00:1.75 and 1.75:1.00, in particular between 1.00:1.50 and 1.50:1.00, for example 1.00:1.95 or 1.95:1.00 or 1.00:1.90 or 1.90:1.00 or 1.00:1.85 or 1.85:1.00 or 1.00:1.80 or 1.80:1.00 or 1.00:1.70 or 1.70:1.00 or 1.00:1.65 or 1.65:1.00 or 1.00:1.60 or 1.60:1.00 or 1.00:1.55 or 1.55:1.00 or 1.00:1.45 or 1.45:1.00 or 1.00:1.40 or 1.40:1.00 or 1.00:1.35 or 1.35:1.00 or 1.00:1.30 or 1.30:1.00 or 1.00:1.25 or 1.25:1.00 or 1.00:1.20 or 1.20:1.00 or 1.00:1.15 or 1.15:1.00 or 1.00:1.10 or 1.10:1.00 or 1.00:1.05 or 1.05:1.00. In yet another embodiment, the molar ratio of Azu:Z is 1.00:1.00.

According to a further embodiment of the method, the electron pair donor E has at least one donor atom selected from the group consisting of a nitrogen atom, a phosphorus atom, an oxygen atom and a sulfur atom. In this case, at least one donor atom of the respective electron pair donor E is suitable for forming an, in particular coordinative, bond with an electron pair acceptor, in particular AlH₃.

In another embodiment of the method, it is provided that the electron pair donor E has one, two, three, four or five donor atoms. In this case, at least one donor atom of the respective electron pair donor E is suitable for forming an, in particular coordinative, bond with an electron pair acceptor, such as AlH₃.

In a further embodiment of the method, a molar ratio of Z:E is at least 1.00:5.00. It can therefore also be 1.00:1.00. In another embodiment of the method, the molar ratio of Z:E is between 1.00:5.00 and 5.00:1.00, advantageously between 1.00:4.50 and 4.50:1.00, in particular between 1.00:4.00 and 4.00:1.00, for example 1.00:3.75 or 3.75:1.00 or 1.00:3.50 or 3.50:1.00 or 1.00:3.25 or 3.25:1.00 or 1.00:3.00 or 3.00:1.00 or 1.00:2.75 or 2.75:1.00 or 1.00:2.50 or 2.50:1.00 or 1.00:2.25 or 2.25:1.00 or 1.00:2.00 or 2.00:1.00 or 1.00:1.75 or 1.75:1.00 or 1.00:1.50 or 1.50:1.00 or 1.00:1.25 or 1.25:1.00. In yet another embodiment, the molar ratio of Z:E is 1.00:1.00.

According to a further variant of the method, it is provided that the hydridic reducing agent Z comprises at least two hydridic reducing agents Zᵣ, wherein in each case r is a whole natural number≥1. This means that the hydridic reducing agent Z comprises, for example, a first hydridic reducing agent Z₁ and a second hydridic reducing agent Z₂ and can optionally also comprise a third hydridic reducing agent Z₃ etc. The two or more hydridic reducing agents Zᵣ can be provided separately from one another or as a mixture of two or more hydridic reducing agents Zᵣ. In addition, the two or more hydridic reducing agents Zᵣ can be provided with identical or different mass fractions.

Another embodiment of the method provides that the hydridic reducing agent Z consists of exactly one or exactly two hydridic reducing agents. For example, a mixture consisting of a first hydridic reducing agent Z₁ and a second hydridic reducing agent Z₂ can be provided. This may be a mixture of lithium hydride and diisobutylaluminum hydride (DIBAL).

In a mixture of two different hydridic reducing agents Z₁ and Z₂, a molar ratio Z₁:Z₂ of the two hydridic reducing agents can be between 1:10 and 10:1, i.e., between 0.1 and 10.0, advantageously between 1:8 and 8:1, particularly advantageously between 1:6 and 6:1, in particular between 1:5 and 5:1. Therefore, the molar ratio Z₁:Z 2 can therefore also be between 1:9 and 9:1, or between 1:7 and 7:1, or between 1:4 and 4:1, or between 1:3 and 3:1, or between 1:2 and 2:1. According to a further embodiment, a molar ratio Z₁:Z₂ of 1:1 is provided.

When at least one alkali metal aluminum tetrahydride M^{A}AlH₄ is used as a first hydridic reducing agent Z₁, it is provided according to step C of the method described here that
i. at least one second hydridic reducing agent Z₂ selected from the group consisting of alkali metal hydrides M^{A}H is provided,
and/or
ii. at least one electron pair donor E is provided, wherein the electron pair donor E has at least one donor atom, wherein H₂O
is excluded.

An advantageous embodiment variant of the method provides at least one first hydride reducing agent Z₁ and at least one second hydridic reducing agent Z₂, wherein
i. at least one first hydridic reducing agent Z₁ is selected from the group consisting of alkali metal aluminum tetrahydrides M^{A}AlH₄
and
ii. at least one second hydridic reducing agent Z₂ is selected from the group consisting of alkali metal hydrides M^{A}H.

For example, LiAlH₄ may be selected as the first hydridic reducing agent Z₁ and LiH as the second hydridic reducing agent Z₂. In this case, the aluminum trihydride AlH₃ or (AlH₃)ₓ obtained or being obtained is captured by the electron pair donor LiH, which is sparingly soluble to insoluble, in particular in aprotic polar solvents, such as ethers, e.g., tetrahydrofuran or diethyl ether, or by the hydride anion H⁻ thereof. In this case, the first hydridic reducing agent LiAlH₄ is advantageously regenerated without further intervention. Consequently, the first hydridic reducing agent Z₁, which is used for the reaction with the azulene or the azulene derivative and which typically has good to very good solubility in the respective solvent S_{P}, is available again as a soluble, hydride-transferring reagent. Consequently, the relatively cost-intensive first hydridic reducing agent LiAlH₄—based on the respective reactant of the azulene or azulene derivative—can advantageously also be used in a substoichiometric amount, in particular in a catalytic amount. This is particularly advantageous in terms of a large-scale application of the embodiment variant described here, specifically from an (atom) economic and ecological perspective. This is because, on the one hand, a smaller amount of the relatively expensive first hydridic reducing agent Z₁ is required, and on the other hand it is fully used up. With regard to the relatively cost-effective second hydridic reducing agent lithium hydride, which is commercially available in large amounts, it may be advantageous, in particular due to its solubility behavior, to use an excess, based on the respective reactant azulene or azulene derivative. Optionally, unreacted lithium hydride can be quantitatively separated off by means of a simple filtration step, optionally via silica, e.g., Celite® and/or by centrifuging and/or decanting. A lithium hydride contamination of the compounds according to the general formula M^{A}Yₙ(AzuH) (I), which can be produced by means of the method described here, can thus be ruled out. The respective M^{A}Yₙ(AzuH) (I)-type target compound typically demonstrates good to very good solubility in the, in particular aprotic non-polar, solvent S P used.

The use of lithium hydride is also advantageous for safety reasons. This is because, in contrast to other hydride-transferring reagents, it is not pyrophoric in air and, as a result of passivation, can even be handled in air for a short time.

The fact that this process management is particularly advantageous from an (atom) economic and ecological perspective can be easily understood based on the three reaction equations (1) to (3) listed below:

$$Azu + Li [ A l {H}_{4} ] \to Li ( AzuH ) + {[ Al {H}_{3} ]}_{x} \qquad ( 1 )$$

$$\underline{{⌈ {AlH}_{3} ⌉}_{x} + LiH \to Li ⌈ Al {H}_{4} ⌉} \qquad ( 2 )$$

$$Azu + LiH \to Li ( AzuH ) \qquad ( 3 )$$

In this case, Azu and AzuH are as defined above. Li(AzuH) also comprises solvent solvates thereof in which solvated lithium ions are present.

Another embodiment of the claimed method provides that at least one first hydridic reducing agent Z₁ is selected from the group consisting of alkali metal aluminum tetrahydrides M^{A}AlH₄ and at least one second hydridic reducing agent Z₂ is selected from the group consisting of alkali metal hydrides M^{A}H,
wherein
a) a molar ratio Azu:Z₁ is at least 1.0:1.0,
and
b) a molar ratio Z₁:Z₂ is at least 1:250.

Advantageously, the molar ratio Azu:Z₁ (subitem a)) is between 1.0:1.0 and 20.0:1.0, particularly advantageously between 1.1:1.0 and 20.0:1.0, in particular between 1.1:1.0 and 19.9:1.0, for example 19.8:1.0 or 19.7:1.0 or 19.6:1.0 or 19.5:1.0 or 19.4:1.0 or 19.3:1.0 or 19.2:1.0 or 19.1:1.0 or 19.0:1.0 or 18.9:1.0 or 18.8:1.0 or 18.7:1.0 or 18.6:1.0 or 18.5:1.0 or 18.4:1.0 or 18.3:1.0 or 18.2:1.0 or 18.1:1.0 or 18.0:1.0 or 17.9:1.0 or 17.8:1.0 or 17.7:1.0 or 17.6:1.0 or 17.5:1.0 or 17.4:1.0 or 17.3:1.0 or 17.2:1.0 or 17.1:1.0 or 17.0:1.0 or 16.9:1.0 or 16.8:1.0 or 16.7:1.0 or 16.6:1.0 or 16.5:1.0 or 16.4:1.0 or 16.3:1.0 or 16.2:1.0 or 16.1:1.0 or 16.0:1.0 or 15.9:1.0 or 15.8:1.0 or 15.7:1.0 or 15.6:1.0 or 15.5:1.0 or 15.4:1.0 or 15.3:1.0 or 15.2:1.0 or 15.1:1.0 or 15.0:1.0 or 14.9:1.0 or 14.8:1.0 or 14.7:1.0 or 14.6:1.0 or 14.5:1.0 or 14.4:1.0 or 14.3:1.0 or 14.2:1.0 or 14.1:1.0 or 14.0:1.0 or 13.9:1.0 or 13.8:1.0 or 13.7:1.0 or 13.6:1.0 or 13.5:1.0 or 13.4:1.0 or 13.3:1.0 or 13.2:1.0 or 13.1:1.0 or 13.0:1.0 or 12.9:1.0 or 12.8:1.0 or 12.7:1.0 or 12.6:1.0 or 12.5:1.0 or 12.4:1.0 or 12.3:1.0 or 12.2:1.0 or 12.1:1.0 or 12.0:1.0 or 11.9:1.0 or 11.8:1.0 or 11.7:1.0 or 11.6:1.0 or 11.5:1.0 or 11.4:1.0 or 11.3:1.0 or 11.2:1.0 or 11.1:1.0 or 11.0:1.0 or 10.9:1.0 or 10.8:1.0 or 10.7:1.0 or 10.6:1.0 or 10.5:1.0 or 10.4:1.0 or 10.3:1.0 or 10.2:1.0 or 10.1:1.0 or 10.0:1.0 or 9.9:1.0 or 9.8:1.0 or 9.7:1.0 or 9.6:1.0 or 9.5:1.0 or 9.4:1.0 or 9.3:1.0 or 9.2:1.0 or 9.1:1.0 or 9.0:1.0 or 8.9:1.0 or 8.8:1.0 or 8.7:1.0 or 8.6:1.0 or 8.5:1.0 or 8.4:1.0 or 8.3:1.0 or 8.2:1.0 or 8.1:1.0 or 8.0:1.0 or 7.9:1.0 or 7.8:1.0 or 7.7:1.0 or 7.6:1.0 or 7.5:1.0 or 7.4:1.0 or 7.3:1.0 or 7.2:1.0 or 7.1:1.0 or 7.0:1.0 or 6.9:1.0 or 6.8:1.0 or 6.7:1.0 or 6.6:1.0 or 6.5:1.0 or 6.4:1.0 or 6.3:1.0 or 6.2:1.0 or 6.1:1.0 or 6.0:1.0 or 5.9:1.0 or 5.8:1.0 or 5.7:1.0 or 5.6:1.0 or 5.5:1.0 or 5.4:1.0 or 5.3:1.0 or 5.2:1.0 or 5.1:1.0 or 5.0:1.0 or 4.9:1.0 or 4.8:1.0 or 4.7:1.0 or 4.6:1.0 or 4.5:1.0 or 4.4:1.0 or 4.3:1.0 or 4.2:1.0 or 4.1:1.0 or 4.0:1.0 or 3.9:1.0 or 3.8:1.0 or 3.7:1.0 or 3.6:1.0 or 3.5:1.0 or 3.4:1.0 or 3.3:1.0 or 3.2:1.0 or 3.1:1.0 or 3.0:1.0 or 2.9:1.0 or 2.8:1.0 or 2.7:1.0 or 2.6:1.0 or 2.5:1.0 or 2.4:1.0 or 2.3:1.0 or 2.2:1.0 or 2.1:1.0 or 2.0:1.0 or 1.9:1.0 or 1.8:1.0 or 1.7:1.0 or 1.6:1.0 or 1.5:1.0 or 1.4:1.0 or 1.3:1.0 or 1.2:1.0.

The molar ratio Z₁:Z₂ (subitem b)) is advantageously between 1:250 and 20:1, particularly advantageously between 1:245 and 19:1, very particularly advantageously between 1:240 and 18:1, in particular between 1:235 and 17:1. Therefore, the molar ratio Z₁:Z 2 can, for example, also be 1:230 or 1:225 or 1:220 or 1:215 or 1:210 or 1:209 or 1:208 or 1:207 or 1:206 or 1:205 or 1:204 or 1:203 or 1:202 or 1:201 or 1:200 or 1:199 or 1:198 or 1:197 or 1:196 or 1:195 or or 1:194 or 1:193 or 1:192 or 1:191 or 1:190 or 1:185 or 1:180 or 1:175 or 1:170 or 1:165 or 1:160 or 1:155 or 1:150 or 1:145 or 1:140 or 1:135 or 1:130 or 1:125 or 1:120 or 1:115 or 1:110 or 1:105 or 1:100 or 1:95 or 1:90 or 1:85 or 1:80 or 1:75 or 1:70 or 1:65 or 1:60 or 1:55 or 1:50 or 1:45 or 1:40 or 1:35 or 1:30 or 1:25 or 1:20 or 1:19 or 1:18 or 1:17 or 1:16 or 1:15 or 1:14 or 1:13 or 1:12 or 1:11 or 1:10 or 1:9.5 or 1:9 or 1:8.5 or 1:8 or 1:7.5 or 1:7 or 1:6.5 or 1:6 or 1:5.5 or 1:5 or 1:4.5 or 1:4 or 1:3.5 or 1:3 or 1:2.5 or 1:2 or 1:1.5 or 1:1.4 or 1:1.3 or 1:1.2 or 1:1.1 or 19.5:1 or 18.5:1 or 17.5:1 or 16.5:1 or 16.0:1 or 15.5:1 or 15.0:1 or 14.5:1 or 14.0:1 or 13.5:1 or 13.0:1 or 12.5:1 or 12.0:1 or 11.5:1 or 11.0:1 or 10.5:1 or 10.0:1 or 9.5:1 or 9.0:1 or 8.5:1 or 8.0:1 or 7.5:1 or 7.0:1 or 6.5:1 or 6.0:1 or 5.5:1 or 5.0:1 or 4.5:1 or 4.0:1 or 3.5:1 or 3.0:1 or 2.5:1 or 2.0:1 or 1.5:1 or 1.4:1 or 1.3:1 or 1.2:1 or 1.1:1.

The molar ratio Azu:Z₁ can, for example, be 19.8:1.0, wherein the molar ratio Z₁:Z₂ is 1:200. At this juncture, reference is made to the section Working Regulations (Example 1, Method C).

The electron pair donor E is a Lewis acid scavenger, by means of which aluminum trihydride AlH₃ obtained and/or being obtained for example as a by-product, and/or (AlH₃)ₓ with the formation of a Lewis acid/Lewis base complex E-AlH₃ can be captured. In other words: The electron pair donor E serves to change the solubility of the aluminum trihydride AlH₃ or (AlH₃)ₓ in the solvent S_{P} used in each case compared to the solubility of the respective M^{A}Yₙ(AzuH) (I)-type target compound, such that a quantitative separation of the aforementioned hydrides, inevitably obtained as by-products, is possible. For this purpose, a Lewis acid/Lewis base complex E-AlH₃, which is sparingly soluble in the respective solvent S_{P} and therefore precipitates quantitatively, is typically generated. Alternatively, it can be provided that a Lewis acid/Lewis base complex E-AlH₃, which is particularly well soluble in the respective solvent S_{P}, is produced when the respective product according to the general formula M^{A}Yₙ(AzuH) (I) has very low to no solubility in the respective solvent S p. In the latter case, the amount of the respective target compound contained in the reaction mixture advantageously precipitates quantitatively or virtually quantitatively.

The electron pair donor E can be added only after the reaction according to step B., i.e., in step C., and/or already during the reaction according to step B. Alternatively or additionally, the electron pair donor E can be added in step A. and/or in step D. In one embodiment of the method, the solvent S_{P} comprises the electron pair donor E.

In a non-limiting manner, examples of the electron pair donor E are given below: tertiary amines, such as, for example, 1,4-diazabicyclo[2.2.2]octane (DABCO®=triethylenediamine) and TMEDA, organic amides, such as, for example, N,N dimethylformamide (DMF) and hexamethylphosphoramide (HMPT), and the heterocyclic oxygen base 1,4-dioxane.

Advantageously, the electron pair donor E can be used to capture the by-product aluminum trihydride AlH₃ or (AlH₃)ₓ, obtained or being obtained during the reaction of the azulene or azulene derivative with the at least one hydridic reducing agent Z, directly during step B. and/or in the subsequent step C. and/or step D. The AlH₃-E adduct formed are sparingly soluble to insoluble in the, in particular aprotic polar, solvent S_{P} used, in particular tetrahydrofuran, 1,4-dioxane, tetrahydropyran, dialkyl ethers, e.g., diethyl ether, di-n-butyl ether, and tertbutyl methyl ether, and glycol ethers, such as, for example, 1,2-dimethoxyethane. Consequently, this precipitate can be quantitatively separated off by means of a simple filtration step, optionally via silica, e.g., Celite® and/or by centrifuging and/or decanting.

A quantitative removal of AlH₃ or (AlH₃)ₓ from the reaction mixture is a challenge which cannot be satisfactorily overcome by means of the methods described in the prior art. However, the quantitative separation of AlH₃ or (AlH₃)ₓ is imperative. This is because it represents a strong Lewis acid, which exhibits high reactivity even at or slightly above room temperature, in particular with respect to various metal precursors. Therefore, a further reaction of a M^{A}Yₙ(AzuH) (I)-type compound, which is contaminated by AlH₃ or (AlH₃)ₓ, is associated with yield losses. This problem is advantageously eliminated by means of the method described here. Subsequent to the aforementioned filtration step and/or the centrifuging and/or decanting, a solvent exchange can take place, for example, in that the solvent S_{P}, in particular tetrahydrofuran, is completely removed under vacuum and another solvent S_{P}, particularly Et₂O, is added. As already mentioned above, the desired product is insoluble in Et₂O and therefore separable by means of a simple filtration and/or by centrifuging and/or decanting. If necessary, as described further above, at least one wash step can be provided.

According to another embodiment, the at least one hydridic reducing agent Z is or comprises an alkali metal boron tetrahydride M^{A}BH₄ and/or alkali metal trialkylborohydride M^{A}[(R)^{C})₃BH] and/or alkali metal trialkyl aluminum hydride M^{A}[(R)^{D})₃AlH] and/or alkali metal dihydridobis(dialkoxy)aluminates M^{A}[AlH₂(OR^{E})₂], wherein an electron pair donor E is provided, by means of which the boron trihydride BH₃ or B₂H₆ and/or trialkyl borane and/or trialkyl aluminum and/or [(R^{E}O)₂AlH]ₓ obtained and/or being obtained is captured. For example, LiBH₄ and/or lithium triethylborohydride and/or lithium triethylaluminum hydride and/or Li[AlH₂(OC)₂H₄OCH₃)₂] can be provided as one of the hydridic reducing agents Z. Then, the boron trihydride BH₃ or B₂H₆ and/or triethylborane Et₃B and/or triethylaluminum Et₃Al or (Et₃Al)₂ and/or [(R^{E}O)₂AlH]ₓ obtained or being obtained is captured to form a Lewis acid/Lewis base complex E-BH₃ or E-BH₃ or E-AlH₃ or and/or E-Al(R^{E}O)₂H—as already described above for AlH₃ or (AlH₃)ₓ.

A further embodiment variant of the method provides at least one first hydride reducing agent Z₁ and at least one second hydridic reducing agent Z₂, wherein
i. at least one first hydridic reducing agent Z₁ is selected from the group consisting of alkali metal boron tetrahydrides M^{A}BH₄, alkali metal dihydridobis(dialkoxy)aluminates M^{A}[AlH₂(OR^{E})₂], alkali metal trialkylaluminum hydrides M^{A}[(R)^{D})₃AlH] and alkali metal trialkylborohydrides M^{A}[(R)^{C})₃ BH], and mixtures thereof,
and
ii. at least one second hydridic reducing agent Z₂ is selected from the group consisting of alkali metal hydrides M^{A}H.

An alternative or supplementary embodiment of the method claimed provides that
a) a molar ratio Azu:Z₁ is at least 1.0:1.0,
and
b) a molar ratio Z₁:Z₂ is at least 1:250.

Advantageously, the molar ratio Azu:Z₁ (subitem a)) is between 1.0:1.0 and 20.0:1.0, particularly advantageously between 1.1:1.0 and 20.0:1.0, in particular between 1.1:1.0 and 19.9:1.0, for example 19.8:1.0 or 19.7:1.0 or 19.6:1.0 or 19.5:1.0 or 19.4:1.0 or 19.3:1.0 or 19.2:1.0 or 19.1:1.0 or 19.0:1.0 or 18.9:1.0 or 18.8:1.0 or 18.7:1.0 or 18.6:1.0 or 18.5:1.0 or 18.4:1.0 or 18.3:1.0 or 18.2:1.0 or 18.1:1.0 or 18.0:1.0 or 17.9:1.0 or 17.8:1.0 or 17.7:1.0 or 17.6:1.0 or 17.5:1.0 or 17.4:1.0 or 17.3:1.0 or 17.2:1.0 or 17.1:1.0 or 17.0:1.0 or 16.9:1.0 or 16.8:1.0 or 16.7:1.0 or 16.6:1.0 or 16.5:1.0 or 16.4:1.0 or 16.3:1.0 or 16.2:1.0 or 16.1:1.0 or 16.0:1.0 or 15.9:1.0 or 15.8:1.0 or 15.7:1.0 or 15.6:1.0 or 15.5:1.0 or 15.4:1.0 or 15.3:1.0 or 15.2:1.0 or 15.1:1.0 or 15.0:1.0 or 14.9:1.0 or 14.8:1.0 or 14.7:1.0 or 14.6:1.0 or 14.5:1.0 or 14.4:1.0 or 14.3:1.0 or 14.2:1.0 or 14.1:1.0 or 14.0:1.0 or 13.9:1.0 or 13.8:1.0 or 13.7:1.0 or 13.6:1.0 or 13.5:1.0 or 13.4:1.0 or 13.3:1.0 or 13.2:1.0 or 13.1:1.0 or 13.0:1.0 or 12.9:1.0 or 12.8:1.0 or 12.7:1.0 or 12.6:1.0 or 12.5:1.0 or 12.4:1.0 or 12.3:1.0 or 12.2:1.0 or 12.1:1.0 or 12.0:1.0 or 11.9:1.0 or 11.8:1.0 or 11.7:1.0 or 11.6:1.0 or 11.5:1.0 or 11.4:1.0 or 11.3:1.0 or 11.2:1.0 or 11.1:1.0 or 11.0:1.0 or 10.9:1.0 or 10.8:1.0 or 10.7:1.0 or 10.6:1.0 or 10.5:1.0 or 10.4:1.0 or 10.3:1.0 or 10.2:1.0 or 10.1:1.0 or 10.0:1.0 or 9.9:1.0 or 9.8:1.0 or 9.7:1.0 or 9.6:1.0 or 9.5:1.0 or 9.4:1.0 or 9.3:1.0 or 9.2:1.0 or 9.1:1.0 or 9.0:1.0 or 8.9:1.0 or 8.8:1.0 or 8.7:1.0 or 8.6:1.0 or 8.5:1.0 or 8.4:1.0 or 8.3:1.0 or 8.2:1.0 or 8.1:1.0 or 8.0:1.0 or 7.9:1.0 or 7.8:1.0 or 7.7:1.0 or 7.6:1.0 or 7.5:1.0 or 7.4:1.0 or 7.3:1.0 or 7.2:1.0 or 7.1:1.0 or 7.0:1.0 or 6.9:1.0 or 6.8:1.0 or 6.7:1.0 or 6.6:1.0 or 6.5:1.0 or 6.4:1.0 or 6.3:1.0 or 6.2:1.0 or 6.1:1.0 or 6.0:1.0 or 5.9:1.0 or 5.8:1.0 or 5.7:1.0 or 5.6:1.0 or 5.5:1.0 or 5.4:1.0 or 5.3:1.0 or 5.2:1.0 or 5.1:1.0 or 5.0:1.0 or 4.9:1.0 or 4.8:1.0 or 4.7:1.0 or 4.6:1.0 or 4.5:1.0 or 4.4:1.0 or 4.3:1.0 or 4.2:1.0 or 4.1:1.0 or 4.0:1.0 or 3.9:1.0 or 3.8:1.0 or 3.7:1.0 or 3.6:1.0 or 3.5:1.0 or 3.4:1.0 or 3.3:1.0 or 3.2:1.0 or 3.1:1.0 or 3.0:1.0 or 2.9:1.0 or 2.8:1.0 or 2.7:1.0 or 2.6:1.0 or 2.5:1.0 or 2.4:1.0 or 2.3:1.0 or 2.2:1.0 or 2.1:1.0 or 2.0:1.0 or 1.9:1.0 or 1.8:1.0 or 1.7:1.0 or 1.6:1.0 or 1.5:1.0 or 1.4:1.0 or 1.3:1.0 or 1.2:1.0.

The molar ratio Z₁:Z₂ (subitem b)) is advantageously between 1:250 and 20:1, particularly advantageously between 1:245 and 19:1, very particularly advantageously between 1:240 and 18:1, in particular between 1:235 and 17:1. Therefore, the molar ratio Z₁:Z 2 can, for example, also be 1:230 or 1:225 or 1:220 or 1:215 or 1:210 or 1:209 or 1:208 or 1:207 or 1:206 or 1:205 or 1:204 or 1:203 or 1:202 or 1:201 or 1:200 or 1:199 or 1:198 or 1:197 or 1:196 or 1:195 or or 1:194 or 1:193 or 1:192 or 1:191 or 1:190 or 1:185 or 1:180 or 1:175 or 1:170 or 1:165 or 1:160 or 1:155 or 1:150 or 1:145 or 1:140 or 1:135 or 1:130 or 1:125 or 1:120 or 1:115 or 1:110 or 1:105 or 1:100 or 1:95 or 1:90 or 1:85 or 1:80 or 1:75 or 1:70 or 1:65 or 1:60 or 1:55 or 1:50 or 1:45 or 1:40 or 1:35 or 1:30 or 1:25 or 1:20 or 1:19 or 1:18 or 1:17 or 1:16 or 1:15 or 1:14 or 1:13 or 1:12 or 1:11 or 1:10 or 1:9.5 or 1:9 or 1:8.5 or 1:8 or 1:7.5 or 1:7 or 1:6.5 or 1:6 or 1:5.5 or 1:5 or 1:4.5 or 1:4 or 1:3.5 or 1:3 or 1:2.5 or 1:2 or 1:1.5 or 1:1.4 or 1:1.3 or 1:1.2 or 1:1.1 or 19.5:1 or 18.5:1 or 17.5:1 or 16.5:1 or 16.0:1 or 15.5:1 or 15.0:1 or 14.5:1 or 14.0:1 or 13.5:1 or 13.0:1 or 12.5:1 or 12.0:1 or 11.5:1 or 11.0:1 or 10.5:1 or 10.0:1 or 9.5:1 or 9.0:1 or 8.5:1 or 8.0:1 or 7.5:1 or 7.0:1 or 6.5:1 or 6.0:1 or 5.5:1 or 5.0:1 or 4.5:1 or 4.0:1 or 3.5:1 or 3.0:1 or 2.5:1 or 2.0:1 or 1.5:1 or 1.4:1 or 1.3:1 or 1.2:1 or 1.1:1.

For example, LiBH₄ or Li[AlH₂(OC)₂H₄OCH₃)₂] or Li[Et₃AlH] or Li[Et₃BH], or a mixture thereof can be selected as the first hydridic reducing agent Z₁, and Z₂LiH can be selected as the second hydridic reducing agent. In this case, the boron trihydride BH₃ or B₂H₆ and/or [(H₃COH₄C₂O)₂AlH]ₓ and/or triethylaluminum Et₃Al or (Et₃Al)₂ and/or triethylborane Et₃B obtained or being obtained is captured by the electron pair donor LiH, which is poorly soluble to insoluble in, in particular aprotic polar, solvents, such as ethers, e.g., tetrahydrofuran or diethyl ether, or by the hydride anion H⁻ thereof. In this case, the first hydridic reducing agent LiBH₄ and/or Li[AlH₂(OC)₂H₄OCH₃)₂] and/or Li[Et₃AlH] and/or Li[Et₃ BH] is advantageously regenerated without further intervention. Consequently, the first hydridic reducing agent Z₁, which is used for the reaction with the azulene or the azulene derivative and which typically has good to very good solubility in the respective solvent S_{P}, is available again as a soluble, hydride-transferring reagent. Consequently, the relatively cost-intensive first hydridic reducing agent LiBH₄ and/or Li[AlH₂(OC)₂H₄OCH₃)₂] and/or Li[Et₃AlH] and/or Li[Et₃ BH]— based on the respective starting material azulene or azulene derivative—can advantageously also be used in a substoichiometric amount, in particular in a catalytic amount. This is particularly advantageous in terms of a large-scale application of the embodiment variant described here, specifically from an (atom) economic and ecological perspective. This is because, on the one hand, a smaller amount of the relatively expensive first hydridic reducing agent Z₁ is required, and on the other hand it is fully used up. With regard to the relatively cost-effective second hydridic reducing agent lithium hydride, which is commercially available in large amounts, it may be advantageous, in particular due to its solubility behavior, to use an excess, based on the respective reactant azulene or azulene derivative. Optionally, unreacted lithium hydride can be quantitatively separated off by means of a simple filtration step, optionally via silica, e.g., Celite® and/or by centrifuging and/or decanting. A lithium hydride contamination of the compounds according to the general formula M^{A}Yₙ(AzuH) (I), which can be produced by means of the method described here, can thus be ruled out. The respective M^{A}Yₙ(AzuH) (I)-type target compound typically demonstrates good to very good solubility in the, in particular aprotic non-polar, solvent S_{P} used.

The use of lithium hydride is also advantageous for safety reasons. This is because, in contrast to other hydride-transferring reagents, it is not pyrophoric in air and, as a result of passivation, can even be handled in air for a short time.

The fact that this process management is particularly advantageous from an (atom) economic and ecological perspective can be easily understood based on the reaction equations (4) through (6) and (7) through (9) and (10) through (12) listed below:

$$Azu + L i [ B {H}_{4} ] \to Li ( AzuH ) + {BH}_{3} \qquad ( 4 )$$

$$\underline{{BH}_{3} + L i H \to Li [ {BH}_{4} ]} \qquad ( 5 )$$

$$Azu + LiH \to Li ( AzuH ) \qquad ( 6 )$$

$$Azu + L i [ A l {{H}_{2} ( O {C}_{2} {H}_{4} O C {H}_{3} )}_{2} ] \to Li ( AzuH ) + {[ {( {H}_{3} C O {H}_{4} {C}_{2} O )}_{2} A l H ]}_{x} \qquad ( 7 )$$

$${[ {( {H}_{3} C O {H}_{4} {C}_{2} O )}_{2} AlH ]}_{x} + L i H \to Li [ Al {{H}_{2} ( O {C}_{2} {H}_{4} O C {H}_{3} )}_{2} ] \qquad ( 8 )$$

$$A zu + LiH \to Li ( AzuH ) \qquad ( 9 )$$

$$Azu + Li [ E {t}_{3} B H ] \to Li ( AzuH ) + {Et}_{3} B \qquad ( 10 )$$

$$\underline{{Et}_{3} B + L i H} \to \underline{Li [ {Et}_{3} BH ]} \qquad ( 11 )$$

$$A zu + LiH \to Li ( AzuH ) \qquad ( 12 )$$

In this case, Azu and AzuH are each as defined above. Li(AzuH) also comprises in each case solvent solvates thereof in which solvated lithium ions are present.

The reaction equations for the reaction of Azu with Li[Et₃AlH] as first hydridic reducing agent Z₁ and LiH as second hydridic reducing agent Z₂ can be formulated analogously to equations (10) through (12).

If, in the method described here, an azulene derivative is used as the reactant, it is provided that the azulene scaffold on one carbon atom or multiple carbon atoms, selected from the group consisting of the carbon atoms C1, C2, C3, C4, C5, C6, C7 and C8, has a substituent R^{F}. At the same time, at least one of the carbon atoms C4, C6 and C8 should bear an H atom. The regioselectivity of the nucleophilic addition of the hydride anion H⁻ provided by the at least one hydridic reducing agent Z can be influenced in particular by the choice of the substitution pattern of the azulene derivative. It is therefore possible to directly influence the number of regioisomers to be expected. If bicyclo[5.3.0] decapentene, i.e., azulene, according to general formula II, is used as the reactant, the hydride anion H⁻ can be added nucleophilically in the 4 position (C4), in the 6 position (C6) or in the 8 position (C8) of the azulene. This is because the carbon atoms C4, C6 and C8, as is known, have a comparable nucleophilicity. Therefore, a mixture of three regioisomers is obtained when unsubstituted azulene is used as reactant. By contrast, for example in the case of the azulene derivative 7-iso-propyl-1,4-dimethylazulene (guaiazulene), regioselective addition of the hydride anion in the 8 position, i.e., on the carbon atom C8, is observed. Therefore, using the method described here, the preparation of isomerically pure compounds according to the general formula M^{A}Yₙ (AzuH) (I) is possible, especially as a function of the substitution pattern of the azulene derivative selected as the reactant. One example is lithium-7-isopropyl-1,4-dimethyl-8-H-dihydroazulenide, which can also be referred to as lithium-8-H-dihydroguaiazulenide.

According to one embodiment of the method, an azulene derivative is provided in step A, wherein at least one hydrogen atom is provided
on the carbon atoms C4 and C6
or
on the carbon atoms C8 and C6
or
on the carbon atom C4 and/or on the carbon atom C8 of the azulene skeleton, an H atom is provided.

According to another variant of the method described here, an azulene derivative is provided in step A., wherein at least one carbon atom of the azulene scaffold, selected from the group consisting of C1, C2 and C3, bears a substituent R^{F} and the carbon atoms C4, C5, C6, C7 and C8 of the azulene scaffold each bear an H atom.

In yet another embodiment, at least one carbon atom of the azulene scaffold, selected from the group consisting of C4, C5, C6, C7 and C8, bears a substituent R^{F}, and the carbon atoms C1, C2 and C3 of the azulene scaffold each bear an H atom.

In a further variant of the method, a disubstituted azulene derivative is used as the reactant in step A. It is provided, for example, that exactly one carbon atom of the five-membered ring, i.e., C1 or C2 or C3, and exactly one carbon atom of the seven-membered ring, i.e., C4 or C5 or C6 or C7 or C8, bear a substituent R^{F}.

An alternative embodiment of the method provides a trisubstituted azulene derivative as the reactant in step A. It is provided, for example, that exactly one carbon atom of the five-membered ring, i.e., C1 or C2 or C3, and exactly two carbon atoms of the seven-membered ring, i.e., two of the carbon atoms C4, C5, C6, C7, C8, bear a substituent R^{F}.

According to yet another method variant, a tetrasubstituted azulene derivative is provided in step A. It is provided, for example, that exactly one carbon atom of the five-membered ring, i.e., C1 or C2 or C3, and exactly three carbon atoms of the seven-membered ring, as three of the carbon atoms C4, C5, C6, C7, C8, bear a substituent R^{F}.

In a further embodiment of the method, an azulene derivative is provided in step A., wherein at least the carbon atoms C1, C4 and C7 of the azulene scaffold bear a substituent R^{F} or one of the isomers thereof.

The azulene derivative can be selected, for example, from the group consisting of 1,4,7-trimethylazulene, 7-ethyl-1,4-dimethylazulene (chamazulene), 7-n-propyl-1,4-dimethylazulene, 7-isopropyl-1,4-dimethylazulene (guiazulene), 7-n-butyl 1,4-dimethylazulene, 7-isobutyl-1,4-dimethylazulene, 7-secbutyl-1,4-dimethylazulene, 7-tertbutyl-1,4-dimethylazulene, 7-n-bentyl-1,4-dimethylazulene, 7-isopentyl 1,4-dimethylazulene, 7-neopentyl-1,4-dimethylazulene, 7-n-hexyl-1,4-dimethylazulene, 7-isohexyl-1,4-dimethylazulene, 7-(3-methylpentane)-1,4-dimethylazulene, 7-neohexyl-1,4-dimethylazulene, 7-(2,3-dimethylbutane)-1,4-dimethylazulene, and isomers thereof.

Guaiazulene is a natural substance which contains chamomile oil and other essential oils and, advantageously, is thus available cost-effectively in large quantities. It can be produced synthetically from guaiol of the guaiac wood oil (guaiac resin). Guaiazulene is an intensely blue substance with anti-inflammatory action. One isomer of guaiazulene is, for example, 2-isopropyl-4,8-dimethylazulene (vetivazulene).

In another variant of the method, at least one hydridic reducing agent Z is selected from the group consisting of alkali metal hydrides M^{A}H, alkali metal boron tetrahydrides M^{A}BH₄, alkali metal trialkylborohydrides M^{A}[(R)^{C})₃BH], alkali metal aluminum tetrahydrides M^{A}AlH₄, alkali metal trialkylaluminum hydrides M^{A}[(R)^{D})₃AlH], alkali metal dihydridobis(dialkoxy)aluminates M^{A}[AlH₂(OR^{E})₂], and mixtures thereof, wherein
i. the radicals R^{C} and R^{D} are each selected independently of one another from the group consisting of primary, secondary, tertiary alkyl, alkenyl and alkynyl radicals having 1 to 10 carbon atoms,
wherein in each case two substituents R^{C} or two substituents R^{D} can optionally form a ring,
and
ii. the radicals OR^{E} are each independently of one another a corresponding base of a glycol ether R^{E}OH.

In another embodiment of the method, the alkali metal dihydridobis(dialkoxy)aluminate according to the general formula M^{A}[AlH₂(OR^{E})₂], where M^{A}=Li, Na or K, is produced in situ by a reaction of M^{A}AlH₄, i.e., LiAlH₄, NaAlH₄ or KAlH₄, with a glycol ether R^{E}OH. A molar ratio is thereby M^{A}AlH₄:glycol ether R^{E}OH 1:2, i.e., 0.5.

In the context of the present invention, the phrase “prepared/produced in situ” or “in situ production” means that the reactants required for the synthesis of a compound to be prepared in this way are reacted in a suitable stoichiometry in a solvent or solvent mixture and the resulting product is not isolated. Instead, the solution or the suspension, which comprises the compound produced in situ, is generally reused directly, i.e., without isolation and/or further purification. The in situ production of a compound can take place in the reaction container provided for the further use thereof or in a different reaction vessel. The terms reaction container and reaction vessel have already been defined further above.

In yet another embodiment of the claimed method, the glycol ether R^{E}OH, which is used for the in situ preparation of a reducing agent according to the general formula M^{A}[AlH₂(OR^{E})₂]— starting from LiAlH₄, NaAlH₄ or KAlH₄—is selected from the group consisting of monooxomethylene monoethers, monoethylene glycol monoethers, monopropylene glycol monoethers, and isomer mixtures thereof, and mixtures thereof. In an advantageous variant, a monoethylene glycol monoether is used. For example, the alcoholysis takes place starting from LiAlH₄, NaAlH₄ or KAlH₄ and a monoglycol monoether R^{E}OH, wherein in particular R^{E}=C₂H₄OCH₃ or C₂H₄OC₄H₉, in an aliphatic or aromatic solvent, e.g., n-pentane, n-hexane, toluene, or p-cymene. The synthesis can be carried out, for example, in a temperature range of −10° C. to 40° C., wherein it is absolutely essential that there is the possibility of gas equalization.

Polyethers are also understood as glycol ethers. In one variant of the method, the glycol ether is selected from the group consisting of 2-methoxyethanol CH₃—O—CH₂CH₂—OH, 2-ethoxyethanol CH₃CH₂—O—CH₂CH₂—OH, ethylene glycol mono-n-propyl ether CH₃CH₂CH₂—O—CH₂CH₂—OH, ethylene glycol mono-isopropyl ether (CH₃)₂CH—O—CH₂CH₂—OH, ethylene glycol mono-n-butyl ether CH₃CH₂CH₂CH₂—O—CH₂CH₂—OH, ethylene glycol mono-n-pentyl ether CH₃CH₂CH₂CH₂CH₂—O—CH₂CH₂—OH, ethylene glycol mono-n-hexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, propylene glycol monomethyl ether CH₃—OCH₂CH₂CH₂—OH, propylene glycol monoethyl ether CH₃CH₂—OCH₂CH₂CH₂—OH, propylene glycol mono-n-propyl ether CH₃CH₂CH₂—OCH₂CH₂CH₂—OH, propylene glycol mono-n-butyl ether CH₃CH₂CH₂CH₂—OCH₂CH₂CH₂—OH, propylene glycol mono-n-pentyl ether CH₃CH₂CH₂CH₂CH₂—OCH₂CH₂CH₂—OH, propylene glycol mono-n-hexyl ether CH₃CH₂CH₂CH₂CH₂CH₂—OCH₂CH₂CH₂—OH, propylene glycol monophenyl ether C₆H₅—OCH₂CH₂CH₂—OH, propylene glycol monobenzyl ether C₆H₅CH₂—OCH₂CH₂CH₂—OH isopropylene glycol monomethyl ether CH₃—O—CH₂—CH(CH₃)—OH, isopropylene glycol monoethyl ether CH₃CH₂—O—CH₂—CH(CH₃)—OH, isopropylene glycol mono-n-propyl ether CH₃CH₂CH₂—O—CH₂—CH(CH₃)—OH, isopropylene glycol monoisopropyl ether (CH₃)₂CH—O—CH₂—CH(CH₃)—OH, iso-propylene glycol mono-n-butyl ether CH₃CH₂CH₂CH₂—O—CH₂—CH(CH₃)—OH, isopropylene glycol mono-n-pentyl ether CH₃CH₂CH₂CH₂CH₂—O—CH₂—CH(CH₃)—OH, isopropylene glycol mono-n-hexyl ether CH₃CH₂CH₂CH₂CH₂CH₂—O—CH₂—CH(CH₃)—OH, isopropylene glycol monophenyl ether C₆H₅—O—CH₂—CH(CH₃)—OH, isopropylene glycol monobenzyl ether C₆H₅CH₂—O—CH₂—CH(CH₃)—OH, 1-methoxy-2-propanol CH₃—OCH₂CH(CH₃)—OH, 1-butoxypropan-2-ol C₄H₉—O—CH₂CH(CH₃)—OH, 1-propoxy-2-propanol CH₃CH₂CH₂—O—CH₂CH(CH₃)—OH and mixtures thereof. The stated glycol ethers can also be used as isomer mixtures.

According to a further embodiment of the method, the electron pair donor E is a base, selected from the group consisting of organic, organometallic and inorganic bases, and mixtures thereof. In particular, the electron pair donor E is a Lewis base.

In a further embodiment of the claimed method, the electron pair donor E is an organic or inorganic base. The electron pair donor E is advantageously selected from the group consisting of primary, secondary and tertiary amines, organic amides, heterocyclic oxygen bases, heterocyclic nitrogen bases, ammonia, alkali metal carbonates, alkali metal oxides and alkali metal amides, and mixtures thereof. If the electron pair donor E is an alkali metal oxide and/or an alkali metal amide, it is advantageously selected from the group consisting of lithium, sodium and potassium oxide and lithium, sodium and potassium amide. In particular, the electron pair donor E is selected from the group consisting of amines, organic amides, heterocyclic oxygen bases, heterocyclic nitrogen bases and ammonia. N,N-dimethylformamide (DMF) or hexamethylphosphoramide (HMPT), for example, can be provided as organic amide. The heterocyclic oxygen base may, for example, be selected from the group consisting of tetrahydrofuran, 2-methyltetrahydrofuran, 3-methyltetrahydrofuran, 1,4-dioxane and tetrahydropyran, and mixtures thereof. When amine is used, it is generally possible to use different amines, including as a mixture, such as primary, secondary or tertiary amines. Alkylamines can advantageously be used here. These can be methylamine, ethylamine, propylamine, isopropylamine, butylamine, tertbutylamine, cyclohexylamine, dimethylamine, diethylamine, dipropylamine, diisopropylamine, dibutylamine, ditertbutylamine, dicyclohexylamine, trimethylamine, triethylamine, tripropylamine, triisopropylamine, tributylamine, tritertbutylamine, tricyclohexylamine, and derivatives and mixtures thereof. Mixed substituted amines and mixtures thereof are also conceivable, such as diisopropylethylamine (DIPEA). Likewise, urotropine, acetamidine, ethylenediamine, triethylenetetramine, morpholine, N-methylmorpholine, 1,8-diazabicyclo[5.4.0]undec-7-ene (DBU), DABCO®, TMEDA, guanidines, urea, thiourea, imines, aniline, pyridine, pyrazole, pyrimidine, imidazole, hexamethyldisilazane or combinations thereof can be used as base.

A further embodiment of the method provides that the reaction of the azulene or of the azulene derivative with the at least one hydridic reducing agent Z in the solvent S_{P} comprises the following step:
i) providing the azulene or the azulene derivative
as a substance or as a solution or suspension in a solvent, which is miscible with or identical to the solvent S_{P},
and
ii) adding the at least one hydridic reducing agent Z
as a substance or as a solution or suspension in a solvent, which is miscible with or identical to the solvent S_{P},
wherein, during the addition and/or after the addition of Z, a reaction of the azulene or of the azulene derivative with Z takes place.

The term “substance” here comprises, in particular, solids, liquids and liquid crystals.

In an alternative embodiment of the method, it is provided that in step i) the hydridic reducing agent Z is provided and in step ii) the azulene or the azulene derivative is added.

According to another embodiment variant, in step i) and/or in step ii) and/or in a subsequent step iii), the at least one electron pair donor E is added. This can be provided, for example, when the hydridic reducing agent Z comprises, for example, at least one alkali metal aluminum tetrahydride M^{A}AlH₄ or consists of one or more alkali metal aluminum tetrahydrides M^{A}AlH₄. Typically, the addition of the at least one electron pair donor E advantageously results in a quantitative capture of a Lewis acid, such as aluminum trihydride AlH₃ or (AlH₃)ₓ, obtained and/or being obtained as by-product, this being with the formation of Lewis acid/Lewis base complexes E-AlH₃.

Another embodiment of the method provides that the electron pair donor E is added by introducing a gas or liquid, introducing a solution, advantageously in the solvent S_{P} or an, in particular aprotic polar, solvent that is miscible therewith, or by applying pressure via the reaction solution in a closed pressure container.

In a further variant of the method, it is provided that the at least one hydridic reducing agent Z and/or of the at least one electron pair donor E is added to the solution or to the suspension of the azulene or of the azulene derivative in the, in particular aprotic polar, solvent or solvent mixture S_{P} using a metering device. The addition can take place, for example, by dropwise addition or injection. Alternatively or additionally, a shut-off valve and/or a stop valve can be provided in a supply line of the reaction vessel. The solvent S_{P} may optionally represent a mixture of multiple, in particular aprotic polar, solvents.

Depending on the choice of solvent or solvent mixture S_{P}, the reactants used, including the optionally provided electron pair donor E, and also of the other reaction conditions, such as, for example, addition form of the hydridic reducing agent Z and/or of the electron pair donor E, for example as a substance, i.e., as a gas, liquid or solid, or dissolved or suspended in a solvent, in particular in the solvent S_{P} or a solvent miscible therewith, speed of adding the hydridic reducing agent Z and/or the electron pair donor E, stirring speed, internal temperature of the reaction vessel, the reaction of the azulene or of the azulene derivative already takes place during the addition and/or after the addition of the at least one hydridic reducing agent Z and/or the at least one electron pair donor E.

Furthermore, a method variant is provided in which the azulene or the azulene derivative is reacted with the at least one hydridic reducing agent Z, optionally with the provision of an electron pair donor E, in the, in particular aprotic polar, solvent or solvent mixture S_{P} at a temperature T_{U}, wherein the temperature T_{U} is between −30° C. and 100° C., advantageously between −20° C. to 80° C., in particular between −10° C. and 70° C. The reaction at a temperature Tᵤ between −10° C. and 60° C. is particularly energy efficient and thus cost efficient.

Temperature Tᵤ means the internal temperature Tᵤ of the respective reaction vessel.

An internal temperature of the respective reaction vessel can be determined by means of a temperature sensor or multiple temperature sensors for one or more regions of the reaction vessel. At least one temperature sensor is provided for determining the temperature Tᵤ, which generally corresponds to an average temperature T_{D1} of the reaction mixture.

In a further variant of the method, the internal temperature Tᵤ of the reaction vessel is regulated and/or controlled using a heat transfer medium Wu. For this purpose, a cryostat can be used, for example, which contains the heat transfer medium Wu, which ideally can function both as a coolant and as a heating medium. By using the heat transfer medium Wu, deviations of the temperature Tᵤ from a target value T_{S1} defined for the reaction of the azulene or azulene derivative with the at least one hydridic reducing agent Z, optionally in the presence of the electron pair donor E, is largely captured or compensated. Typical device deviations render it hardly possible to realize a constant temperature Tᵤ. By using the heat transfer medium Wu, the azulene or azulene derivative can be reacted out with the hydridic reducing agent Z, optionally in the presence of the electron pair donor E but at least in a preselected temperature range or in multiple preselected temperature ranges. For example, depending on the remaining reaction parameters, it may be advantageous to provide a temperature program for even better control of the course of the reaction and/or of the exothermic reaction. For example, a lower temperature or a lower temperature range can be selected during a first phase of the reaction of the azulene or azulene derivative with the hydridic reducing agent Z than in a second phase of the reaction of the azulene or azulene derivative with the at least one hydridic reducing agent Z. It is also possible to provide more than two phases of the addition and thus more than two preselected temperatures or temperature ranges. Depending on the choice of the other reaction conditions, such as, for example, the concentration of the hydridic reducing agent and the solvent or solvent mixture, it may be favorable during the addition and/or after the addition of Z and optionally E to increase the internal temperature Tᵤ of the reaction vessel using the heat transfer medium W_{U}. As a result, it can optionally be ensured that the azulene or azulene derivative is reacted with the at least one hydridic reducing agent Z quantitatively, optionally with provision of an electron pair donor E. The duration of the increase in the internal temperature Tᵤ of the reaction vessel using the heat transfer medium Wᵤ can be, for example, between 10 min and 96 h.

In yet another variant, the solvent S_{P} is chemically inert.

In the context of the present invention, the term “inert solvent” means a solvent which is not chemically reactive under the respective process conditions. Under the respective reaction conditions, including the purification and/or isolation steps, the inert solvent therefore does not react with a potential reaction partner, in particular not with a reactant and/or an intermediate and/or a product and/or a by-product, and not with another solvent, air, or water.

In a further embodiment of the method, it is provided that after the reaction in step B. or after step C. or after step D a step is carried out comprising an isolation of M^{A}Yₙ (AzuH) (1):
as a suspension or solution comprising M^{A}Yₙ(AzuH) (I) and at least one, in particular aprotic polar, solvent S_{P},
or
as a liquid or solid.

In a further variant of the method, the isolation comprises a filtration step. Multiple filtration steps may also be provided, optionally also one or more filtrations over a cleaning medium, such as activated carbon or silica, e.g., Celite®.

The isolation of the compound of the general formula M^{A}Yₙ(AzuH) (I) as a solution or as a solid may comprise further method steps, such as the reduction of the mother liquor volume, i.e., concentration, for example by means of “bulb-to-bulb”, the addition of a solvent and/or a solvent exchange to precipitate the product from the mother liquor and/or to remove impurities and/or reactants, washing, e.g., with pentane and/or hexane, and drying of the product. The aforementioned steps may each be provided in different orders and frequencies.

Advantageously, the filtrate, centrifugate, or decantate or the solid may be subjected to purification and/or isolation steps which may be carried out rapidly and without complication and without special effort in terms of preparation. Overall, the purification and/or isolation of the target compound according to the general formula M^{A}Yₙ(AzuH) (I) is relatively simple and inexpensive.

In general, the end product may still contain residues of solvents or for example impurities from the reactants. Isolated M^{A}Yₙ(AzuH) (I)-type compounds have a purity of at least 97%, advantageously more than 97%, in particular more than 98% or 99%. The reproducible yield, in particular as a function of the choice of reactant and of the solvent or mixture of solvents, is typically 60%, even when scaling up to industrial scale.

In addition, the object is achieved by a solution or a suspension comprising M^{A}Yₙ(AzuH) (I) and at least one, in particular aprotic polar, solvent S_{P}, obtained or obtainable by a method according to one of the embodiments described further above.

The solvent S_{P} is advantageously an aprotic polar solvent or comprises at least one aprotic polar solvent. For example, the solvent S_{P} is an ether or comprises at least one ether. The ether can be selected from the group consisting of tetrahydrofuran, methyl tetrahydrofuran, 1,4-dioxane, diethyl ether, methyltertbutyl ether, di-n-propyl ether, diisopropyl ether, cyclopentyl methyl ether, and isomers thereof, and mixtures thereof.

The solutions or suspensions are characterized in particular by high purity of the M^{A}Yₙ (AzuH) (I)-type compound contained therein.

The compounds according to the general formula M^{A}Yₙ(AzuH) (I) and obtainable by means of the method described here, each have one H-dihydroazulenyl anion (AzuH)¹⁻, which represents a derivative of the cyclopentadienyl anion or a cyclopentadienyl-like monoanion. It is particularly advantageous that the compounds obtainable by means of the method described here and comprising cyclopentadienyl-like monoanions (AzuH)¹⁻ have good to very good long-term stability at room temperature. When stored for several months at room temperature, neither decomposition reactions nor oligomerization or polymerization are observed. This is advantageous, particularly with respect to the further use of the M^{A}Yₙ(AzuH) (I)-type compounds, in particular for the production of sandwich and semi-sandwich complexes. Furthermore, the preparation according to the method claimed here of alkali metal H-dihydroazulenides of the general formula M^{A}Yₙ(AzuH) (I), comprising cyclopentadienyl-like monoanions (AzuH)¹⁻, is less intensive in terms of work and time than the provision of LiCp. Usable reactants, such as, for example, natural substances, like guaiazulene, and hydridic reducing agents, like lithium triethylborohydride, are not only easier to handle and store, but also more cost-effective. In addition, fewer and simpler working steps have to be carried out.

Therefore, with the method claimed here, M^{A}Yₙ(AzuH) (I)-type compounds, comprising cyclopentadienyl-like monoanions (AzuH)¹⁻, can be obtained easily and reproducibly and, depending on the choice of reactants, sustainably and comparatively cost-effectively. The target compounds obtained are present in a high purity of at least 97%, advantageously of more than 97%, in particular of more than 98% or 99%, and in good yields, also space-time yields of 60%. This also applies to production on an industrial scale.

The object is further achieved by compounds according to the general formula M^{A}Yₙ (AzuH) (I), obtained or obtainable by a method according to one of the embodiments described above.

Whether the compounds claimed here according to the general formula M^{A}Yₙ(AzuH) (I) are present as solvent adducts, in particular ether adducts, depends on various factors, for example on the solvent used for the preparation of compounds according to the general formula I and also on the type of alkali metal cation M^{A}+, that is to say the hydridic reducing agent Z, used. If, for example, during the synthesis, including the purification, a solvent was used, which comprised one or more ethers or consisted thereof, and at least one hydridic reducing agent Z having a lithium cation was used, then in all probability an ether adduct Li(ether)ₙ(AzuH) (I), where n=1 or 2, will be present. If, in conclusion, such an ether adduct were washed with a non-ethereal solvent, such as, for example, pentane or hexane, a solvent-free compound of the general formula Li(AzuH) (I) typically occurs.

An advantage of the compounds obtainable by means of the method described above is that their production can be achieved easily and reproducibly and, depending on the choice of reactants, can be realized sustainably and relatively cost-effectively. Depending on the process management, in particular on the choice of hydridic reducing agent Z, the desired compounds of M^{A}Yₙ(AzuH) (I)—as already described above—are isolated, for example by means of simple filtration and/or by centrifuging and/or by decanting. The target compounds are routinely present, even without further purification, in a high purity of 97%, advantageously of more than 97%, in particular of more than 98% or 99%. In addition, good yields, as well as space-time yields, of >60% are achieved using the method claimed here. Advantageously, production on an industrial scale is also possible, with a comparable purity and yield.

In particular, compounds according to the general formula M^{A}Yₙ(AzuH) (I), where AzuH=GuaH=7-isopropyl-1,4-dimethyl-8-H-dihydroazulene, obtained or obtainable by a method according to any one of the embodiments described above, are to be assessed as sustainable. This is because these compounds which comprise cyclopentadienyl-like ligands can be produced using inexpensive renewable raw materials. The guide price of partially synthetic guaiazulene based on the natural substance guaiol and other azulene formers available by simple dehydration and dehydrogenation (T. Shono, N. Kise, T. Fujimo, N. Tenchaga, H. Morita, J. Org. Chem. 1992, 57, 26, 7175-7187; CH 314 487 A (B. Joos) Jan. 29, 1953) is € 74.70 per 25 g (Sigma Aldrich, 12/2020).

The object is also achieved by a compound of the general formula

M^{A}Yₙ(AzuH) (I),
wherein
   M^{A} is an alkali metal,
   Y is a neutral ligand which is bonded or coordinated to M^{A} via at least one donor atom, wherein H₂O is excluded,
   n=0, 1, 2, 3, or 4
and
   AzuH=azulene or an azulene derivative that bears a hydride anion in the 4, 6 or
8 position in addition to an H atom,
wherein
Azu=azulene according to the formula

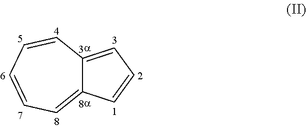

or
Azu=an azulene derivative having an azulene scaffold according to formula II consisting of a five-membered ring and a seven-membered ring,
wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom,
wherein
the compounds Li(O(C₂H₅)₂)ₙ(AzulenH) and Li(O(C₂H₅)₂)ₙ(GuaH),
wherein
   n=0, 1 or 2,
   azuleneH=azulene that bears a hydride anion in the 4, 6 or 8 position in addition to an H atom,
   GuaH=7-isopropyl-1,4-dimethyl-8-H-dihydroazulene,
are excluded.

Compounds according to the general formula M^{A}Yₙ(AzuH) (I) are hereinafter referred to as alkali metal-H-dihydroadulides, which optionally are present as solvent adducts, in particular ether adducts, which are also referred to as ethers. Compounds according to the general formula M^{A}Yₙ (AzuH) (I) can also be present as isomer mixtures. This also applies to the compound Li(O(C(C)₂H₅)₂)ₙ (azuleneH) excluded here.

The compounds claimed here according to the general formula M^{A}Yₙ(AzuH) (I) each have one H-dihydroazulenyl anion (AzuH)¹⁻, which represents a derivative of the cyclopentadienyl anion or a cyclopentadienyl-like monoanion. The H-dihydroazulenyl anion (AzuH)¹⁻ may be a 3α,4-H-dihydroazulenyl, a 8,8α-H-dihydroazulenyl, a 3α,6-H-dihydroazulenyl or a 6,8α-H-dihydroazulenyl anion, or a mixture of two or more regioisomers.

It is particularly advantageous that the compounds of this type comprising cyclopentadienyl-like monoanions (AzuH)¹⁻ have good to very good long-term stability at room temperature. When stored for several months at room temperature, neither decomposition reactions nor oligomerization or polymerization are observed. This is advantageous, particularly with respect to the further use of the compounds according to the general formula M^{A}Yₙ(AzuH) (I), in particular for the production of sandwich and semi-sandwich complexes. Furthermore, the preparation of alkali metal H-dihydroazulenides of the general formula M^{A}Yₙ(AzuH) (I) comprising cyclopentadienyl-like monoanions (AzuH)¹⁻ requires less work and time compared to the provision of LiCp. Usable reactants, such as, for example, natural substances, like guaiazulene, and hydridic reducing agents, like lithium triethylborohydride, are not only easier to handle and store, but also more cost-effective. In addition, fewer and simpler working steps have to be carried out.

The M^{A}Yₙ(AzuH) (I)-type compounds described here, comprising cyclopentadienyl-like monoanions (AzuH)¹⁻, can be obtained easily and reproducibly and, depending on the choice of reactants, sustainably and comparatively inexpensively. In addition, high purity and good yields, as well as space-time yields, can be achieved. They are therefore also suitable for use in industrial processes.

In particular, compounds according to the general formula M^{A}Yₙ(AzuH) (I), where AzuH=GuaH=7-isopropyl-1,4-dimethyl-8-H-dihydroazulene, are to be assessed as sustainable. This is because these compounds which comprise cyclopentadienyl-like ligands can be produced using inexpensive renewable raw materials. The guide price of partially synthetic guaiazulene based on the natural substance guaiol and other azulene formers available by simple dehydration and dehydrogenation (T. Shono, N. Kise, T. Fujimo, N. Tenchaga, H. Morita, J. Org. Chem. 1992, 57, 26, 7175-7187; CH 314 487 A (B. Joos) Jan. 29, 1953) is € 74.70 per 25 g (Sigma Aldrich, 12/2020).

According to one embodiment of the claimed compounds, it is provided that Azu=azulene, wherein the compound according to the general formula M^{A}Yₙ (azuleneH) (I) is present as an isomer mixture or in isomerically pure form, wherein the isomer mixture comprises at least two regioisomers selected from the group consisting of a first regioisomer, a second regioisomer and a third regioisomer. The first regioisomer has a CH₂ group in the C4 position of the azulene, the second regioisomer has a CH₂ group in the C6 position of the azulene, and the third regioisomer has a CH₂ group in the C8 position. In other words: In the case of the first regioisomer, the carbon atom C4 bears an H atom and a hydride anion H⁻, in the case of the second regioisomer, the carbon atom C6 bears an H atom and a hydride anion H⁻, and in the case of the third regioisomer, the carbon atom C8 bears an H atom and a hydride anion H⁻.

While the carbon atoms C4, C6 and C8 of the bicyclo[5.3.0]decapentaene (=azulene) are known to have a comparable nucleophilicity, the carbon atoms C4, C6 and C8 of an azulene derivative, i.e., of a substituted azulene, generally have a different nucleophilicity. Therefore, M^{A}Yₙ (AzuH) (I)-type compounds, where Azu=is an azulene derivative—depending on the substitution pattern of the azulene derivative—are present not only as mixtures of three regioisomers, but advantageously also as isomer mixtures containing only two regioisomers, or particularly advantageously as isomerically pure compounds.

In the context of the present invention, “isomerically pure” means that the desired product is obtained or was obtained in isomerically pure form or the desired isomer is present after purification with a content of >90%, preferably of ≥95%, more preferably of ≥99%. Isomer purity is determined, for example, by means of nuclear magnetic resonance spectroscopy.

In another embodiment of the M^{A}Yₙ(AzuH) (I)-type compounds claimed here, it is provided that Azu=is an azulene derivative, wherein the compound according to the general formula M^{A}Yₙ(AzuH) (I) is present as an isomer mixture or in isomerically pure form.

If Azu=azulene derivative and if the compound according to the general formula M^{A}Yₙ(AzuH) (I) is present as an isomer mixture, the isomer mixture comprises at least two regioisomers selected from the group consisting of a first regioisomer, a second regioisomer and a third regioisomer. The first regioisomer has a CH₂ group in the C4 position of the azulene scaffold, the second regioisomer has a CH₂ group in the C6 position of the azulene scaffold, and the third regioisomer has a CH₂ group in the C8 position. In other words: In the case of the first regioisomer, the carbon atom C4 bears an H atom and a hydride anion H⁻, in the case of the second regioisomer, the carbon atom C6 bears an H atom and a hydride anion H⁻, and in the case of the third regioisomer, the carbon atom C8 bears an H atom and a hydride anion H⁻.

If Azu=azulene derivative and if the compound of the general formula M^{A}Yₙ (AzuH) (I) is present in isomerically pure form, then either
i. the carbon atom C4 of the azulene scaffold
or
ii. the carbon atom C6 of the azulene scaffold
or
iii. the carbon atom C8 of the azulene scaffold
bears a hydride anion H⁻ in addition to the one H atom.

Therefore, a CH₂ group is present either in the C4 position or alternatively in the C6 position or in the C8 position of the azulene scaffold. In other words: There is only one regioisomer.

According to one variant of the compounds claimed here according to the general formula M^{A}Yₙ(AzuH) (I), where Azu=is an azulene derivative, at least one carbon atom of the azulene scaffold, selected from the group consisting of C1, C2 and C3, bears a substituent R^{F} and the carbon atoms C4, C5, C6, C7 and C8 of the azulene scaffold each bear an H atom.

In another embodiment of the M^{A}Yₙ(AzuH) (I)-type compounds described here, where Azu=is an azulene derivative, at least one carbon atom of the azulene scaffold, selected from the group consisting of C4, C5, C6, C7 and C8, bears a substituent R^{F} and the carbon atoms C1, C2 and C3 of the azulene scaffold each bear an H atom.

In a further variant of the compounds claimed here according to the general formula M^{A}Yₙ(AzuH) (I), where Azu=is an azulene derivative, it is provided that exactly one carbon atom of the five-membered ring, i.e., C1 or C2 or C3, and exactly one carbon atom of the seven-membered ring, i.e., C4 or C5 or C6 or C7 or C8, bear a substituent R^{F}.

An alternative embodiment of the compounds claimed here according to the general formula M^{A}Yₙ(AzuH) (I), where Azu=is an azulene derivative, provides that exactly one carbon atom of the five-membered ring, i.e., C1 or C2 or C3, and exactly two carbon atoms of the seven-membered ring, i.e., two of the carbon atoms C4, C5, C6, C7, C8 bear a substituent R^{F}.

According to yet another embodiment variant of the compounds described here according to the general formula M^{A}Yₙ(AzuH) (I), where Azu=is an azulene derivative, it is provided that exactly one carbon atom of the five-membered ring, i.e., C1 or C2 or C3, and exactly three carbon atoms of the seven-membered ring, i.e., exactly three of the carbon atoms C4, C5, C6, C7, C8, bear one substituent R^{F}.

In a further embodiment of the compounds claimed here according to the general formula M^{A}Yₙ(AzuH) (I), where Azu=is an azulene derivative, at least the carbon atoms C1, C4 and C7 of the azulene scaffold bear a substituent R^{F}. The isomers of the at least 1,4,7-substituted azulene derivative are also comprised here.

Examples of 1,4,7-substituted azulene derivatives are 1,4,7-trimethylazulene, 7-ethyl-1,4-dimethylazulene (chamazulene), 7-n-propyl-1,4-dimethylazulene, 7-isopropyl-1,4-dimethylazulene (guaiazulene), 7-n-butyl-1,4-dimethylazulene, 7-isobutyl-1,4-dimethylazulene, 7-secbutyl-1,4-dimethylazulene, 7-tertbutyl-1,4-dimethylazulene, 7-n-pentyl-1,4-dimethylazulene, 7-isopentyl-1,4-dimethylazulene, 7-neopentyl-1,4-dimethylazulene, 7-n-hexyl-1,4-dimethylazulene, 7-isohexyl-1,4-dimethylazulene, 7-(3-methylpentane)-1,4-dimethylazulene, 7-neohexyl-1,4-dimethylazulene, 7-(2,3-dimethylbutane)-1,4-dimethylazulene, and isomers thereof.

Guaiazulene is a natural substance which contains chamomile oil and other essential oils and is thus available cost-effectively in large quantities. It can be produced synthetically from guaiol of the guaiac wood oil (guaiac resin). Guaiazulene is an intensely blue substance with anti-inflammatory action. One isomer of guaiazulene is, for example, 2-isopropyl-4,8-dimethylazulene (vetivazulene).

If Azu=guaiazulene, the isomerically pure compound alkali metal 7-isopropyl-1,4-dimethyl-8-H-dihydroazulenide, which also serves as alkali metal 8-H-dihydroguaiazulenide, is advantageously present.

In another variant of the claimed compounds, the alkali metal M^{A} is selected from the group consisting of Li, Na and K.

According to yet another embodiment, the neutral ligand Y is an aprotic polar solvent. The neutral ligand is advantageously selected from the group consisting of ethers (=alkoxyalkanes), thioethers and tertiary amines, in particular from the group consisting of ethers (=alkoxy alkanes) and thioethers.

The term “alkoxyalkane” in the present case means any oxygen-containing ether, including for example glycol dialkyl ethers and crown ethers. The term “thioether” comprises both non-cyclic and cyclic thioethers.

The glycol dialkyl ethers are also understood to mean terminally dialkylated mono-, di- or trialkylene glycol dialkyl ethers. Examples of glycol dialkyl ethers are listed above in a non-limiting manner. A definition of the term “crown ethers” and a selection of crown ethers are already provided above.

The tertiary amine can, for example, be diisopropylethylamine (DIPEA) or N,N,N′,N-tetramethylethylenediamine (TMEDA).

According to yet another embodiment of the claimed compounds, the neutral ligand Y is an ether. For example, the ether can be a non-cyclic or a cyclic ether selected from the group consisting of dialkyl ethers, cyclopentyl methyl ether, tetrahydrofuran, 2-methyltetrahydrofuran, 3-methyltetrahydrofuran, tetrahydropyran, 1,4-dioxane, and isomers thereof, and mixtures thereof, in particular from the group consisting of diethyl ether, methyl-tertbutyl ether, di-n-propyl ether, diisopropyl ether, di-n-butyl ether, diisobutyl ether, ditertbutyl ether, tetrahydrofuran, 2-methyltetrahydrofuran, 3-methyltetrahydrofuran, tetrahydropyran, 1,4-dioxane, and isomers thereof, and mixtures thereof.

In a further variant of the compounds described here, the neutral ligand Y is a crown ether selected from the group consisting of macrocyclic polyethers and aza, phospha and thia derivatives thereof, wherein an internal diameter of the crown ether and an ion radius of M^{A} correspond to one another.

Whether the compounds claimed here according to the general formula M^{A}Yₙ(AzuH) (I) are present as solvent adducts, in particular ether adducts, depends on various factors, for example on the solvent or solvent mixture used for the preparation of compounds according to the general formula I and also on the type of alkali metal cation M^{A+}, that is to say the hydridic reducing agent Z, used. If, for example, during the synthesis, including the purification, a solvent was used, which comprised one or more ethers or consisted thereof, and at least one hydridic reducing agent Z having a lithium cation was used, then in all probability an ether adduct Li(ether)ₙ(AzuH) (I), where n=1 or 2, will be present. If, in conclusion, such an ether adduct were washed with a non-ethereal solvent, such as, for example, pentane or hexane, a solvent-free compound of the general formula Li(AzuH) (I) typically occurs.

The object is also achieved by using
a) a compound of the general formula M^{A}Yₙ(AzuH) (I)
   according to an embodiment of the compounds described above of the general formula M^{A}Yₙ(AzuH) (I)
or
   obtained or obtainable by a method for preparing such compounds according to one of the exemplary embodiments described above.
or
b) a solution or a suspension,
comprising a compound of the general formula M^{A}Yₙ(AzuH) (I) and at least one, in particular aprotic polar, solvent S_{P},
   obtained or obtainable by a method according to any one of the exemplary embodiments described above,
wherein
   M^{A} is an alkali metal,
   Y is a neutral ligand which is bonded or coordinated to M^{A} via at least one donor atom, wherein H₂O is excluded,
   n=0, 1, 2, 3, or 4
and
   AzuH=azulene or an azulene derivative that bears a hydride anion in the 4, 6 or
8 position in addition to an H atom,
wherein
Azu=azulene according to the formula

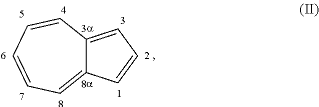

or
Azu=an azulene derivative which has an azulene scaffold according to formula II consisting of a five-membered ring and a seven-membered ring,
wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom, for preparing metal complexes according to the general formula

M(L_{K})_{f}(AzuH)ₘ (III)

or

M(L_{N})(AzuH)_{q} (IV)

or

[M(L_{S})_{g}(AzuH)ᵥ]X (V)

or

[M(L_{T})(AzuH)_{z}]X (VI),
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or weakly coordinating monovalent anion or non-coordinating monovalent anion,
and
AzuH and Azu are as defined above.

The aforementioned use of a compound according to the general formula M^{A}Yₙ(AzuH) (I) or to a solution or suspension comprising a compound according to the general formula M^{A}Yₙ(AzuH) (I) and at least one, in particular aprotic polar, solvent S_{P} for the preparation of metal complexes, is a method for the preparation of metal complexes according to the general formula

M(L_{K})_{f}(AzuH)ₘ (III)

or

M(L_{N})(AzuH)_{q} (IV)

or

[M(L_{S})_{g}(AzuH)ᵥ]X (V)

or

[M(L_{T})(AzuH)_{z}]X (VI),
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or
8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or weakly coordinating monovalent anion or non-coordinating monovalent anion,
and where
Azu=azulene according to the formula

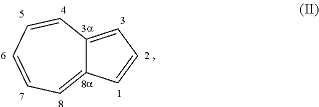

or
Azu=an azulene derivative, which has an azulene scaffold according to formula II,
consisting of a five-membered ring and a seven-membered ring, wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom, using
   a compound according to the general formula M^{A}Yₙ(AzuH) (I),
   according to an embodiment of the compounds described above of the general formula M^{A}Yₙ(AzuH) (I)
or
   obtained or obtainable by a method for preparing such compounds according to one of the exemplary embodiments described above.
or
   a solution or a suspension,
comprising a compound of the general formula M^{A}Yₙ(AzuH) (I) and at least one, in particular aprotic polar, solvent S_{P},
   obtained or obtainable by a method according to any one of the exemplary embodiments described above,
wherein
   M^{A} is an alkali metal,
   Y is a neutral ligand which is bonded or coordinated to M^{A} via at least one donor atom, wherein H₂O is excluded,
   n=0, 1, 2, 3, or 4
and
   AzuH and Azu are as defined above,
comprising the steps of:
A. providing the compound according to the general formula M^{A}Yₙ(AzuH) (I) or the solution or the suspension comprising the compound according to the general formula M^{A}Yₙ(AzuH) (I) and the at least one, in particular aprotic polar, solvent S_{P},
and
B. synthesis of the metal complex

M(L_{K})_{f}(AzuH)ₘ (III)

or

M(L_{N})(AzuH)_{q} (IV)

or

[M(L_{S})_{g}(AzuH)ᵥ]X (V)

or

[M(L_{T})(AzuH)_{z}]X (VI)

using the compound according to the general formula M^{A}Yₙ (AzuH) (I) as reactant.

The general formulae III, IV, V, and VI comprise both the monomers and any oligomers, in particular dimers.

The respective central metal atom M can in principle have a formal oxidation state or oxidation number of 0, 1, 2, 3, 4, 5, 6, or 7. The higher oxidation states, in particular oxidation states 4, 5, 6 and 7, are usually stabilized by anionic, in particular monoanionic ligands, e.g., fluoride anions (cf. in particular formulae IV, V and VI) and/or dianionic ligands, e.g., O²⁻ (cf. in particular formula VI).

The index q can assume the value 1, 2, 3, 4, 5, or 6. Alternatively, q=1, 2, 3, 4, or 5, preferably q=1, 2, 3, or 4, in particular q=1, 2 or 3.

The index v can likewise be 1, 2, 3, 4, 5, or 6. Alternatively, v=1, 2, 3, 4, or 5, advantageously v=1, 2, 3, or 4, in particular v=1, 2 or 3.

The index z can assume the value 1, 2, 3, 4, or 5. Alternatively, z=1, 2, 3, or 4, in particular z=1, 2 or 3.

The term “weakly coordinating” also covers the terms “very weakly coordinating” and “moderately strongly coordinating.” The halide anions are in particular selected from the group consisting of fluoride, chloride and bromide. The weakly coordinating monovalent and non-coordinating monovalent anions are, in particular, perfluorinated anions, e.g., PF₆⁻, BF₄⁻ and [(CF₃SO₂)₂N]⁻.

The metal complexes of the general formulae III, IV, V, and VI are usually obtained in a solvent-free form, i.e., not as solvent adducts. However, the preparation of solvent adducts of these metal complexes is also possible. In the case of a solvent adduct, the solvent is in particular identical to the solvent S_{P}. Alternatively or additionally, one or more of the neutral donor ligands L_{K} or L_{S} (cf. formula III or formula V) can be selected from the group consisting of acetonitrile, dimethyl sulfoxide and tetrahydrothiophene.

The compound of the type M^{A}Yₙ(AzuH) (I) used in each case may be present in an isomerically pure form or as a mixture of two or three isomers. The isomers of the general formula M^{A}Yₙ(AzuH) (I) are specifically an alkali metal-3α,4-H-dihydroazulenide, an alkali metal-8,8α-H-dihydroazulenide, an alkali metal-3α,6-H-dihydroazulenide and/or an alkali metal-6,8α-H-dihydroazulenide. These can be present in adduct-free or solvent-free form, namely when n=0, or as adducts or solvates with an (n=1), two (n=2), three (n=3) or four (n=4) neutral ligands Y The neutral ligand Y is advantageously selected from the group consisting of ethers (=alkoxyalkanes), thioethers and tertiary amines, in particular from the group consisting of ethers (=alkoxyalkanes) and thioethers. Examples of Y are indicated further above.

The solvent S_{P} may also be a mixture of solvents. The solvent S_{P} is advantageously an aprotic polar solvent or comprises at least one aprotic polar solvent. For example, the solvent S_{P} is an ether or comprises at least one ether. The ether can be selected from the group consisting of tetrahydrofuran, methyl tetrahydrofuran, 1,4-dioxane, diethyl ether, methyltertbutyl ether, di-n-propyl ether, diisopropyl ether, cyclopentyl methyl ether, and isomers thereof, and mixtures thereof.

Surprisingly, by means of the use claimed herein of compounds of the general formula M^{A}Yₙ(AzuH) (I) or by means of the method described herein, metal complexes of middle transition metals (groups 6, 7 and 8), in particular of metals of group 8, and later transition metals, i.e., of metals of group 9, group 10, group 11, and group 12, are obtainable in good purity of 97%, advantageously of more than 97%, in particular of more than 98% or 99%, and good yield, including space-time yield. Specifically, these are metal complexes of the general formulae M(L_{K})_{f}(AzuH)ₘ (III), M(L_{N})(AzuH)_{q} (IV), [M(L_{S})_{g}(AzuH)ᵥ]X (V), [M(L_{T})(AzuH)_{z}]X (VI). In this case, M is central metal atom selected from group 6, group 7, group 8, group 9, group 10, group 11, or group 12.

Furthermore, it has surprisingly been found that strongly reducing H-dihydroazulenyl ligands (AzuH)¹⁻, such as 8-H-dihydroguaiazulenyl ligand (GuaH)¹⁻ are suitable for the preparation of complexes of the middle transition metals (groups 6, 7 and 8), for example starting from chloride salts of group 8 metals, and the late transition metals, for example starting from chloride salts of metals of group 9, group 10, group 11, and group 12. These complexes are also advantageously obtainable in good yield and good purity, in many cases also in isomerically pure form.

The aforementioned facts are surprising because it is known to the person skilled in the art that strongly reducing H-dihydroazulenyl ligands (AzuH)¹⁻, such as 8-H-dihydroguaiazulenyl ligand (GuaH)¹⁻, is particularly suitable for complex formation with early transition metals, such as titanium and zirconium, for example (cf. J. Richter, P. Liebing, F. T. Edelmann Inorg. Chim. Acta 2018, 475, 18-27).

By means of the use claimed herein of compounds of the general formula M^{A}Yₙ(AzuH) (I) or by means of the method described herein, on the one hand, high-purity homoleptic sandwich complexes of middle transition metals (groups 6, 7 and 8), in particular of metals of group 8, and later transition metals, i.e., of metals of group 9, group 10, group 11, and group 12, are obtainable, in particular:
neutral sandwich complexes of the type M(L_{K})_{f}(AzuH)ₘ (III) with f=0, i.e., without neutral donor ligands L_{K}, e.g., Fe(GuaH)₂, Ru(GuaH)₂, Co(GuaH)₂, Zn(GuaH)₂, wherein the formal oxidation state is 2, M=Fe, Ru, Co or Zn, f=0, m=2 and AzuH=GuaH
and
cationic sandwich complexes of the type [M(L_{S})_{g}(AzuH)ᵥ]X (V) with g=0, i.e., without neutral donor ligands L_{S}, e.g., [Co(GuaH)₂]PF₆, wherein the formal oxidation state is 3, M=Co, g=0, v=3−1=2, AzuH=GuaH and X=PF₆.

On the other hand, by means of the use claimed herein of compounds of the general formula M^{A}Yₙ(AzuH) (I) or by means of the method described herein, high-purity heteroleptic sandwich complexes of middle transition metals (groups 6, 7 and 8), in particular of metals of group 8, and later transition metals, i.e., of metals of group 9, group 10, group 11, and group 12, are obtainable, in particular:
neutral half-sandwich complexes of the type M(L_{K})_{f}(AzuH)ₘ (III) with f=1 or 2, i.e., with exactly one neutral sigma-donor ligand or with exactly one neutral, non-planar pi-donor ligand, e.g., Cu(PPh₃)(GuaH), Rh(nbd)(GuaH), Rh(cod)(GuaH), wherein the formal oxidation state is 1 in each case, M=Cu or Rh, L_{K}=PPh₃, NBD or COD, f is 1 in each case, m is 1 in each case and AzuH=GuaH, or two planar, neutral pi-donor ligands, e. g. Rh(ethene)₂(GuaH), wherein the formal oxidation state is 1, M=Rh, L_{K}=ethene, f=2, m=1, and AzuH=GuaH.
neutral half-sandwich complexes of the type M(L_{N})(AzuH)_{q} (IV), for example with |u|=1, 2 or 3, i.e., for example, with one, two or three monoanionic sigma-donor ligands, e.g., Zn(Mes)(GuaH), wherein the formal oxidation state is 2, M=Zn, L_{N}=Mes⁻, |u|=1, q=2−|−1|=1 and AzuH=GuaH, and PtMe₃(GuaH), wherein the formal oxidation state is 4, M=Pt, L_{N}=CH₃⁻, |u|=3, q=4−|−3|=1 and AH=GuaH
neutral sandwich complexes of the type M(L_{N})(AzuH)_{q} (IV), for example with |u|=1, i.e., with exactly one monoanionic, planar pi-donor ligand, e.g., Ru(Cp*)(GuaH), wherein the formal oxidation state is 2, M=Ru, L_{N}=Cp*, |u|=1, q=2−|−1|=1 and AH=GuaH
cationic sandwich complexes of the type [M(L_{S})_{g}(AzuH)ᵥ]X (V) with g=1, i.e., with exactly one neutral, planar pi-donor ligand, e.g., [Ru(p-cymene)(GuaH)]PF₆, wherein the formal oxidation state is 2, M=Ru, L_{S}=p-cymene, g=1, v=2−1=1, AzuH=GuaH and X=PF₆
cationic half-sandwich complexes of the type [M(L_{S})_{g}(AzuH)ᵥ]X (v) with g=1 or 2, i.e., with a neutral non-planar pi-donor ligand, e.g., [Pt(cod)(GuaH)]PF₆, wherein the formal oxidation state is 2, M=Pt, L_{S}=COD, g=1, v=2−1=1, AzuH=GuaH and X=PF₆
or with two planar, neutral pi-donor ligands, e.g., [Pt(ethene)₂(GuaH)]PF₆, wherein the formal oxidation state is 2, M=Pt, L_{S}=ethene, g=2, v=2−1=1, AzuH=GuaH and X=PF 6
cationic sandwich complexes of the type [M(L_{T})(AzuH)_{z}]X (VI) with |h|=1, i.e., with exactly one anionic, planar pi-donor ligand, e.g., [Rh(Cp*)(GuaH)]Cl, [Rh(Cp*)(GuaH)]PF₆, wherein the formal oxidation state in each case is 3, M=Rh, L_{T}=Cp*, |h|=1, z=3−(|−1|+1)=1, AzuH=GuaH and X=Cl or PF₆.

Purity here means both the absence of undesired impurities, in particular due to reactants, by-products and solvents, and also the isomeric purity. This is because both aforementioned types of purity can be important with regard to the later use of the metal complexes which can be prepared by means of this method. A definition of the term “isomerically pure” and thus implicitly also the term “isomeric purity” is already given above.

In the context of the present invention, the term “high-purity” also refers to a total content of impurities, comprising in particular impurities due to metals, semimetals, atmospheric oxygen, water and oxygen-containing compounds, of below 1 ppm, ideally below 100 ppb.

In one embodiment of the use claimed or the method claimed herein, the preparation of metal complexes of the general formula M(L_{K})_{f}(AzuH)ₘ (III) is provided.

According to yet another embodiment of the claimed use or the claimed method, the central metal atom M of the metal complex of the general formula M(L_{K})_{f}(AzuH)_{M} (III) to be prepared is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the use or the method provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the use or of the method, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the use claimed herein or of the method claimed herein provides that the central metal atom M has a formal oxidation state of 1, 2, 3, 4, 5, 6, or 7. According to an alternative or supplementary embodiment of the use or of the method, it is provided that the index m and the formal oxidation state of the central metal atom M of the metal complex to be prepared in each case of the general formula M(L_{K})_{f}(AzuH)ₘ (III) are identical, i.e., the same natural number, wherein zero is excluded. Thus, it is possible that m=1, 2, 3, 4, 5, 6, or 7.

According to a further embodiment variant of the use or of the method, the preparation of a metal complex of the general formula M(L_{K})_{f}(AzuH)ₘ (III) is provided, wherein the central metal atom M has a formal oxidation state of 1, 2, 3, or 4, advantageously of 1, 2 or 3, in particular of 1 or 2. In an alternative or supplementary embodiment variant of the claimed use or of the claimed method, the index m is 1, 2, 3, or 4, advantageously 1, 2 or 3, in particular 1 or 2. A further alternative or supplementary embodiment of the claimed use or of the claimed method provides that the index f, which indicates the number of neutral ligands L_{K} in a metal complex of the general formula M(L_{K})_{f}(AzuH)_{M} (III), is zero, 1, 2, 3, 4, or 5, advantageously zero, 1, 2, 3, or 4, in particular zero, 1, 2 or 3.

In another embodiment variant of the use claimed herein or of the method claimed herein, the sum of the number m of ligands AzuH and the number f of neutral ligands L_{K}, i.e., Σ(f+m), is 2, 3, 4, 5, 6, or 7. Another embodiment provides that the sum of the number m of ligands AzuH and the number f of neutral ligands L_{K}, i.e., Σ(f+m), is 2, 3, 4, 5, or 6, advantageously 2, 3, 4, or 5, in particular 2, 3 or 4.

A further embodiment provides that the neutral sigma-donor ligand L_{K} or pi-donor ligand L_{K} is selected from the group consisting of monodentate and polydentate phosphorus donor ligands, alkenes, cyclic dienes and cyclic polyenes, and mononuclear arenes, polynuclear arenes, mononuclear heteroarenes and polynuclear heteroarenes, and derivatives thereof.

The term “phosphorus donor ligand” in the present case means any mono- or polydentate ligand which has at least one phosphorus donor atom via which the neutral ligand L_{K} can coordinate to a metal ion. These include, in addition to phosphanes and diphosphanes, phosphorus donor ligands such as 2-(dicyclohexylphosphino)-2′-(N,N-dimethylamino))-1,1′-biphenyl (DavePhos).

Examples of the ligand L_{K} are the alkenes ethene, propene, butene, pentene, hexene, heptene, octene, nonene, decene, and isomers thereof, the bicyclic alkene bicyclo[2.2.1]hept-2-ene, the cyclic diene cycloocta-1,5-diene (COD), the bicyclic diene bicyclo[2.2.1]hepta-2,5-diene (NBD), the monocyclic cycloocta-1,3,5,7-tetraene (COT).

Examples of a monocyclic arene and derivatives of a mononuclear arene are benzene and benzene derivatives, e.g., toluene, p-cymene and halogenated benzenes. Naphthalene and naphthalene derivatives are examples of a polycyclic arene and a derivative of a polynuclear arene. One example of a heteroarene is pyridine. A binuclear or bicyclic heteroarene is, for example, indole. The mononuclear arenes, polynuclear arenes, mononuclear heteroarenes and polynuclear heteroarenes may also be substituted, in particular alkyl groups and/or alkenyl groups and/or alkynyl groups and/or aryl groups and/or heteroaryl groups and/or halogen substituents.

In a variant of the claimed use or the claimed method, the ligand L_{K} is selected from the group consisting of 2-(dicyclohexylphosphino)-2′-(N,N-dimethylamino))-1,1′-biphenyl (DavePhos), 2-(dicyclohexylphosphino)-2′,4′,6′-triisopropyl-1,1′-biphenyl (XPhos), 2-dicyclohexylphosphino-2′, 6′-dimethoxy-1,1′-biphenyl (SPhos), 2-dicyclohexylphosphino-2′,6′-diisopropoxy-1,1′-biphenyl (RuPhos), 2-(dicyclohexylphosphino)-3, 6-dimethoxy-2′,4′,6′-tri-isopropyl-1,1′-biphenyl (BrettPhos), [4-(N,N-dimethylamino)phenyl]ditertbutylphosphine (Amphos), 9,9-dimethyl-4,5-bis(diphenylphosphino)xanthene (Xantphos), 2-dicyclohexylphosphino-2′,6′-bis(dimethylamino)-1,1′-biphenyl (CPhos), tricyclohexylphosphine (PCy₃), butyldi-1-adamantylphosphine (cataCXium® A), 2-ditertbutylphosphino-2′,4′, 6′-tri-isopropyl-1,1′-biphenyl (t-BuXPhos), 2-(ditertbutylphosphino)-3,6-dimethoxy-2′,4′,6′-triisopropyl-1, 1′-biphenyl (tert-BuBrettPhos), 2-(ditertbutylphosphino)-3-methoxy-6-methyl-2′,4′,6′-tri-isopropyl-1,1′-biphenyl (RockPhos), 2-Di[3,5-bis(trifluoromethyl)phenylphosphino]-3,6-dimethoxy-2′,4′,6′-triisopropyl-1,1′-biphenyl (JackiePhos), (R)-(−)-1-[(S)-2-(dicyclohexylphosphino)ferrocenyl]ethylditertbutylphosphine, ditertbutyl(n-butyl)phosphine, 2-(di-1-adamantylphosphino)-3, 6-dimethoxy-2′,4′,6′-triisopropyl-1, 1′-biphenyl (AdBrettPhos), 2-diethylphosphino-2′,6′-bis(dimethylamino)-1,1′-biphenyl, racemic-2-ditertbutylphosphino-1,1′-binaphthyl (TrixiePhos), tritertbutylphosphine (PtBu₃), 1,3,5,7-tetramethyl-8-phenyl-2, 4,6-trioxa-8-phosphaadamantane (MeCgPPh), N-[2-(di-1-adamantylphosphino)phenyl]morpholine (MorDalPhos), 4,6-bis(diphenylphosphino)phenoxazine (NiXantphos), 1,1′-bis(diphenylphosphino)ferrocene (dppf), 2-ditertbutylphosphino-2′-(N,N-dimethylamino))-1, 1′-biphenyl (tBuDavePhos), racemic-2,2′-bis(diphenylphosphino)-1,1′-binaphthyl (rac-BINAP), 1,1′-bis(ditertbutylphosphino)ferrocene (DTBPF), 2-ditertbutylphosphino-3,4,5,6-tetramethyl-2′,4′,6′-triisopropyl)-1,1′-biphenyl (Me₄t-BuXPhos), 2-dicyclohexylphosphino-4-(N,N-dimethylamino)-1,1′-biphenyl, trimethylphosphine (PMe₃), tris-p-tolylphosphine (P(p-tolyl)₃), tris-o-tolylphosphine (P(p-tolyl)₃), methyldiphenylphosphine, triphenylphosphine (PPh₃), trifluorophosphine, 1,2-bis(diphenylphosphino)ethane (dppe), phenyl-ditertbutylphosphine, ditertbutyl-neopentylphosphine, 1,2,3,4,5-pentaphenyl-1′-(ditertbutylphosphino)ferrocene, tris(p-methoxyphenyl)phosphine, tris(p-trifluoromethylphenyl)phosphine, tris(2,4,6-trimethoxyphenyl)phosphine, tris(2,4, 6,-trimethyl)phosphine, tris(2,6-dimethylphenyl)phosphine, 1-adamantyl-ditertbutylphosphine, benzyldi-1-adamantylphosphine, butyldi-1-adamantylphosphine, tris(1-adamantyl)phosphine (PAd₃), cyclohexylditertbutylphosphine, cyclohexyldiphenylphosphine, 2-ditertbutylphosphino-1,1′-binaphtyl, 2-(ditertbutylphosphino)biphenyl, 2-ditertbutylphosphino-2′-methylbiphenyl, 2-ditertbutylphosphino-2′,4′,6′-tri-isopropyl-1,1′-biphenyl, 2-ditertbutylphosphino-3,4,5,6-tetramethyl-2′,4′,6′-tri-isopropylbiphenyl, 2-(dicyclohexylphosphino)biphenyl, 2-(dicyclohexylphosphino)-2′,6′-dimethoxy-1,1′-biphenyl, 2-ditertcyclohexylphosphino-2′-(N, N-dimethylamino)biphenyl, 2-ditertcyclohexylphosphino-2′,6′-diisopropoxy-1,1′-biphenyl, 2-(dicyclohexylphosphino)-2′,4′, 6′-triisopropyl-1,1′-biphenyl, 2-dicyclohexylphosphino-2′-methylbiphenyl, 2-diphenylphosphino-2′-(N,N-dimethylamino)biphenyl, (4-dimethyl-aminophenyl)(tertbutyl)2-phosphine, 1,2-bis(ditertbutylphosphinomethyl)benzene, 1,3-bis(ditertbutylphosphinomethyl)propane, 1,2-bis(diphenylphosphinomethyl)benzene, 1,2-bis(diphenylphosphino)ethane, 1,2-bis(diphenylphosphino)propane, 1,2-bis(diphenylphosphino)butane, N-(2-methoxyphenyl)-2-(ditertbutylphosphino)pyrrole, 1-(2-methoxyphenyl)-2-(dicyclohexylphosphino)pyrrole, N-phenyl-2-(ditertbutylphosphino)indole, N-phenyl-2-(ditertbutylphosphino)pyrrole, N-phenyl-2-(dicyclohexylphosphino)indole, N-phenyl-2-(dicyclohexylphosphino)pyrrole and 1-(2,4,6-trimethylphenyl)-2(dicyclohexylphosphino)imidazole.

A further advantageous embodiment of the use or of the method provides that the central metal atom M of the metal complex to be prepared of the general formula M(L_{K})_{f}(AzuH)ₘ (III) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In a further embodiment of the claimed use or of the method claimed herein, the preparation of a metal complex of the general formula M(L_{N})(AzuH)_{q} (IV) is provided.

According to yet another embodiment of the claimed use or of the claimed method, the central metal atom M of the metal complex to be prepared of the general formula M(L_{N})(AzuH)_{q} (IV) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the use or the method provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the use or of the method, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the use claimed herein or of the method claimed herein provides that the central metal atom M has a formal oxidation state of 2, 3, 4, 5, 6, or 7. According to an alternative or supplementary embodiment of the use or of the method, it is provided that w₂ and the formal oxidation state of the central metal atom M of the metal complex to be prepared in each case of the general formula M(L_{N})(AzuH)_{q} (IV) are identical, i.e., are the same natural number, zero being excluded. Consequently, it is possible that w₂=2, 3, 4, 5, 6, or 7.

According to a further embodiment variant of the claimed use or of the claimed method, the preparation of a metal complex of the general formula M(L_{N})(AzuH)_{q} (IV) is provided, wherein the central metal atom M

has a formal oxidation state of 2, 3, 4, 5, or 6, advantageously of 2, 3, 4, or 5, in particular of 2, 3 or 4. In an alternative or supplementary embodiment variant of the claimed use or of the claimed method, w₂=2, 3, 4, 5, or 6, advantageously w₂=2, 3, 4, or 5, in particular w₂=2, 3 or 4. A further alternative or supplementary embodiment of the claimed use or of the claimed method provides that |u|, i.e., the absolute value of the sum of the negative charges of all anionic ligands L_{N} in a metal complex of the general formula M(L_{N})(AzuH)_{q} (IV), is 1, 2, 3, 4, 5, or 6. In yet another embodiment variant, |u|, i.e., the absolute value of the sum of the negative charges of all anionic ligands L_{N} in a metal complex of the general formula M(L_{N})(AzuH)_{q} (IV), is 1, 2, 3, 4, or 5, advantageously 1, 2, 3, or 4, in particular 1, 2 or 3.

In another embodiment variant of the use claimed herein or of the method claimed herein, the sum of the number q of ligands AzuH and the number of anionic ligands L_{N} is 2, 3, 4, 5, 6, or 7. A further embodiment provides that the sum of the number q of ligands AzuH and the number of anionic ligands L_{N} is 2, 3, 4, 5, or 6, advantageously 2, 3, 4, or 5, in particular 2, 3 or 4.

Yet another embodiment of the use claimed herein or of the method claimed herein for the preparation of metal complexes of the general formula M(L_{N})(AzuH)_{q} (IV) provides that the anionic sigma-donor ligand L_{N} or pi-donor ligand L_{N} is advantageously a monoanionic ligand which is selected from the group consisting of anions of cyclopentadiene and derivatives thereof, alkyl anions and aryl anions. Alternatively or additionally, a fluoride anion can be provided as at least one of the monoanionic ligands L_{N}.

Examples of the anionic ligands L_{N} are the cyclopentadienyl anion C₅H₅⁻ (Cp⁻) and the 1,2,3,4,5-pentamethylcyclopentadienyl anion C₅Me₅⁻ (Cp*), the methyl anion CH₃⁻ (Me⁻) and the mesityl anion Me₃C₆H₂⁻ (Mes⁻). The aforementioned anions can act as monoanionic pi-donor ligands or sigma-donor ligands L_{N} in the context of the preparation of neutral sandwich or half-sandwich complexes of the type M(L_{N})(AzuH)_{q} (IV).

A further advantageous embodiment of the use or of the method provides that the central metal atom M of the metal complex to be prepared of the general formula M(L_{N})(AzuH)_{q} (IV) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

The complexes Ru(Cp*)(GuaH), Zn(Mes)(GuaH), and PtMe₃(GuaH) are present in isolated form as liquids. The latter is advantageous in particular with regard to use as metal precursor compounds for vapor deposition processes. In addition, it is advantageous to use a liquid catalyst in catalysis, for example the Pt(IV) compound PtMe₃(GuaH) for light-induced platinum-catalyzed hydrosilylation reactions. The abovementioned Pt(IV) compound additionally shows absorption in the visible range. This constitutes a further advantage in the context of light-induced platinum-catalyzed hydrosilylation reactions. This is because the use of UV-Vis light is regularly provided, which usually requires special safety measures in order to reduce the risk of skin cancer. Such safety measures are not mandatory when using PtMe₃(GuaH).

In another embodiment of the claimed use or of the method claimed herein, the preparation of metal complexes of the general formula [M(L_{S})_{g}(AzuH)ᵥ]X (V) is provided.

According to yet another embodiment of the claimed use or of the claimed method, the central metal atom M of the metal complex to be prepared of the general formula [M(L_{S})_{g}(AzuH)ᵥ]X (V) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the use or the method provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the use or of the method, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the use claimed herein or of the method claimed herein provides that the central metal atom M has a formal oxidation state of 2, 3, 4, 5, 6, or 7. According to an alternative or supplementary embodiment of the use or of the method, it is provided that w₃ and the formal oxidation state of the central metal atom M of the metal complex to be prepared in each case of the general formula [M(L_{S})_{g}(AzuH)ᵥ]X (V) are identical, i.e., are the same natural number, zero being excluded. Consequently, it is possible that w₃=2, 3, 4, 5, 6, or 7.

According to a further embodiment variant of the use or of the method, the preparation of a metal complex of the general formula [M(L_{S})_{g}(AzuH)ᵥ]X (V) is provided, wherein the central metal atom M has a formal oxidation state of 2, 3, 4, 5, or 6, advantageously of 2, 3, 4, or 5, in particular of 2, 3 or 4. In an alternative or supplementary embodiment variant of the claimed use or of the claimed method, w₃=2, 3, 4, 5, or 6, advantageously w₃=2, 3, 4, or 5, in particular w₃=2, 3 or 4. A further alternative or supplementary embodiment of the claimed use or of the claimed method provides that the index g, which indicates the number of neutral ligands L_{S} in a metal complex of the general formula [[M(L_{S})_{g}(AzuH)ᵥ]X (V), is zero, 1, 2, 3, 4, 5, or 6. In yet another embodiment variant, the index g, which indicates the number of neutral ligands L_{S} in a metal complex of the general formula [M(L_{S})_{g}(AzuH)ᵥ]X (V), is zero, 1, 2, 3, 4, or 5, advantageously zero, 1, 2, 3, or 4, in particular zero, 1, 2 or 3.

In another embodiment variant of the use claimed herein or of the method claimed herein, the sum of the number v of ligands AzuH and the number g of neutral ligands L_{S}, i.e., Σ(g+v), is 2, 3, 4, 5, 6, or 7. A further embodiment provides that the sum of the number v of ligands AzuH and the number g of neutral ligands L_{S}, i.e., Σ(g+v), is 2, 3, 4, 5, or 6, advantageously 2, 3, 4, or 5, in particular 2, 3 or 4.

In a further variant of the claimed use or of the method for preparing metal complexes, the neutral sigma-donor ligand L_{S} or the neutral pi-donor ligand L_{S} is selected from the group consisting of monodentate and polydentate phosphorus donor ligands, alkenes, cyclic dienes and cyclic polyenes, and mononuclear arenes, polynuclear arenes, mononuclear heteroarenes and polynuclear heteroarenes, and derivatives thereof.

The term “phosphorus donor ligand” is defined above. An exemplary selection of phosphorus donor ligands is also given in a non-limiting manner above.

Further examples of the neutral, in particular pi-donor ligands L_{S} are the alkenes ethene, propene, butene, pentene, hexene, heptene, octene, nonene, decene, and isomers thereof, the bicyclic alkene bicyclo[2.2.1]hept-2-ene, the cyclic diene cycloocta-1,5-diene (COD), the bicyclic diene bicyclo[2.2.1]hepta-2,5-diene (NBD), the monocyclic cycloocta-1,3,5,7-tetraene (COT).

Examples of a monocyclic arene and derivatives of a mononuclear arene are benzene and benzene derivatives, e.g., toluene, p-cymene and halogenated benzenes. Naphthalene and naphthalene derivatives are examples of a polycyclic arene and a derivative of a polynuclear arene. One example of a heteroarene is pyridine. A binuclear or bicyclic heteroarene is, for example, indole. The mononuclear arenes, polynuclear arenes, mononuclear heteroarenes and polynuclear heteroarenes may also be substituted, in particular alkyl groups and/or alkenyl groups and/or alkynyl groups and/or aryl groups and/or heteroaryl groups and/or halogen substituents.

A further advantageous embodiment of the use or of the method provides that the central metal atom M of the metal complex to be prepared of the general formula [M(L_{S})_{g}(AzuH)ᵥ]X (V) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In yet another embodiment of the claimed use or of the method claimed herein, the preparation of metal complexes of the general formula [M(L_{T})(AzuH)_{z}]X (VI) is provided.

According to yet another embodiment of the claimed use or of the claimed method, the central metal atom M of the metal complex to be prepared of the general formula [M(L_{T})(AzuH)_{z}]X (VI) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the use or the method provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the use or of the method, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the use claimed herein or of the method claimed herein provides that the central metal atom M has a formal oxidation state of 3, 4, 5, 6, or 7. According to an alternative or supplementary embodiment of the use or of the method, it is provided that w₄ and the formal oxidation state of the central metal atom M of the metal complex to be prepared in each case of the general formula [M(L_{T})(AzuH)_{z}]X (VI) are identical, i.e., are the same natural number, zero being excluded. Consequently, it is possible that w₄=3, 4, 5, 6, or 7.

According to a further embodiment variant of the claimed use or of the claimed method, the preparation of a metal complex of the general formula [M(L_{T})(AzuH)_{z}]X (VI) is provided, wherein the central metal atom M has a formal oxidation state of 3, 4, 5, or 6, in particular 3, 4 or 5. In an alternative or supplementary embodiment variant of the claimed use or of the claimed method, w₄=3, 4, 5, or 6, in particular w₄=3, 4 or 5. A further alternative or supplementary embodiment of the claimed use or of the claimed method provides that |h|, i.e., the absolute value of the sum of the negative charges of all anionic ligands L_{T} in a metal complex of the general formula [M(L_{T})(AzuH)_{z}]X (VI), is 1, 2, 3, or 4, in particular 1, 2 or 3.

In another embodiment variant of the use claimed herein or of the method claimed herein, the sum of the number z of ligands AzuH and the number of anionic ligands L_{T} is 2, 3, 4, 5, or 6. A further embodiment provides that the sum of the number z of ligands AzuH and the number of anionic ligands L_{T} is 2, 3, 4, or 5, in particular 2, 3 or 4.

A further embodiment of the use claimed herein or of the method claimed herein for the preparation of metal complexes of the general formula [M(L_{T})(AzuH)_{z}]X (VI) provides that the ligand L_{T} is a monoanionic ligand selected from the group consisting of anions of cyclopentadiene and derivatives thereof and a fluoride anion, or a dianionic ligand. A dianionic ligand L_{T} is selected, for example, from the group consisting of an oxidoligand O²⁻, an imidoligand (NR^{Q})²⁻ and an alkylidene ligand (CR^{P}R^{V})²⁻. In this case, R^{Q}, R^{P} and R^{V} are independently selected from primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene, wherein the substituents R^{P} and R^{V} may optionally form a ring. The radicals R^{Q}, R^{P} and RV can also be substituted independently of one another, in particular halogenated.

Examples of anions of cyclopentadiene (Cp) are the cyclopentadienyl anion C₅H₅⁻ (Cp⁻) and the 1,2,3,4,5-pentamethylcyclopentadienyl anion C₅Me₅⁻ (Cp*). The aforementioned anions can be used as planar pi-donor ligands L_{T} for the synthesis of cationic sandwich complexes of the type [M(L_{T})(AzuH)_{z}]X (VI).

A further advantageous embodiment of the use or of the method provides that the central metal atom M of the metal complex to be prepared in each case of the general formula [M(L_{T})(AzuH)_{z}]X (VI) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

It is known to the person skilled in the art which metal precursor compounds are commercially available or can be prepared—optionally also in situ—and which reaction conditions, e.g., stoichiometry of the reactants, solvents, reaction temperature, reaction time, and working steps, including, if necessary, solvent change, isolation and, if necessary, purification, are required in step B. for the synthesis of the respective metal complex according to one of the formulae III, IV, V, and VI.

In one embodiment of the method, it is provided that the synthesis of the respective metal complex according to step B. is carried out in a solvent which comprises or is in particular an aprotic polar solvent. A further variant of the method provides that the synthesis of the respective metal complex according to step B. is carried out in a solvent which is in particular identical to or miscible with the solvent S_{P}. In this case—assuming the inertness of the solvent S_{P} and the solvent provided in step B.—a solvent change can be dispensed with, which is particularly advantageous from a (method) economic and ecological point of view.

The term “miscible” has already been defined above.

The method described herein for preparing homoleptic or heteroleptic metal complexes according to the formulae III, IV, V, and VI can be carried out as a discontinuous method or as a continuous method.

In the context of the method claimed herein for the preparation of metal complexes of the general formulae III, IV, V, and VI, in step A., in particular, previously isolated and optionally purified compounds of the general formula M^{A}Yₙ(AzuH) (I) are used. This is particularly advantageous because using (isomerically) pure reactants of the type M^{A}Yₙ(AzuH) (I) a synthesis of the desired metal complexes of the general formulae M(L_{K})_{f}(AzuH)ₘ (III), M(L_{N})(AzuH)_{q} (IV), [M(L_{S})_{g}(AzuH)ᵥ]X (V), [M(L_{T})(AzuH)_{z}]X (VI) can be ensured in a particularly simple, relatively cost-effective and—depending on the choice of reactants—sustainable and reproducible manner. In addition, the target compounds are obtained in high (isomeric) purity of 97%, advantageously of more than 97%, in particular of more than 98% or 99%, and good to very good yield, including space-time yield.

If in step A. a suspension is provided comprising a compound of the general formula M^{A}Yₙ(AzuH) (I) and a solvent S_{P}, in particular an aprotic polar solvent, it is particularly advantageous if the provision according to step A comprises at least one filtration step. This is because this allows by-products which have precipitated during the preparation of M^{A}Yₙ(AzuH) (I) and/or any unreacted reactants which are insoluble in the solvent S_{P} and/or other impurities to be separated off simply and quickly. As a result, the purity and/or the yields, including space-time yields, of the metal complexes obtainable by means of the use described herein or by means of the method described can be improved in a simple and rapid manner, where appropriate.

One embodiment of the claimed method for preparing metal complexes provides that the provision in step A. comprises in situ preparation of the compound of the general formula M^{A}Yₙ (AzuH) (I). In this case, the in situ preparation is carried out in particular according to an embodiment of the method described above for preparation of compounds of the general formula M^{A}Yₙ(AzuH) (I).

The in situ preparation of the compound of the general formula M^{A}Yₙ(AzuH) (I) can be carried out, for example, in an, in particular, aprotic polar, solvent or solvent mixture SL. The solvent SL may be selected from the group consisting of tetrahydrofuran, methyltetrahydrofuran, 1,4-dioxane, diethyl ether, methyl tertbutyl ether, di-n-propyl ether, diisopropyl ether, cyclopentyl methyl ether, and isomers thereof, acetonitrile, chloroform, dichloromethane, and mixtures thereof. It is particularly advantageous if the in situ preparation comprises at least one filtration step to separate off by-products precipitated during the synthesis and/or any unreacted reactants that are insoluble in the solvent SL and/or other impurities.

In another variant of the method for preparing metal complexes, it is provided that the synthesis in step B. comprises at least one salt metathesis reaction.

In particular, in the context of the synthesis of complexes of the general formula [M(L_{S})_{g}(AzuH)ᵥ]X (V) or [M(L_{T})(AzuH)_{z}]X (VI), at least two salt metathesis reactions may be required. For example, in situ preparation of the respective precursor compound may be carried out in a first salt metathesis reaction. The precursor compound can in particular be a halide, such as, for example, [Pt(cod)(GuaH)]Cl (GuaH=7-isopropyl-1,4-dimethyl-8-H-dihydroazulene). In a second salt metathesis reaction following the in situ preparation of the precursor compound, the target compound is then prepared. In the aforementioned example, the target compound can be [Pt(cod)(GuaH)]PF₆.

Alternatively or additionally to the at least one salt metathesis reaction, step B. can comprise at least one oxidation reaction.

Thus, for example, a salt metathesis reaction of a compound of the general formula M^{A}Yₙ(AzuH) (I) can be provided, followed by an oxidation, for example using atmospheric oxygen, and reaction of the oxidation product with a salt comprising a weakly coordinating or non-coordinating anion, e.g., KPF₆ or NH₄PF₆. An example of such a reaction sequence is the reaction of Li(GuaH) with cobalt(II) chloride to form Co(GuaH)₂ (meso form and racemate) of the general formula III, followed by oxidation of the isolated or in situ prepared compound Co(GuaH)₂ in the presence of atmospheric oxygen and reaction of the oxidation product with KPF₆ or NH₄PF₆. The product of this reaction sequence is a Cobalt(III) compound of the general formula V, namely [Co(GuaH)₂]PF₆, which is present as a mixture of three isomers (meso form and racemate).

The at least one salt metathesis reaction in step B. is carried out in a solvent SM, in particular an aprotic polar solvent S M. The aprotic polar solvent SM may be selected, for example, from the group consisting of ethers, acetonitrile, halogenated aliphatic and aromatic hydrocarbons. In a further variant of the method, the aprotic polar solvent SM is selected from the group consisting of tetrahydrofuran, methyl tetrahydrofuran, 1,4-dioxane, diethyl ether, methyltertbutyl ether, di-n-propyl ether, diisopropyl ether, cyclopentyl methyl ether, and isomers thereof, acetonitrile, chloroform, dichloromethane, and mixtures thereof.

In a further variant, the solvents S_{P} and the solvent provided in step B., in particular the solvents SL and SM, are chemically inert.

The term “inert solvent” is already defined above.

The at least one oxidation reaction can take place in a polar solvent, in particular water, in the presence of oxygen, in particular atmospheric oxygen.

It is particularly advantageous that the use of compounds of the general formula M^{A}Yₙ(AzuH) (I) for preparing metal complexes and the method for preparing metal complexes of the general formulae III, IV, V, and VI using compounds of the general formula M^{A}Yₙ (AzuH) (I) enable the preparation of high-purity metal complexes. In particular, a plurality of isomerically pure metal complexes can be provided in good to very good, in some cases quantitative, yields by means of the method described herein. Examples of such isomerically pure metal complexes are Ru(Cp*)(GuaH), [Ru(p-cymene)(GuaH)]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH).

In the case of the metal complexes Fe(GuaH)₂ and Ru(GuaH)₂, it was possible to isolate the rac diastereomer as the main product in each case, with a good yield of >70% and >60%, respectively. The metal complexes Co(GuaH)₂ and [Co(GuaH)₂]PF₆ were each obtained as a mixture of isomers of the meso form and a racemate.

The object is also achieved by metal complexes of the general formula

M(L_{K})_{f}(AzuH)ₘ (III)

or

M(L_{N})(AzuH)_{q} (IV)

or

[M(L_{S})_{g}(AzuH)ᵥ]X (V)

or

[M(L_{T})(AzuH)_{z}]X (VI)
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or 8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or weakly coordinating monovalent anion or non-coordinating monovalent anion,
wherein
Azu=azulene according to the formula

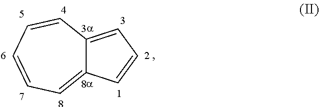

or
Azu=an azulene derivative which has an azulene skeleton according to formula II, consisting of a five-membered ring and a seven-membered ring,
wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom, obtained or obtainable by a method for preparing such metal complexes according to one of the embodiments described above.

The object is further achieved by solutions or suspensions comprising a metal complex of the general formula

M(L_{K})_{f}(AzuH)ₘ (III)

or

M(L_{N})(AzuH)_{q} (IV)

or

[M(L_{S})_{g}(AzuH)ᵥ]X (V)

or

[M(L_{T})(AzuH)_{z}]X (VI)
and at least one solvent which is miscible with or identical to the, in particular aprotic polar, solvent S_{P},
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or
8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or weakly coordinating monovalent anion or non-coordinating monovalent anion,
wherein
Azu=azulene according to the formula

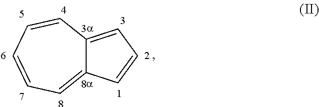

or
Azu=an azulene derivative which has an azulene skeleton according to formula II, consisting of a five-membered ring and a seven-membered ring,
wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom, obtained or obtainable by a method for preparing such solutions or suspensions according to one of the embodiments described above.

The general formulae III, IV, V, and VI comprise both the monomers and any oligomers, in particular dimers.

The respective central metal atom M can in principle have a formal oxidation state or oxidation number of 0, 1, 2, 3, 4, 5, 6, or 7. The higher oxidation states, in particular oxidation states 4, 5, 6 and 7, are usually stabilized by anionic, in particular monoanionic ligands, e.g., fluoride anions (cf. in particular formulae IV, V and VI) and/or dianionic ligands, e.g., O²⁻ (cf. in particular formula VI).

The index q can assume the value 1, 2, 3, 4, 5, or 6. Alternatively, q=1, 2, 3, 4, or 5, preferably q=1, 2, 3, or 4, in particular q=1, 2 or 3.

The index v can likewise be 1, 2, 3, 4, 5, or 6. Alternatively, v=1, 2, 3, 4, or 5, advantageously v=1, 2, 3, or 4, in particular v=1, 2 or 3.

The index z can assume the value 1, 2, 3, 4, or 5. Alternatively, z=1, 2, 3, or 4, in particular z=1, 2 or 3.

The metal complexes of the general formulae III, IV, V, and VI are usually obtained in a solvent-free form, i.e., not as solvent adducts. However, solvent adducts of these metal complexes can also be obtained by means of the method described above for preparation of such metal complexes. In the case of a solvent adduct, the solvent is in particular identical to the solvent S_{P} used in context of the method described above. Alternatively or additionally, one or more of the neutral donor ligands L_{K} or L_{S} (cf. formula III or formula V) can be selected from the group consisting of acetonitrile, dimethyl sulfoxide and tetrahydrothiophene.

The term “weakly coordinating” also covers the terms “very weakly coordinating” and “moderately strongly coordinating.” The halide anions are in particular selected from the group consisting of fluoride, chloride and bromide. The weakly coordinating monovalent and non-coordinating monovalent anions are, in particular, perfluorinated anions, e.g., PF₆⁻, BF₄⁻ and [(CF₃SO₂)₂N]⁻.

A definition of the term “miscible” has already been given above.

Metal complexes of the general formulae M(L_{K})_{f}(AzuH)ₘ (III), M(L_{N})(AzuH)_{q} (IV), [M(L_{S})_{g}(AzuH)ᵥ]X (V), [M(L_{T})(AzuH)_{z}]X (VI) each have at least one H-dihydroazulenyl anion (AzuH)¹⁻ which is a singly hydrogenated azulene or azulene derivative, namely hydrogenated in the 4 position, in the 6 position or in the 8 position. The respective H-dihydroazulenyl anion (AzuH)¹⁻ has a hydride anion H⁻ in the 4, 6 or 8 position in addition to an H atom. Therefore, a CH₂ group is present in the C4, C6 or C8 position of the azulene scaffold. The H-dihydroazulenyl anion represents a derivative of the cyclopentadienyl anion or a cyclopentadienyl-like monoanion. The H-dihydroazulenyl anion can be a 3α,4-H-dihydroazulenyl, a 8.8α-H-dihydroazulenyl, a 3α,6-H-dihydroazulenyl or a 6,8α-H-dihydroazulenyl anion, or a mixture of two or more regioisomers.

The metal complexes of types III, IV, V, and VI and the solutions or suspensions thereof in at least one, in particular aprotic polar, solvent which is miscible with or identical to the solvent S_{P}, e.g., SL and/or SM, can advantageously be obtained in a simple, reproducible and comparatively cost-effective manner in high (isomeric) purity of 97%, advantageously of more than 97%, in particular of more than 98% or 99%, and good to very good yield, in some cases quantitative yield, by means of the method claimed herein for the preparation of such metal complexes and solutions. In particular, a plurality of said metal complexes is isomerically pure. According to the above, metal complexes of the general formulae III, IV, V, and VI which are obtainable by means of the method claimed herein, as well as solutions or suspensions comprising such metal complexes, are suitable as high-quality reactants for further reactions and/or applications, including on an industrial scale.

Due to the presence of at least one H-dihydroazulenyl anion, i.e., at least one cyclopentadienyl-like monoanion, the compounds according to general formulae III, IV, V, and VI are suitable in particular as precatalysts, as catalysts and as electron transfer reagents for chemical reactions in which metal complexes having cyclopentadienyl ligands are otherwise employed. This is particularly advantageous because providing a H-dihydroazulenyl ligand is less labor intensive and time-consuming compared to providing the cyclopentadienyl ligand. This is because the reactants, for example natural substances such as guaiazulene and hydride reducing agents such as lithium triethylborohydride, are not only easier to handle and store, but also less expensive. In addition, fewer and simpler working steps have to be carried out. Consequently, the synthesis effort and the production costs for the metal complexes claimed herein, as well as solutions or suspensions comprising such a compound and at least one, in particular aprotic polar, solvent which is miscible with or identical to the solvent S_{P}, also prove to be lower than for analogous metal-Cp complexes. Consequently, the metal complexes described herein, as well as the solutions and suspensions thereof, constitute an alternative to metal-Cp complexes, in particular with regard to industrial application.

Guaiazulene is a natural substance which contains chamomile oil and other essential oils and, advantageously, is thus available cost-effectively in large quantities. It can be produced synthetically from guaiol of the guaiac wood oil (guaiac resin). Guaiazulene is an intensely blue substance with anti-inflammatory action. One isomer of guaiazulene is, for example, 2-isopropyl-4,8-dimethylazulene (vetivazulene).

In an advantageous embodiment of the metal complexes claimed herein of the general formulae III, IV, V, and VI and the solutions or suspensions claimed, comprising such a metal complex and at least one, in particular aprotic polar, solvent which is miscible or identical with the solvent S_{P}, in each case obtained or obtainable by a method for preparing such metal complexes or solutions or suspensions according to one of the embodiments described above, Azu=Gua=7-iso-propyl-1,4-dimethylazulene and AzuH=GuaH=7-iso-propyl-1,4-dimethyl-8-H-dihydroazulene.

Examples of the metal complexes claimed herein of the general formulae III, IV, V, and VI, each comprising at least one anion of the type (AzuH)¹⁻, which are present as an isolated solid or as an isolated liquid, i.e., in substance, or in a solution or suspension comprising such a metal complex and at least one, in particular aprotic polar, solvent which is miscible with or identical to the solvent S_{P}, are on the one hand high-purity homoleptic sandwich complexes of middle transition metals (groups 6, 7 and 8), in particular of metals of group 8, and later transition metals, i.e., of metals of group 9, group 10, group 11, and group 12, in particular:
neutral sandwich complexes of the type M(L_{K})_{f}(AzuH)ₘ (III) with f=0, i.e., without neutral donor ligands L_{K}, e.g., Fe(GuaH)₂, Ru(GuaH)₂, Co(GuaH)₂, Zn(GuaH)₂, wherein the formal oxidation state is 2, M=Fe, Ru, Co or Zn, f=0, m=2 and AzuH=GuaH
and
cationic sandwich complexes of the type [M(L_{S})_{g}(AzuH)ᵥ]X (V) with g=0, i.e., without neutral donor ligands L_{S}, e.g., [Co(GuaH)₂]PF₆, wherein the formal oxidation state is 3, M=Co, g=0, v=3-1=2, AzuH=GuaH and X=PF₆.

On the other hand, the metal complexes claimed herein of the general formulae III, IV, V, and VI, each comprising at least one anion of the type (AzuH)¹⁻, which are present as an isolated solid or as an isolated liquid, i. e. in substance, or in a solution or suspension comprising such a metal complex and at least one, in particular aprotic polar, solvent which is miscible with or identical to the solvent S_{P}, are high-purity heteroleptic complexes of middle transition metals (groups 6, 7 and 8), in particular of metals of group 8, and later transition metals, i.e., of metals of group 9, group 10, group 11, and group 12, in particular:
neutral half-sandwich complexes of the type M(L_{K})_{f}(AzuH)ₘ (III) with f=1 or 2, i.e., with exactly one neutral sigma-donor ligand or with exactly one neutral, non-planar pi-donor ligand, e.g., Cu(PPh₃)(GuaH), Rh(nbd)(GuaH), Rh(cod)(GuaH), wherein the formal oxidation state is 1 in each case, M=Cu or Rh, L_{K}=PPh₃, NBD or COD, f is 1 in each case, m is 1 in each case and AzuH=GuaH, or two planar, neutral pi-donor ligands, e. g. Rh(ethene)₂(GuaH), wherein the formal oxidation state is 1, M=Rh, L_{K}=ethene, f=2, m=1, and AzuH=GuaH.
neutral half-sandwich complexes of the type M(L_{N})(AzuH)_{q} (IV), for example with |u|=1, 2 or 3, i.e., for example, with one, two or three monoanionic sigma-donor ligands, e.g., Zn(Mes)(GuaH), wherein the formal oxidation state is 2, M=Zn, L_{N}=Mes⁻, |u|=1, q=2−|−1|=1 and AzuH=GuaH, and PtMe₃(GuaH), wherein the formal oxidation state is 4, M=Pt, L_{N}=CH₃⁻, |u|=3, q=4−|−3|=1 and AH=GuaH
neutral sandwich complexes of the type M(L_{N})(AzuH)_{q} (IV), for example with |u|=1, i.e., with exactly one monoanionic, planar pi-donor ligand, e.g., Ru(Cp*)(GuaH), wherein the formal oxidation state is 2, M=Ru, L_{N}=Cp*, |u|=1, q=2−|−1|=1 and AH=GuaH
cationic sandwich complexes of the type [M(L_{S})_{g}(AzuH)ᵥ]X (V) with g=1, i.e., with exactly one neutral, planar pi-donor ligand, e.g., [Ru(p-cymene)(GuaH)]PF₆, wherein the formal oxidation state is 2, M=Ru, L_{S}=p-cymene, g=1, v=2−1=1, AzuH=GuaH and X=PF₆
cationic half-sandwich complexes of the type [M(L_{S})_{g}(AzuH)ᵥ]X (v) with g=1 or 2, i.e., with a neutral non-planar pi-donor ligand, e.g., [Pt(cod)(GuaH)]PF₆, wherein the formal oxidation state is 2, M=Pt, L_{S}=COD, g=1, v=2−1=1, AzuH=GuaH and X=PF₆
or with two planar, neutral pi-donor ligands, e.g., [Pt(ethene)₂(GuaH)]PF₆, wherein the formal oxidation state is 2, M=Pt, L_{S}=ethene, g=2, v=2−1=1, AzuH=GuaH and X=PF 6
cationic sandwich complexes of the type [M(L_{T})(AzuH)_{z}]X (VI) with |h|=1, i.e., with exactly one anionic, planar pi-donor ligand, e.g., [Rh(Cp*)(GuaH)]CI, [Rh(Cp*)(GuaH)]PF₆, wherein the formal oxidation state in each case is 3, M=Rh, L_{T}=Cp*, |h|=1, z=3−(|−1|+1)=1, AzuH=GuaH and X=C1 or PF₆.

The terms “purity” and “high-purity” have already been defined above.

In one embodiment of the claimed metal complexes which are present as an isolated solid or as an isolated liquid, i.e., in substance, or solutions or suspensions comprising such a metal complex and at least one, in particular aprotic polar, solvent which is miscible with or identical to the solvent S_{P}, in each case obtained or obtainable by a method for preparing such metal complexes or solutions or suspensions according to one of the embodiments described above, the metal complex has the general formula M(L_{K})_{f}(AzuH)_{M} (III).

According to yet another embodiment of the claimed metal complexes or solutions or suspensions, the central metal atom M of the metal complex of the general formula M(L_{K})_{f}(AzuH)ₘ (III) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed compounds or solutions or suspensions provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed compounds or solutions or suspensions, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the compounds or solutions or suspensions claimed herein provides that the central metal atom M has a formal oxidation state of 1, 2, 3, 4, 5, 6, or 7. According to an alternative or supplementary embodiment of the claimed compounds or solutions or suspensions, it is provided that the index m and the formal oxidation state of the central metal atom M of the respective metal complex of the general formula M(L_{K})_{f}(AzuH)ₘ (III) are identical, i.e., are the same natural number, zero being excluded. Thus, it is possible that m=1, 2, 3, 4, 5, 6, or 7.

According to a further embodiment variant of the claimed compounds or solutions or suspensions, the metal complex has the general formula M(L_{K})_{f}(AzuH)ₘ (III), wherein the central metal atom M has a formal oxidation state of 1, 2, 3, or 4, advantageously of 1, 2 or 3, in particular of 1 or 2. In an alternative or supplementary embodiment of the claimed compounds or solutions or suspensions, the index m is 1, 2, 3, or 4, advantageously 1, 2 or 3, in particular 1 or 2. A further alternative or supplementary embodiment of the claimed compounds or solutions or suspensions provides that the index f, which indicates the number of neutral ligands L_{K} in a metal complex of the general formula M(L_{K})_{f}(AzuH)_{M} (III), is zero, 1, 2, 3, 4, or 5, advantageously zero, 1, 2, 3, or 4, in particular zero, 1, 2 or 3.

In another embodiment variant of the claimed metal complexes of the general formula M(L_{K})_{f}(AzuH)ₘ (III) or solutions or suspensions comprising such a metal complex, the sum of the number m of ligands AzuH and the number f of neutral ligands L_{K}, i.e., Σ(f+m), is 2, 3, 4, 5, 6, or 7. Another embodiment provides that the sum of the number m of ligands AzuH and the number f of neutral ligands L_{K}, i.e., Σ(f+m), is 2, 3, 4, 5, or 6, advantageously 2, 3, 4, or 5, in particular 2, 3 or 4.

A further embodiment provides that the neutral sigma-donor ligand L_{K} or pi-donor ligand L_{K} is selected from the group consisting of monodentate and polydentate phosphorus donor ligands, alkenes, cyclic dienes and cyclic polyenes, and mononuclear arenes, polynuclear arenes, mononuclear heteroarenes and polynuclear heteroarenes, and derivatives thereof.

The term “phosphorus donor ligand” is defined above. An exemplary selection of phosphorus donor ligands is also given in a non-limiting manner above.

Further examples of the ligands L_{K} are the alkenes ethene, propene, butene, pentene, hexene, heptene, octene, nonene, decene, and isomers thereof, the bicyclic alkene bicyclo[2.2.1]hept-2-ene, the cyclic diene cycloocta-1,5-diene (COD), the bicyclic diene bicyclo[2.2.1]hepta-2,5-diene (NBD), the monocyclic cycloocta-1,3,5,7-tetraene (COT).

Examples of a monocyclic arene and derivatives of a mononuclear arene are benzene and benzene derivatives, e.g., toluene, p-cymene and halogenated benzenes. Naphthalene and naphthalene derivatives are examples of a polycyclic arene and a derivative of a polynuclear arene. One example of a heteroarene is pyridine. A binuclear or bicyclic heteroarene is, for example, indole. The mononuclear arenes, polynuclear arenes, mononuclear heteroarenes and polynuclear heteroarenes may also be substituted, in particular alkyl groups and/or alkenyl groups and/or alkynyl groups and/or aryl groups and/or heteroaryl groups and/or halogen substituents.

A further advantageous embodiment of the claimed metal complexes or solutions or suspensions comprising such a metal complex provides that the central metal atom M of the metal complex of the general formula M(L_{K})_{f}(AzuH)_{M} (III) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In a further embodiment of the claimed metal complexes which are present as an isolated solid or as an isolated liquid, i.e., in substance, or solutions or suspensions comprising such a metal complex and at least one, in particular aprotic polar, solvent which is miscible with or identical to the solvent S_{P}, in each case obtained or obtainable by a method for preparing such metal complexes or solutions or suspensions according to one of the embodiments described above, the metal complex has the general formula M(L_{N})(AzuH)_{q} (IV).

According to yet another embodiment of the claimed compounds or solutions or suspensions, the central metal atom M of the metal complex of the general formula M(L_{N})(AzuH)_{q} (IV) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed compounds or solutions or suspensions provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed compounds or solutions or suspensions, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed metal complexes of the general formula M(L_{N})(AzuH)_{q} (IV) or solutions or suspensions comprising such a metal complex provide that the central metal atom M has a formal oxidation state of 2, 3, 4, 5, 6, or 7. According to an alternative or supplementary embodiment of the claimed compounds or solutions or suspensions, it is provided that w₂ and the formal oxidation state of the central metal atom M of the metal complex to be prepared in each case of the general formula M(L_{N})(AzuH)_{q} (IV) are identical, i.e., are the same natural number, zero being excluded. Consequently, it is possible that w₂=2, 3, 4, 5, 6, or 7.

According to a further embodiment variant of the claimed compounds or solutions or suspensions, the metal complex has the general formula M(L_{N})(AzuH)_{q} (IV), wherein the central metal atom M has a formal oxidation state of 2, 3, 4, 5, or 6, advantageously of 2, 3, 4, or 5, in particular of 2, 3 or 4. In an alternative or supplementary embodiment variant of the claimed compounds or solutions or suspensions, w₂=2, 3, 4, 5, or 6, advantageously w₂=2, 3, 4, or 5, in particular w₂=2, 3 or 4. A further alternative or supplementary embodiment of the claimed compounds or solutions or suspensions provides that |u|, i.e., the absolute value of the sum of the negative charges of all anionic ligands L_{N} in a metal complex of the general formula M(L_{N})(AzuH)_{q} (IV), is 1, 2, 3, 4, 5, or 6. In yet another embodiment variant, |u|, i.e., the absolute value of the sum of the negative charges of all anionic ligands L_{N} in a metal complex of the general formula M(L_{N})(AzuH)_{q} (IV), is 1, 2, 3, 4, or 5, advantageously 1, 2, 3, or 4, in particular 1, 2 or 3.

In another embodiment variant of the claimed metal complexes of the general formula M(L_{N})(AzuH)_{q} (IV) or solutions or suspensions comprising such a metal complex, the sum of the number q of ligands AzuH and the number of anionic ligands L_{N} is 2, 3, 4, 5, 6, or 7. A further embodiment provides that the sum of the number q of ligands AzuH and the number of anionic ligands L_{N} is 2, 3, 4, 5, or 6, advantageously 2, 3, 4, or 5, in particular 2, 3 or 4.

Yet another embodiment of the claimed compounds or solutions or suspensions provides that the metal complex has the general formula M(L_{N})(AzuH)_{q} (IV), wherein the anionic sigma-donor ligand L_{N} or pi-donor ligand L_{N} is advantageously a monoanionic ligand which is selected from the group consisting of anions of cyclopentadiene and derivatives thereof, alkyl anions and aryl anions. Alternatively or additionally, a fluoride anion can be provided as at least one of the monoanionic ligands L_{N}.

Examples of the anionic ligands L_{N} are the cyclopentadienyl anion C₅H₅⁻ (Cp⁻) and the 1,2,3,4,5-pentamethylcyclopentadienyl anion C₅Me₅⁻ (Cp*), the methyl anion CH₃⁻ (Me⁻) and the mesityl anion Me₃C₆H₂⁻ (Mes⁻). The aforementioned anions can act as monoanionic pi-donor ligands or sigma-donor ligands L_{N} in the context of the preparation of neutral sandwich or half-sandwich complexes of the type M(L_{N})(AzuH)_{q} (IV).

A further advantageous embodiment of the claimed compounds or solutions or suspensions provides that the central metal atom M of the metal complex of the general formula M(L_{N})(AzuH)_{q} (IV) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In another embodiment of the claimed metal complexes which are present as an isolated solid or as an isolated liquid, i.e., in substance, or solutions or suspensions comprising such a metal complex and at least one, in particular aprotic polar, solvent which is miscible with or identical to the solvent S_{P}, in each case obtained or obtainable by a method for preparing such metal complexes or solutions or suspensions according to one of the embodiments described above, the metal complex has the general formula [M(L_{S})_{g}(AzuH)ᵥ]X (V).

According to yet another embodiment of the claimed compounds or solutions or suspensions, the central metal atom M of the metal complex of the general formula [M(L_{S})_{g}(AzuH)ᵥ]X (V) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed compounds or solutions or suspensions provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed compounds or solutions or suspensions, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed metal complexes of the general formula [M(L_{S})_{g}(AzuH)ᵥ]X (V) or solutions or suspensions comprising such a metal complex provides that the central metal atom M has a formal oxidation state of 2, 3, 4, 5, 6, or 7. According to an alternative or supplementary embodiment of the claimed compounds or solutions or suspensions, it is provided that w₃ and the formal oxidation state of the central metal atom M of the respective metal complex of the general formula [M(L_{S})_{g}(AzuH)ᵥ]X (V) are identical, i.e., are the same natural number, zero being excluded. Consequently, it is possible that w₃=2, 3, 4, 5, 6, or 7.

According to a further embodiment variant of the claimed compounds or solutions or suspensions, the metal complex has the general formula [M(L_{S})_{g}(AzuH)ᵥ]X (V), wherein the central metal atom M has a formal oxidation state of 2, 3, 4, 5, or 6, advantageously of 2, 3, 4, or 5, in particular of 2, 3 or 4. In an alternative or supplementary embodiment variant of the claimed compounds or solutions or suspensions, w₃=2, 3, 4, 5, or 6, advantageously w₃=2, 3, 4, or 5, in particular w₃=2, 3 or 4. A further alternative or supplementary embodiment of the claimed compounds or solutions or suspensions provides that the index g, which indicates the number of neutral ligands L_{S} in a metal complex of the general formula [M(L_{S})_{g}(AzuH)ᵥ]X (V) is zero, 1, 2, 3, 4, 5, or 6. In yet another embodiment variant, the index g, which indicates the number of neutral ligands L_{S} in a metal complex of the general formula [M(L_{S})_{g}(AzuH)ᵥ]X (V), is zero, 1, 2, 3, 4, or 5, advantageously zero, 1, 2, 3, or 4, in particular zero, 1, 2 or 3.

In another embodiment variant of the claimed compounds or solutions or suspensions, the sum of the number v of ligands AzuH and the number g of neutral ligands L_{S}, i.e., Σ(g+v), is 2, 3, 4, 5, 6, or 7. A further embodiment provides that the sum of the number v of ligands AzuH and the number g of neutral ligands L_{S}, i.e., Σ(g+v), is 2, 3, 4, 5, or 6, advantageously 2, 3, 4, or 5, in particular 2, 3 or 4.

In a further variant of the claimed compounds or solutions or suspensions, the neutral sigma-donor ligand L_{S} or the neutral pi-donor ligand L_{S} is selected from the group consisting of monodentate and polydentate phosphorus donor ligands, alkenes, cyclic dienes and cyclic polyenes, and mononuclear arenes, polynuclear arenes, mononuclear heteroarenes and polynuclear heteroarenes, and derivatives thereof.

The term “phosphorus donor ligand” is defined above. An exemplary selection of phosphorus donor ligands is also given in a non-limiting manner above.

Further examples of the neutral, in particular pi-donor ligands L_{S} are the alkenes ethene, propene, butene, pentene, hexene, heptene, octene, nonene, decene, and isomers thereof, the bicyclic alkene bicyclo[2.2.1]hept-2-ene, the cyclic diene cycloocta-1,5-diene (COD), the bicyclic diene bicyclo[2.2.1]hepta-2,5-diene (NBD), the monocyclic cycloocta-1,3,5,7-tetraene (COT).

Examples of a monocyclic arene and derivatives of a mononuclear arene are benzene and benzene derivatives, e.g., toluene, p-cymene and halogenated benzenes. Naphthalene and naphthalene derivatives are examples of a polycyclic arene and a derivative of a polynuclear arene. One example of a heteroarene is pyridine. A binuclear or bicyclic heteroarene is, for example, indole. The mononuclear arenes, polynuclear arenes, mononuclear heteroarenes and polynuclear heteroarenes may also be substituted, in particular alkyl groups and/or alkenyl groups and/or alkynyl groups and/or aryl groups and/or heteroaryl groups and/or halogen substituents.

A further advantageous embodiment of the claimed compounds or solutions or suspensions provides that the central metal atom M of the metal complex of the general formula [M(L_{S})_{g}(AzuH)ᵥ]X (V) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In yet another embodiment of the claimed metal complexes which are present as an isolated solid or as an isolated liquid, i.e., in substance, or solutions or suspensions comprising such a metal complex and at least one, in particular aprotic polar, solvent which is miscible with or identical to the solvent S_{P}, in each case obtained or obtainable by a method for preparing such metal complexes or solutions or suspensions according to one of the embodiments described above, the metal complex has the general formula [M(L_{T})(AzuH)_{z}]X (VI).

According to a further embodiment of the claimed compounds or solutions or suspensions, the central metal atom M of the metal complex of the general formula [M(L_{T})(AzuH)_{z}]X (VI) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed compounds or solutions or suspensions provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed compounds or solutions or suspensions, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed compounds of the general formula [M(L_{T})(AzuH)_{z}]X (VI), or solutions or suspensions comprising such a compound, provides that the central metal atom M has a formal oxidation state of 3, 4, 5, 6, or 7. According to an alternative or supplementary embodiment of the claimed compounds or solutions or suspensions, it is provided that w₄ and the formal oxidation state of the central metal atom M of the metal complex of the general formula [M(L_{T})(AzuH)_{z}]X (VI) are identical, i.e., are the same natural number, zero being excluded. Consequently, it is possible that w₄=3, 4, 5, 6, or 7.

According to a further embodiment variant of the claimed compounds or solutions or suspensions, a metal complex of the general formula [M(L_{T})(AzuH)_{z} is provided, wherein the central metal atom M has a formal oxidation state of 3, 4, 5, or 6, in particular 3, 4 or 5. In an alternative or supplementary embodiment variant of the claimed metal complexes or solutions or suspensions comprising such a metal complex, w₄=3, 4, 5, or 6, in particular w₄=3, 4 or 5. A further alternative or supplementary embodiment of the claimed compounds or solutions or suspensions provides that |h|, i.e., the absolute value of the sum of the negative charges of all anionic ligands L_{T} in a metal complex of the general formula [M(L_{T})(AzuH)_{z}]X (VI), is 1, 2, 3, or 4, in particular 1, 2 or 3.

In another embodiment variant of the claimed metal complexes of the general formula [M(L_{T})(AzuH)_{z}]X (VI) or solutions or suspensions comprising such a metal complex, the sum of the number z of ligands AzuH and the number of anionic ligands L_{T} is 2, 3, 4, 5, or 6. A further embodiment provides that the sum of the number z of ligands AzuH and the number of anionic ligands L_{T} is 2, 3, 4, or 5, in particular 2, 3 or 4.

A further embodiment of the claimed compounds or solutions or suspensions provides a metal complexes of the general formula [M(L_{T})(AzuH)_{z}]X (VI), wherein the ligand L_{T} is a monoanionic ligand selected from the group consisting of anions of cyclopentadiene and derivatives thereof and a fluoride anion, or a dianionic ligand. A dianionic ligand L_{T} is selected, for example, from the group consisting of an oxidoligand O²⁻, an imidoligand (NR^{Q})²⁻ and an alkylidene ligand (CR^{P}R^{V})²⁻. In this case, R^{Q}, R^{P} and R^{V} are independently selected from primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene, wherein the substituents R^{P} and R^{V} may optionally form a ring. The radicals R^{Q}, R^{P} and RV can also be substituted independently of one another, in particular halogenated.

Examples of anions of cyclopentadiene (Cp) are the cyclopentadienyl anion C₅H₅⁻ (Cp⁻) and the 1,2,3,4,5-pentamethylcyclopentadienyl anion C₅Me₅⁻ (Cp*). The aforementioned anions can be provided as planar pi-donor ligands L_{T} in cationic sandwich complexes of the type [M(L_{T})(AzuH)_{z}]X (VI).

A further advantageous embodiment of the claimed compounds or solutions or suspensions provides that the central metal atom M of the respective metal complex of the general formula [M(L_{T})(AzuH)_{z}]X (VI) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

It is particularly advantageous that the use of compounds of the general formula M^{A}Yₙ(AzuH) (I) for preparing metal complexes and the method for preparing metal complexes of the general formulae III, IV, V, and VI using compounds of the general formula M^{A}Yₙ (AzuH) (I) enable the preparation of high-purity metal complexes. In particular, a plurality of isomerically pure metal complexes can be provided in good to very good, in some cases quantitative, yields by means of the method described herein. Examples of such isomerically pure metal complexes obtained or obtainable as solids, liquids, solutions or suspensions by a method according to one of the embodiments described above, are Ru(Cp*)(GuaH), [Ru(p-cymene)(GuaH)]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH).

In one embodiment of the metal complexes or solutions or suspensions claimed herein comprising such a metal complex and at least one, in particular aprotic polar, solvent which is miscible with or identical to the solvent S_{P}, in each case obtained or obtainable by a method for preparing such metal complexes or solutions or suspensions according to one of the embodiments described above, the metal complex is selected from the group consisting of Fe(GuaH)₂, Ru(GuaH)₂, Ru(Cp*)(GuaH), [Ru(p-cymene)(GuaH)]PF₆, Co(GuaH)₂, [Co(GuaH)₂]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH), advantageously from the group consisting of Ru(Cp*)(GuaH), [Ru(p-cymene)(GuaH)]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH), particularly advantageously from the group consisting of Ru(Cp*)(GuaH), Zn(Mes)(GuaH) and PtMe₃(GuaH). In particular, the metal complex is PtMe₃(GuaH).

The complexes Ru(Cp*)(GuaH), Zn(Mes)(GuaH), and PtMe₃(GuaH) are present in isolated form as liquids. This is advantageous in particular with regard to use as metal precursor compounds for vapor deposition processes. In addition, it is advantageous to use a liquid catalyst in catalysis, for example the Pt(IV) compound PtMe₃(GuaH) for light-induced platinum-catalyzed hydrosilylation reactions. The abovementioned Pt(IV) compound additionally shows absorption in the visible range. This constitutes a further advantage in the context of light-induced platinum-catalyzed hydrosilylation reactions. This is because the use of UV-Vis light is regularly provided, which usually requires special safety measures in order to reduce the risk of skin cancer. Such safety measures are not mandatory when using PtMe₃(GuaH). The cobalt complex Co(GuaH)₂ of the metallocene type, which is obtained as a mixture of isomers of the meso form and a racemate and also present in isolated form as a liquid, can be used, for example, as an electron transfer reagent.

In the case of the metal complexes Fe(GuaH)₂ and Ru(GuaH)₂, it was possible to isolate the rac diastereomer as the main product in each case, with a good yield of >70% and >60%, respectively. The metal complexes Co(GuaH)₂ and [Co(GuaH)₂]PF₆ were each obtained as a mixture of isomers of the meso form and a racemate.

The object is also achieved by metal complexes of the general formula

M(L_{K})_{f}(AzuH)ₘ (III)

or

M(L_{N})(AzuH)_{q} (IV)

or

[M(L_{S})_{g}(AzuH)ᵥ]X (V)

or

[M(L_{T})(AzuH)_{z}]X (VI)
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or
8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7, L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or weakly coordinating monovalent anion or non-coordinating monovalent anion,
wherein
Azu=azulene according to the formula

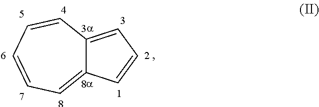

or
Azu=an azulene derivative which comprises an azulene skeleton of formula II,
consisting of a five-membered ring and a seven-membered ring, wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom, wherein the compounds Fe(AzulenH)₂ and Cr(AzulenH)₂, and isomers thereof, are excluded.

The d⁶ metal complex Fe(AzuleneH)₂ (=bis(3α,4-dihydroazulenyl)iron)) obtained as a mixture of isomers by Knox and Pauson (J. Chem. Soc. 1961, 4610-4615) with two H-dihydroazulenyl ligands (AzuleneH)¹⁻ and the d⁶-Cr(0) complex Cr(AzulenH)₂ described by Fischer and Müller (J. Organomet. Chem. 1964, 1, 464-470), which has an azulenium-chromium(0)-azuleniate unit, i.e., only one H-dihydroazulenyl ligand (azuleneH)¹⁻, are not subject matter of the present invention.

The general formulae III, IV, V, and VI comprise both the monomers and any oligomers, in particular dimers.

The respective central metal atom M can in principle have a formal oxidation state or oxidation number of 0, 1, 2, 3, 4, 5, 6, or 7. The higher oxidation states, in particular oxidation states 4, 5, 6 and 7, are usually stabilized by anionic, in particular monoanionic ligands, e.g., fluoride anions (cf. in particular formulae IV, V and VI) and/or dianionic ligands, e.g., O²⁻ (cf. in particular formula VI).

The index q can assume the value 1, 2, 3, 4, 5, or 6. Alternatively, q=1, 2, 3, 4, or 5, preferably q=1, 2, 3, or 4, in particular q=1, 2 or 3.

The index v can likewise be 1, 2, 3, 4, 5, or 6. Alternatively, v=1, 2, 3, 4, or 5, advantageously v=1, 2, 3, or 4, in particular v=1, 2 or 3.

The index z can assume the value 1, 2, 3, 4, or 5. Alternatively, z=1, 2, 3, or 4, in particular z=1, 2 or 3.

The general formulae III, IV, V, and VI each comprise both metal complexes which are solvent-free, i.e., not present as solvent adducts, and solvent adducts of the respective metal complexes. In the case of a solvent adduct, the solvent is in particular identical to the solvent S_{P} defined above. Alternatively or additionally, one or more of the neutral donor ligands L_{K} or L_{S} (cf. formula III or formula V) can be selected from the group consisting of acetonitrile, dimethyl sulfoxide and tetrahydrothiophene.

The term “weakly coordinating” also covers the terms “very weakly coordinating” and “moderately strongly coordinating.” The halide anions are in particular selected from the group consisting of fluoride, chloride and bromide. The weakly coordinating monovalent and non-coordinating monovalent anions are, in particular, perfluorinated anions, e.g., PF₆⁻, BF₄⁻ and [(CF₃SO₂)₂N]⁻.

Metal complexes of the general formulae M(L_{K})_{f}(AzuH)ₘ (III), M(L_{N})(AzuH)_{q} (IV), [M(L_{S})_{g}(AzuH)ᵥ]X (V), [M(L_{T})(AzuH)_{z}]X (VI) each have at least one H-dihydroazulenyl anion (AzuH)¹⁻ which is a singly hydrogenated azulene or azulene derivative, namely hydrogenated in the 4 position, in the 6 position or in the 8 position. The H-dihydroazulenyl anion represents a derivative of the cyclopentadienyl anion or a cyclopentadienyl-like monoanion. The H-dihydroazulenyl anion can be a 3α,4-H-dihydroazulenyl, a 8,8α-H-dihydroazulenyl, a 3α,6-H-dihydroazulenyl or a 6,8α-H-dihydroazulenyl anion, or a mixture of two or more regioisomers.

Due to the presence of at least one H-dihydroazulenyl anion, i.e., at least one cyclopentadienyl-like monoanion, the compounds according to general formulae III, IV, V, and VI described herein are suitable in particular as precatalysts, as catalysts and as electron transfer reagents for chemical reactions in which metal complexes having cyclopentadienyl ligands are otherwise employed. This is particularly advantageous because providing a H-dihydroazulenyl ligand is less labor intensive and time-consuming compared to providing the cyclopentadienyl ligand. This is because the reactants, for example natural substances such as guaiazulene and hydride reducing agents such as lithium triethylborohydride, are not only easier to handle and store, but also less expensive. In addition, fewer and simpler working steps have to be carried out. As a result, the synthesis effort and the production costs for the metal complexes claimed herein of the general formulae III, IV, V, and VI are also lower than for analogous metal-Cp complexes. Consequently, the metal complexes described herein, as well as the solutions and suspensions thereof, constitute an alternative to metal-Cp complexes, in particular with regard to industrial application. This also applies with regard to use as metal precursor compounds in vapor deposition processes.

Guaiazulene is a natural substance which contains chamomile oil and other essential oils and, advantageously, is thus available cost-effectively in large quantities. It can be produced synthetically from guaiol of the guaiac wood oil (guaiac resin). Guaiazulene is an intensely blue substance with anti-inflammatory action. One isomer of guaiazulene is, for example, 2-isopropyl-4,8-dimethylazulene (vetivazulene).

In an advantageous embodiment of the metal complexes claimed herein of the general formulae III, IV, V, and VI, Azu=Gua=7-isopropyl-1,4-dimethylazulene and AzuH=GuaH=7-isopropyl-1,4-dimethyl-8-H-dihydroazulene.

Examples of the metal complexes claimed herein are homoleptic sandwich complexes of middle transition metals (groups 6, 7 and 8), in particular of metals of group 8, and later transition metals, i.e., of metals of group 9, group 10, group 11, and group 12, in particular:
neutral sandwich complexes of the type M(L_{K})_{f}(AzuH)ₘ (III) with f=0, i.e., without neutral donor ligands L_{K}, e.g., Fe(GuaH)₂, Ru(GuaH)₂, Co(GuaH)₂, Zn(GuaH)₂, wherein the formal oxidation state is 2, M=Fe, Ru, Co or Zn, f=0, m=2 and AzuH=GuaH
and
cationic sandwich complexes of the type [M(L_{S})_{g}(AzuH)ᵥ]X (V) with g=0, i.e., without neutral donor ligands L_{S}, e.g., the d⁶ complex [Co(GuaH)₂]PF₆, wherein the formal oxidation state is 3, M=Co, g=0, v=3−1=2, AzuH=GuaH and X=PF₆.

On the other hand, the compounds claimed herein are heteroleptic complexes of middle transition metals (groups 6, 7 and 8), in particular of metals of group 8, and later transition metals, i.e., of metals of group 9, group 10, group 11, and group 12, in particular:
neutral half-sandwich complexes of the type M(L_{K})_{f}(AzuH)ₘ (III) with f=1 or 2, i.e., with exactly one neutral sigma-donor ligand or with exactly one neutral, non-planar pi-donor ligand, e.g., Cu(PPh₃)(GuaH), Rh(nbd)(GuaH), Rh(cod)(GuaH), wherein the formal oxidation state is 1 in each case, M=Cu or Rh, L_{K}=PPh₃, NBD or COD, f is 1 in each case, m is 1 in each case and AzuH=GuaH, or two planar, neutral pi-donor ligands, e. g. Rh(ethene)₂(GuaH), wherein the formal oxidation state is 1, M=Rh, L_{K}=ethene, f=2, m=1, and AzuH=GuaH.
neutral half-sandwich complexes of the type M(L_{N})(AzuH)_{q} (IV), for example with |u|=1, 2 or 3, i.e., for example, with one, two or three monoanionic sigma-donor ligands, e.g., Zn(Mes)(GuaH), wherein the formal oxidation state is 2, M=Zn, L_{N}=Mes⁻, |u|=1, q=2−|−1|=1 and AzuH=GuaH, and PtMe₃(GuaH), wherein the formal oxidation state is 4, M=Pt, L_{N}=CH₃⁻, |u|=3, q=4−|−3|=1 and AH=GuaH
neutral sandwich complexes of the type M(L_{N})(AzuH)_{q} (IV), for example with |u|=1, i.e., with exactly one monoanionic, planar pi-donor ligand, e.g., Ru(Cp*)(GuaH), wherein the formal oxidation state is 2, M=Ru, L_{N}=Cp*, |u|=1, q=2−|−1|=1 and AH=GuaH
cationic sandwich complexes of the type [M(L_{S})_{g}(AzuH)ᵥ]X (V) with g=1, i.e., with exactly one neutral, planar pi-donor ligand, e.g., [Ru(p-cymene)(GuaH)]PF₆, wherein the formal oxidation state is 2, M=Ru, L_{S}=p-cymene, g=1, v=2-1=1, AzuH=GuaH and X=PF₆
cationic half-sandwich complexes of the type [M(L_{S})_{g}(AzuH)ᵥ]X (v) with g=1 or 2, i.e., with a neutral non-planar pi-donor ligand, e.g., Pt(cod)(GuaH)]PF₆, wherein the formal oxidation state is 2, M=Pt, L_{S}=COD, g=1, v=2−1=1, AzuH=GuaH and X=PF₆, or with two planar, neutral pi-donor ligands, e.g., [Pt(ethene)₂(GuaH)]PF₆, wherein the formal oxidation state is 2, M=Pt, L_{S}=ethene, g=2, v=2−1=1, AzuH=GuaH and X=PF₆
cationic sandwich complexes of the type [M(L_{T})(AzuH)_{z}]X (VI) with |h|=1, i.e., with exactly one anionic, planar pi-donor ligand, e.g., [Rh(Cp*)(GuaH)]Cl, [Rh(Cp*)(GuaH)]PF₆, wherein the formal oxidation state in each case is 3, M=Rh, L_{T}=Cp*, |h|=1, z=3−(|−1|+1)=1, AzuH=GuaH and X=Cl or PF.

In one embodiment of the compounds claimed herein, metal complexes of the general formula M(L_{K})_{f}(AzuH)ₘ (III) are provided.

According to yet another embodiment of the claimed compounds, the central metal atom M of the metal complex of the general formula M(L_{K})_{f}(AzuH)ₘ (III) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the metal complexes described herein provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed metal complexes, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed metal complexes provides that the central metal atom M has a formal oxidation state of 1, 2, 3, 4, 5, 6, or 7. According to an alternative or supplementary embodiment of the claimed metal complexes, it is provided that the index m and the formal oxidation state of the central metal atom M of the metal complex of the general formula M(L_{K})_{f}(AzuH)ₘ (III) are identical, i.e., are the same natural number, zero being excluded. Thus, it is possible that m=1, 2, 3, 4, 5, 6, or 7.

According to a further embodiment variant of the compounds claimed herein, a metal complexes of the general formula M(L_{K})_{f}(AzuH)ₘ (III) is provided, wherein the central metal atom M has a formal oxidation state of 1, 2, 3, or 4, advantageously of 1, 2 or 3, in particular of 1 or 2. In an alternative or supplementary embodiment variant of the claimed metal complexes, the index m is 1, 2, 3, or 4, advantageously 1, 2 or 3, in particular 1 or 2. A further alternative or supplementary embodiment of the claimed metal complexes provides that the index f, which indicates the number of neutral ligands L_{K} in a metal complex of the general formula M(L_{K})_{f}(AzuH)ₘ (III), is zero, 1, 2, 3, 4, or 5, advantageously zero, 1, 2, 3, or 4, in particular zero, 1, 2 or 3.

In another embodiment variant of the claimed metal complexes of the general formula M(L_{K})_{f}(AzuH)ₘ(III), the sum of the number m of ligands AzuH and the number f of neutral ligands L_{K}, i.e., (f+m), is 2, 3, 4, 5, 6, or 7. Another embodiment provides that the sum of the number m of ligands AzuH and the number f of neutral ligands L_{K}, i.e., Σ(f+m), is 2, 3, 4, 5, or 6, advantageously 2, 3, 4, or 5, in particular 2, 3 or 4.

A further embodiment provides that the neutral sigma-donor ligand L_{K} or pi-donor ligand L_{K} is selected from the group consisting of monodentate and polydentate phosphorus donor ligands, alkenes, cyclic dienes and cyclic polyenes, and mononuclear arenes, polynuclear arenes, mononuclear heteroarenes and polynuclear heteroarenes, and derivatives thereof.

The term “phosphorus donor ligand” is defined above. An exemplary selection of phosphorus donor ligands is also given in a non-limiting manner above.

Further examples of the ligands L_{K} are the alkenes ethene, propene, butene, pentene, hexene, heptene, octene, nonene, decene, and isomers thereof, the bicyclic alkene bicyclo[2.2.1]hept-2-ene, the cyclic diene cycloocta-1,5-diene (COD), the bicyclic diene bicyclo[2.2.1]hepta-2,5-diene (NBD), the monocyclic cycloocta-1,3,5,7-tetraene (COT).

Examples of a monocyclic arene and derivatives of a mononuclear arene are benzene and benzene derivatives, e.g., toluene, p-cymene and halogenated benzenes. Naphthalene and naphthalene derivatives are examples of a polycyclic arene and a derivative of a polynuclear arene. One example of a heteroarene is pyridine. A binuclear or bicyclic heteroarene is, for example, indole. The mononuclear arenes, polynuclear arenes, mononuclear heteroarenes and polynuclear heteroarenes may also be substituted, in particular alkyl groups and/or alkenyl groups and/or alkynyl groups and/or aryl groups and/or heteroaryl groups and/or halogen substituents.

A further advantageous embodiment of the compounds claimed herein provides that the central metal atom M of the metal complex of the general formula M(L_{K})_{f}(AzuH)ₘ (III) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In a further embodiment of the compounds described herein, metal complexes of the general formula M(L_{N})(AzuH)_{q} (IV) are provided.

According to yet another embodiment of the claimed compounds, the central metal atom M of the metal complex of the general formula M(L_{N})(AzuH)_{q} (IV) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed metal complexes provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed metal complexes, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed metal complexes of the general formula M(L_{N})(AzuH)_{q} (IV) provides that the central metal atom M has a formal oxidation state of 2, 3, 4, 5, 6, or 7. According to an alternative or supplementary embodiment of the claimed metal complexes, it is provided that w₂ and the formal oxidation state of the central metal atom M of the metal complex of the general formula M(L_{N})(AzuH)_{q} (IV) are identical, i.e., are the same natural number, zero being excluded. Consequently, it is possible that w₂=2, 3, 4, 5, 6, or 7.

According to a further embodiment variant of the compounds claimed herein, metal complexes of the general formula M(L_{N})(AzuH)_{q} (IV) are provided, wherein the central metal atom M has a formal oxidation state of 2, 3, 4, 5, or 6, advantageously of 2, 3, 4, or 5, in particular of 2, 3 or 4. In an alternative or supplementary embodiment variant of the claimed metal complexes, w₂=2, 3, 4, 5, or 6, advantageously w₂=2, 3, 4, or 5, in particular w₂=2, 3 or 4. A further alternative or supplementary embodiment of the claimed metal complexes provides that |u|, i.e., the absolute value of the sum of the negative charges of all anionic ligands L_{N} in a metal complex of the general formula M(L_{N})(AzuH)_{q} (IV), is 1, 2, 3, 4, 5, or 6. In yet another embodiment variant, |u|, i.e., the absolute value of the sum of the negative charges of all anionic ligands L_{N} in a metal complex of the general formula M(L_{N})(AzuH)_{q} (IV), is 1, 2, 3, 4, or 5, advantageously 1, 2, 3, or 4, in particular 1, 2 or 3.

In another embodiment variant of the claimed metal complexes, the sum of the number q of ligands AzuH and the number of anionic ligands L_{N} is 2, 3, 4, 5, 6, or 7. A further embodiment provides that the sum of the number q of ligands AzuH and the number of anionic ligands L_{N} is 2, 3, 4, 5, or 6, advantageously 2, 3, 4, or 5, in particular 2, 3 or 4.

Another embodiment of the compounds claimed herein provides metal complexes of the general formula M(L_{N})(AzuH)_{q}(IV), wherein the anionic sigma-donor ligand L_{N} or pi-donor ligand L_{N} is advantageously a monoanionic ligand which is selected from the group consisting of anions of cyclopentadiene and derivatives thereof, alkyl anions and aryl anions. Alternatively or additionally, a fluoride anion can be provided as at least one of the monoanionic ligands L_{N}.

Examples of the anionic ligands L_{N} are the cyclopentadienyl anion C₅H₅⁻ (Cp⁻) and the 1,2,3,4,5-pentamethylcyclopentadienyl anion C₅Me₅⁻ (Cp*), the methyl anion CH₃⁻ (Me⁻) and the mesityl anion Me₃C₆H₂⁻ (Mes⁻). The aforementioned anions can act as monoanionic pi-donor ligands or sigma-donor ligands L_{N} in the context of the preparation of neutral sandwich or half-sandwich complexes of the type M(L_{N})(AzuH)_{q} (IV).

A further advantageous embodiment of the claimed metal complexes provides that the central metal atom M of the metal complex of the general formula M(L_{N})(AzuH)_{q} (IV) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

The complexes Ru(Cp*)(GuaH), Zn(Mes)(GuaH), and PtMe₃(GuaH) are present in isolated form as liquids. The latter is advantageous in particular with regard to use as metal precursor compounds for vapor deposition processes. In addition, it is advantageous to use a liquid catalyst in catalysis, for example the Pt(IV) compound PtMe₃(GuaH) for light-induced platinum-catalyzed hydrosilylation reactions. The abovementioned Pt(IV) compound additionally shows absorption in the visible range. This constitutes a further advantage in the context of light-induced platinum-catalyzed hydrosilylation reactions. This is because the use of UV-Vis light is regularly provided, which usually requires special safety measures in order to reduce the risk of skin cancer. Such safety measures are not mandatory when using PtMe₃(GuaH).

In another embodiment of the compounds claimed herein, metal complexes of the general formula [M(L_{S})_{g}(AzuH)ᵥ]X (V) are provided.

According to a further embodiment of the compounds described herein, the central metal atom M of the metal complex of the general formula [M(L_{S})_{g}(AzuH)ᵥ]X (V) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed metal complexes provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed metal complexes, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed metal complexes provides that the central metal atom M has a formal oxidation state of 2, 3, 4, 5, 6, or 7. According to an alternative or supplementary embodiment of the claimed metal complexes, it is provided that w₃ and the formal oxidation state of the central metal atom M of the metal complex of the general formula [M(L_{S})_{g}(AzuH)ᵥ]X (V) are identical, i.e., are the same natural number, zero being excluded. Consequently, it is possible that w₃=2, 3, 4, 5, 6, or 7.

According to a further embodiment variant of the compounds claimed herein, metal complexes of the general formula [M(L_{S})_{g}(AzuH)ᵥ]X (V) are provided, wherein the central metal atom M has a formal oxidation state of 2, 3, 4, 5, or 6, advantageously of 2, 3, 4, or 5, in particular of 2, 3 or 4. In an alternative or supplementary embodiment variant of the claimed metal complexes, w₃=2, 3, 4, 5, or 6, advantageously w₃=2, 3, 4, or 5, in particular w₂=2, 3 or 4. A further alternative or supplementary embodiment of the claimed metal complexes provides that the index g, which indicates the number of neutral ligands L_{S} in a metal complex of the general formula [M(L_{S})_{g}(AzuH)ᵥ]X (V), is zero, 1, 2, 3, 4, 5, or 6. In yet another embodiment variant, the index g, which indicates the number of neutral ligands L_{S} in a metal complex of the general formula [M(L_{S})_{g}(AzuH)ᵥ]X (V), is zero, 1, 2, 3, 4, or 5, advantageously zero, 1, 2, 3, or 4, in particular zero, 1, 2 or 3.

In another embodiment variant of the claimed metal complexes of the general formula [M(L_{S})_{g}(AzuH)ᵥ]X (V), the sum of the number v of ligands AzuH and the number g of neutral ligands L_{S}, i.e., (g+v), is 2, 3, 4, 5, 6, or 7. A further embodiment provides that the sum of the number v of ligands AzuH and the number g of neutral ligands L_{S}, i.e., (g+v), is 2, 3, 4, 5, or 6, advantageously 2, 3, 4, or 5, in particular 2, 3 or 4.

In a further variant of the claimed metal complexes, the neutral sigma-donor ligand L_{S} or the neutral pi-donor ligand L_{S} is selected from the group consisting of monodentate and polydentate phosphorus donor ligands, alkenes, cyclic dienes and cyclic polyenes, and mononuclear arenes, polynuclear arenes, mononuclear heteroarenes and polynuclear heteroarenes, and derivatives thereof.

The term “phosphorus donor ligand” is defined above. An exemplary selection of phosphorus donor ligands is also given in a non-limiting manner above.

Further examples of the neutral, in particular pi-donor ligands L_{S} are the alkenes ethene, propene, butene, pentene, hexene, heptene, octene, nonene, decene, and isomers thereof, the bicyclic alkene bicyclo[2.2.1]hept-2-ene, the cyclic diene cycloocta-1,5-diene (COD), the bicyclic diene bicyclo[2.2.1]hepta-2,5-diene (NBD), the monocyclic cycloocta-1,3,5,7-tetraene (COT).

Examples of a monocyclic arene and derivatives of a mononuclear arene are benzene and benzene derivatives, e.g., toluene, p-cymene and halogenated benzenes. Naphthalene and naphthalene derivatives are examples of a polycyclic arene and a derivative of a polynuclear arene. One example of a heteroarene is pyridine. A binuclear or bicyclic heteroarene is, for example, indole. The mononuclear arenes, polynuclear arenes, mononuclear heteroarenes and polynuclear heteroarenes may also be substituted, in particular alkyl groups and/or alkenyl groups and/or alkynyl groups and/or aryl groups and/or heteroaryl groups and/or halogen substituents.

A further advantageous embodiment of the metal complexes claimed herein provides that the central metal atom M of the metal complex of the general formula [M(L_{S})_{g}(AzuH)ᵥ]X (V) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In yet another embodiment of the compounds claimed herein, metal complexes of the general formula [M(L_{T})(AzuH)_{z}]X (VI) are provided.

According to a further embodiment of the compounds described herein, the central metal atom M of the metal complex of the general formula [M(L_{T})(AzuH)_{z}]X (VI) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed metal complexes provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed metal complexes, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed metal complexes of the general formula [M(L_{T})(AzuH)_{z}]X (VI) provides that the central metal atom M has a formal oxidation state of 3, 4, 5, 6, or 7. According to an alternative or supplementary embodiment of the claimed metal complexes, it is provided that w₄ and the formal oxidation state of the central metal atom M of the metal complex of the general formula [M(L_{T})(AzuH)_{z}]X (VI) are identical, i.e., are the same natural number, zero being excluded. Consequently, it is possible that w₄=3, 4, 5, 6, or 7.

According to a further embodiment variant of the compounds claimed herein, metal complexes of the general formula [M(L_{T})(AzuH)_{z}]X (VI) are provided, wherein the central metal atom M has a formal oxidation state of 3, 4, 5, or 6, in particular 3, 4 or 5. In an alternative or supplementary embodiment variant of the claimed metal complexes, w₄=3, 4, 5, or 6, in particular w₄=3, 4 or 5. A further alternative or supplementary embodiment of the claimed metal complexes provides that |h|, i.e., the absolute value of the sum of the negative charges of all anionic ligands L_{T} in a metal complex of the general formula [M(L_{T})(AzuH)_{z}]X (VI), is 1, 2, 3, or 4, in particular 1, 2 or 3.

In another embodiment variant of the claimed metal complexes of the general formula [M(L_{T})(AzuH)_{z}]X (VI), the sum of the number z of ligands AzuH and the number of anionic ligands L_{T} is 2, 3, 4, 5, or 6. A further embodiment provides that the sum of the number z of ligands AzuH and the number of anionic ligands L_{T} is 2, 3, 4, or 5, in particular 2, 3 or 4.

A further embodiment of the compounds claimed herein provides metal complexes of the general formula [M(L_{T})(AzuH)_{z}]X (VI), wherein the ligand L_{T} is a monoanionic ligand selected from the group consisting of anions of cyclopentadiene and derivatives thereof and a fluoride anion, or a dianionic ligand. A dianionic ligand L_{T} is selected, for example, from the group consisting of an oxidoligand O²⁻, an imidoligand (NR^{Q})²⁻ and an alkylidene ligand (CR^{P}R^{V})²⁻. In this case, R^{Q}, R^{P} and R^{V} are independently selected from primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene, wherein the substituents R^{P} and R^{V} may optionally form a ring. The radicals R^{Q}, R^{P} and RV can also be substituted independently of one another, in particular halogenated.

Examples of anions of cyclopentadiene (Cp) are the cyclopentadienyl anion C₅H₅⁻ (Cp⁻) and the 1,2,3,4,5-pentamethylcyclopentadienyl anion C₅Me₅⁻ (Cp*). The aforementioned anions can be provided as planar pi-donor ligands L_{T} in cationic sandwich complexes of the type [M(L_{T})(AzuH)_{z}]X (VI).

A further advantageous embodiment of the compounds claimed herein provides that the central metal atom M of the metal complex of the general formula [M(L_{T})(AzuH)_{z}]X (VI) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In one embodiment of the compounds claimed herein, the metal complex is selected from the group consisting of Fe(GuaH)₂, Ru(GuaH)₂, Ru(Cp*)(GuaH), [Ru(p-cymene)(GuaH)]PF₆, Co(GuaH)₂, [Co(GuaH)₂]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH), advantageously from the group consisting of Ru(Cp*)(GuaH), [Ru(p-cymene)(GuaH)]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH), particularly advantageously from the group consisting of Ru(Cp*)(GuaH), Zn(Mes)(GuaH) and PtMe₃(GuaH). In particular, the metal complex is PtMe₃(GuaH).

In particular with regard to use as metal precursor compounds for vapor deposition processes, it is advantageous that the complexes Ru(Cp*)(GuaH), Zn(Mes)(GuaH) and PtMe₃(GuaH) are not only obtainable in high (isomeric) purity of 97%, advantageously of more than 97%, in particular of more than 98% or 99%, and good yield, including space-time yield, but are also present as liquids in isolated form. In addition, it is advantageous to use a liquid catalyst in catalysis, for example the Pt(IV) compound PtMe₃(GuaH) for light-induced platinum-catalyzed hydrosilylation reactions. The abovementioned Pt(IV) compound additionally shows absorption in the visible range. This constitutes a further advantage in the context of light-induced platinum-catalyzed hydrosilylation reactions. This is because the use of UV-Vis light is regularly provided, which usually requires special safety measures in order to reduce the risk of skin cancer. Such safety measures are not mandatory when using PtMe₃(GuaH). The cobalt complex Co(GuaH)₂ of the metallocene type, which is obtainable as a mixture of isomers of the meso form and a racemate and also present in isolated form as a liquid, can be used, for example, as an electron transfer reagent.

The object is also achieved by the use of at least one metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI) or at least one solution or suspension comprising a metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI) and at least one solvent which is miscible with or identical to the, in particular aprotic polar, solvent S_{P},
according to an embodiment of the compounds described above
or
obtained or obtainable according to a method for preparing such compounds or solutions or suspensions according to one of the embodiments described above,
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or
8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or weakly coordinating monovalent anion or non-coordinating monovalent anion,
wherein
Azu=azulene according to the formula

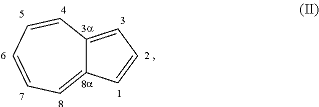

or
Azu=an azulene derivative which comprises an azulene skeleton of formula II,
consisting of a five-membered ring and a seven-membered ring, wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom, as a
i. pre-catalyst or pre-catalyst-containing solution or suspension in a chemical reaction
and/or
ii. catalyst or catalyst-containing solution or suspension in a chemical reaction
and/or
iii. electron transfer reagent or solution or suspension containing electron transfer reagent in a chemical reaction
and/or
iv. precursor compound, or solution or suspension containing precursor compound, for preparing at least one layer containing a metal M, or at least one metal layer consisting of the metal M, in particular on at least one surface of a substrate.

On the one hand, the abovementioned use is a method for carrying out a chemical reaction using at least one metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI) or at least one solution or suspension comprising a metal complex according to one of the formulae M(L_{K})_{f}(AzuH)ₘ(III), M(L_{N})(AzuH)_{q}(IV), [M(L_{S})_{g}(AzuH)ᵥ]X (V) and [M(L_{T})(AzuH)_{z}]X (VI) and at least one solvent which is miscible with or identical to the, in particular aprotic polar, solvent S_{P},
according to an embodiment of the compounds described above
or
obtained or obtainable according to a method for preparing such compounds or solutions or suspensions according to one of the embodiments described above,
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or
8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or weakly coordinating monovalent anion or non-coordinating monovalent anion,
wherein
Azu=azulene according to the formula

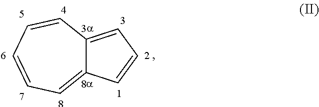

or
Azu=an azulene derivative which comprises an azulene skeleton of formula II,
consisting of a five-membered ring and a seven-membered ring, wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom, comprising the steps of:
A) providing the at least one metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI)
or
the at least one solution or suspension comprising a metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI) and at least one solvent which is miscible with or identical to the, in particular aprotic polar, solvent S_{P},
and
B) carrying out the chemical reaction using the at least one metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI) as precatalyst, as catalyst or as electron transfer reagent.

The general formulae III, IV, V, and VI comprise both the monomers and any oligomers, in particular dimers.

Depending on the application, the metal complexes of the general formulae III, IV, V, and VI to be provided can be present in solvent-free form, i.e., not as solvent adducts, or as solvent adducts of the respective metal complexes. In the case of a solvent adduct, the solvent is in particular identical to the solvent S_{P}. Alternatively or additionally, one or more of the neutral donor ligands L_{K} or L_{S} (cf. formula III or formula V) can be selected from the group consisting of acetonitrile, dimethyl sulfoxide and tetrahydrothiophene.

In particular with regard to use as metal precursor compounds in vapor deposition processes, it is advantageous if the metal complexes of the general formulae III, IV, V, and VI are in particular ether-free.

The central metal atom M can have a formal oxidation state of 0, 1, 2, 3, 4, 5, 6, or 7. Higher oxidation states, in particular the oxidation states 4, 5, 6 or 7, are usually stabilized by anionic, in particular monoanionic ligands, e.g., fluoride anions, and/or dianionic ligands, e.g., O²⁻ (cf. formulae IV, V and VI).

L_{N} is advantageously a monoanionic ligand. L_{T} may be a monoanionic or a dianionic ligand. A dianionic ligand L_{T} is selected, for example, from the group consisting of an oxidoligand O²⁻, an imidoligand (NR^{Q})²⁻ and an alkylidene ligand (CR^{P}R^{V})²−.

The index q can assume the value 1, 2, 3, 4, 5, or 6. Alternatively, q=1, 2, 3, 4, or 5, preferably q=1, 2, 3, or 4, in particular q=1, 2 or 3.

The index v can likewise be 1, 2, 3, 4, 5, or 6. Alternatively, v=1, 2, 3, 4, or 5, advantageously v=1, 2, 3, or 4, in particular v=1, 2 or 3.

The index z can assume the value 1, 2, 3, 4, or 5. Alternatively, z=1, 2, 3, or 4, in particular z=1, 2 or 3.

The halide anion X⁻ acts as a leaving group. The term “weakly coordinating” also covers the terms “very weakly coordinating” and “moderately strongly coordinating.” The halide anions are in particular selected from the group consisting of fluoride, chloride and bromide. The weakly coordinating monovalent and non-coordinating monovalent anions are, in particular, perfluorinated anions, e.g., PF₆⁻, BF₄⁻ and [(CF₃SO₂)₂N]⁻.

A definition of the term “miscible” has already been given above.

For example, the complexes Ru(Cp*)(GuaH), Zn(Mes)(GuaH) and PtMe₃(GuaH) are obtainable in high (isomeric) purity of 97%, advantageously of more than 97%, in particular of more than 98% or 99%, and good yield, including space-time yield, and are present in isolated form as liquids. In catalysis, it is advantageous to use a liquid catalyst, for example the Pt(IV) compound PtMe₃(GuaH) for light-induced platinum-catalysed hydrosilylation reactions. The abovementioned Pt(IV) compound additionally shows absorption in the visible range. This constitutes a further advantage in the context of light-induced platinum-catalyzed hydrosilylation reactions. This is because the use of UV-Vis light is regularly provided, which usually requires special safety measures in order to reduce the risk of skin cancer. Such safety measures are not mandatory when using PtMe₃(GuaH). The cobalt complex Co(GuaH)₂ of the metallocene type, which is obtainable as a mixture of isomers of the meso form and a racemate and also present in isolated form as a liquid, can be used, for example, as an electron transfer reagent.

On the other hand, the aforementioned use is a method for preparing
i. at least one metal layer consisting of a metal M
or
ii. at least one layer containing a metal M,
on at least one surface of a substrate, using
at least one metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI)
or
the at least one solution or suspension comprising a metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI) and at least one solvent which is miscible with or identical to the solvent S_{P},
   according to an embodiment of the compounds described above
or
   obtained or obtainable according to a method for preparing such compounds or solutions or suspensions according to one of the embodiments described above,
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or
8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or weakly coordinating monovalent anion or non-coordinating monovalent anion,
wherein
Azu=azulene according to the formula

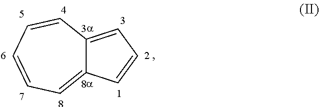

or
Azu=an azulene derivative which comprises an azulene skeleton of formula II,
consisting of a five-membered ring and a seven-membered ring, wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom, comprising the steps of:
A) providing
the at least one metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI)
or
the at least one solution or suspension comprising a metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI) and at least one solvent which is miscible with or identical to the solvent S_{P},
and
B) depositing
i. the at least one metal layer consisting of the metal M
or
ii. the at least one layer containing the metal M,
on the at least one surface of the substrate using the at least one metal complex according to one of the formulae M(L_{K})_{f}(AzuH)ₘ (III), M(L_{N})(AzuH)_{q}(IV), [M(L_{S})_{g}(AzuH)ᵥ]X (V) and [M(L_{T})(AzuH)_{z}]X (VI) as precursor compound.

The general formulae III, IV, V, and VI comprise both the monomers and any oligomers, in particular dimers.

The central metal atom M can have a formal oxidation state of 0, 1, 2, 3, 4, 5, 6, or 7. Higher oxidation states, in particular the oxidation states 4, 5, 6 or 7, are usually stabilized by anionic, in particular monoanionic ligands, e.g., fluoride anions, and/or dianionic ligands, e.g., O²⁻ (cf. formulae IV, V and VI).

L_{N} is advantageously a monoanionic ligand. L_{T} may be a monoanionic or a dianionic ligand. A dianionic ligand L_{T} is selected, for example, from the group consisting of an oxidoligand O²⁻, an imidoligand (NR^{Q})²⁻ and an alkylidene ligand (CR^{P}R^{V})²⁻.

The index q can assume the value 1, 2, 3, 4, 5, or 6. Alternatively, q=1, 2, 3, 4, or 5, preferably q=1, 2, 3, or 4, in particular q=1, 2 or 3.

The index v can likewise be 1, 2, 3, 4, 5, or 6. Alternatively, v=1, 2, 3, 4, or 5, advantageously v=1, 2, 3, or 4, in particular v=1, 2 or 3.

The index z can assume the value 1, 2, 3, 4, or 5. Alternatively, z=1, 2, 3, or 4, in particular z=1, 2 or 3.

The halide anion X⁻ acts as a leaving group. The term “weakly coordinating” also covers the terms “very weakly coordinating” and “moderately strongly coordinating.” The halide anions are in particular selected from the group consisting of fluoride, chloride and bromide. The weakly coordinating monovalent and non-coordinating monovalent anions are, in particular, perfluorinated anions, e.g., PF₆⁻, BF₄⁻ and [(CF₃SO₂)₂N]⁻.

A definition of the term “miscible” has already been given above.

In the uses described herein or the method claimed herein for carrying out a chemical reaction or for preparing at least one metal layer consisting of the metal M or at least one layer containing a metal M, the metal complexes can be used as solids or liquids according to one embodiment of the compounds described above, or as a solid or liquid or as a solution or suspension comprising a metal complex and at least one, in particular aprotic polar, solvent which is miscible with or identical to the solvent S_{P}, e.g., SL and/or S M, in each case obtained or obtainable by a method for preparing such complex compounds or solutions or suspensions according to one of the embodiments described above. Owing to their high purity, the aforementioned complex compounds according to the formulae III, IV, V, and VI are suitable for use both as precatalysts or catalysts in a plurality of reactions catalyzed by metals selected from group 6, group 7, group 8, group 9, group 10, group 11, and group 12, and as metal precursor compounds in vapor deposition processes. Some of these metal complexes are advantageously not only isomerically pure, but also liquid.

It is particularly advantageous that the metal complexes of the types M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI) each have at least one H-dihydroazulenyl anion (AzuH)¹-which is an azulene or azulene derivative that is singly hydrogenated, namely in the 4 position, in the 6 position or in the 8 position. The respective H-dihydroazulenyl anion (AzuH)¹⁻ has a hydride anion H⁻ in the 4, 6 or 8 position in addition to an H atom. Therefore, a CH₂ group is present in the C4, C6 or C8 position of the azulene scaffold. The H-dihydroazulenyl anion represents a derivative of the cyclopentadienyl anion or a cyclopentadienyl-like monoanion. The H-dihydroazulenyl anion can be a 3α,4-H-dihydroazulenyl, a 8,8α-H-dihydroazulenyl, a 3α,6-H-dihydroazulenyl or a 6,8α-H-dihydroazulenyl anion, or a mixture of two or more regioisomers.

Due to the presence of at least one H-dihydroazulenyl anion, i.e., at least one cyclopentadienyl-like monoanion, the compounds according to general formulae III, IV, V, and VI are suitable in particular as precatalysts, as catalysts and as electron transfer reagents for chemical reactions in which metal complexes having cyclopentadienyl ligands are otherwise employed. This is particularly advantageous because providing a H-dihydroazulenyl ligand is less labor intensive and time-consuming compared to providing the cyclopentadienyl ligand. This is because the reactants, for example natural substances such as guaiazulene and hydride reducing agents such as lithium triethylborohydride, are not only easier to handle and store, but also less expensive. In addition, fewer and simpler working steps have to be carried out. As a result, the synthesis effort and the production costs for the metal complexes used here are also lower than for analogous metal-Cp complexes. Consequently, the metal complexes described herein constitute an alternative for metal-Cp complexes, in particular with regard to industrial application.

Guaiazulene is a natural substance which contains chamomile oil and other essential oils and, advantageously, is thus available cost-effectively in large quantities. It can be produced synthetically from guaiol of the guaiac wood oil (guaiac resin). Guaiazulene is an intensely blue substance with anti-inflammatory action. One isomer of guaiazulene is, for example, 2-isopropyl-4,8-dimethylazulene (vetivazulene).

In an advantageous embodiment variant of the uses claimed herein or of the methods claimed herein for carrying out a chemical reaction or for preparing at least one metal layer consisting of the metal M or at least one layer containing a metal M, Azu=Gua=7-iso-propyl-1,4-dimethylamene and AzuH=GuaH=7-isopropyl-1,4-dimethyl-8-H-dihydroazulene.

Examples of the metal complexes used here are homoleptic sandwich complexes of middle transition metals (groups 6, 7 and 8), in particular of metals of group 8, and later transition metals, i.e., of metals of group 9, group 10, group 11, and group 12, in particular:
neutral sandwich complexes of the type M(L_{K})_{f}(AzuH)ₘ (III) with f=0, i.e., without neutral donor ligands L_{K}, e.g., Fe(GuaH)₂, Ru(GuaH)₂, Co(GuaH)₂, Zn(GuaH)₂, wherein the formal oxidation state is 2, M=Fe, Ru, Co or Zn, f=0, m=2 and AzuH=GuaH
and
cationic sandwich complexes of the type [M(L_{S})_{g}(AzuH)ᵥ]X (V) with g=0, i.e., without neutral donor ligands L_{S}, e.g., the d⁶ complex [Co(GuaH)₂]PF₆, wherein the formal oxidation state is 3, M=Co, g=0, v=3−1=2, AzuH=GuaH and X=PF₆.

On the other hand, the compounds used here are heteroleptic complexes of middle transition metals (groups 6, 7 and 8), in particular of metals of group 8, and later transition metals, i.e., of metals of group 9, group 10, group 11, and group 12, in particular:
neutral half-sandwich complexes of the type M(L_{K})_{f}(AzuH)ₘ (III) with f=1 or 2, i.e., with exactly one neutral sigma-donor ligand or with exactly one neutral, non-planar pi-donor ligand, e.g., Cu(PPh₃)(GuaH), Rh(nbd)(GuaH), Rh(cod)(GuaH), wherein the formal oxidation state is 1 in each case, M=Cu or Rh, L_{K}=PPh₃, NBD or COD, f is 1 in each case, m is 1 in each case and AzuH=GuaH, or two planar, neutral pi-donor ligands, e. g. Rh(ethene)₂(GuaH), wherein the formal oxidation state is 1, M=Rh, L_{K}=ethene, f=2, m=1, and AzuH=GuaH.
neutral half-sandwich complexes of the type M(L_{N})(AzuH)_{q} (IV), for example with |u|=1, 2 or 3, i.e., for example, with one, two or three monoanionic sigma-donor ligands, e.g., Zn(Mes)(GuaH), wherein the formal oxidation state is 2, M=Zn, L_{N}=Mes⁻, |u|=1, q=2−|−1|=1 and AzuH=GuaH, and PtMe₃(GuaH), 5 wherein the formal oxidation state is 4, M=Pt, L_{N}=CH₃⁻, |u|=3, q=4−|−3|=1 and AH=GuaH
neutral sandwich complexes of the type M(L_{N})(AzuH)_{q} (IV), for example with |u|=1, i.e., with exactly one monoanionic, planar pi-donor ligand, e.g., Ru(Cp*)(GuaH), wherein the formal oxidation state is 2, M=Ru, L_{N}=Cp*, |u|=1, q=2−|−1|=1 and AH=GuaH
cationic sandwich complexes of the type [M(L_{S})_{g}(AzuH)ᵥ]X (V) with g=1, i.e., with exactly one neutral, planar pi-donor ligand, e.g., [Ru(p-cymene)(GuaH)]PF₆, wherein the formal oxidation state is 2, M=Ru, L_{S}=p-cymene, g=1, v=2−1=1, AzuH=GuaH and X=PF₆
cationic half-sandwich complexes of the type [M(L_{S})_{g}(AzuH)ᵥ]X (v) with g=1 or 2, i.e., with a neutral non-planar pi-donor ligand, e.g., Pt(cod)(GuaH)]PF₆, wherein the formal oxidation state is 2, M=Pt, L_{S}=COD, g=1, v=2−1=1, AzuH=GuaH and X=PF₆, or with two planar, neutral pi-donor ligands, e.g., [Pt(ethene)₂(GuaH)]PF₆, wherein the formal oxidation state is 2, M=Pt, L_{S}=ethene, g=2, v=2−1=1, AzuH=GuaH and X=PF₆
cationic sandwich complexes of the type [M(L_{T})(AzuH)_{z}]X (VI) with |h|=1, i.e., with exactly one anionic, planar pi-donor ligand, e.g., [Rh(Cp*)(GuaH)]Cl, [Rh(Cp*)(GuaH)]PF₆, wherein the formal oxidation state in each case is 3, M=Rh, L_{T}=Cp*, |h|=1, z=3−(|−1|+1)=1, AzuH=GuaH and X=C1 or PF₆.

Examples of such isomerically pure metal complexes are Ru(Cp*)(GuaH), [Ru(p-cymene)(GuaH)]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH).

In the context of the present invention, “isomerically pure” means that the desired product is obtained or was obtained in isomerically pure form or the desired isomer is present after purification with a content of ≥90%, preferably of ≥95%, more preferably of ≥99%. Isomer purity is determined, for example, by means of nuclear magnetic resonance spectroscopy.

In particular with regard to use as metal precursor compounds for vapor deposition processes, it is advantageous that the complexes Ru(Cp*)(GuaH), Zn(Mes)(GuaH) and PtMe₃(GuaH) are not only obtainable in high (isomeric) purity of 97%, advantageously of more than 97%, in particular of more than 98% or 99%, and good yield, including space-time yield, but are also present as liquids in isolated form.

In step A) of the method described herein for carrying out a chemical reaction or for preparing at least one metal layer consisting of the metal M or at least one layer containing a metal M, the provision of a metal complex or multiple metal complexes can be provided in each case. In one embodiment variant of the respective method, it is provided that in step A) at least one metal complex is provided as a solid, as a liquid or as a solution or suspension comprising a metal complex. Alternatively or additionally, multiple metal complexes can be provided independently of one another as separate solids or as solid mixtures or as separate liquids or as liquid mixtures or as separate solutions or suspensions, each comprising a metal complex, or as a solution or suspensions comprising multiple metal complexes.

At this point as well as in the following, the specification of an exact stoichiometry of the depositable metal-containing layers or films has been dispensed with. The term “layer” is synonymous with the expression “film” and does not make any statement regarding the layer thickness or the film thickness. In addition, according to the present invention, a metal layer consisting of the metal M or a layer containing a metal M can contain or consist of nanoparticles of a metal M or nanoparticles of different metals M or nanoparticles each comprising multiple metals M.

Due to their very high degree of (isomeric) purity, the metal complexes used are particularly suitable as precursor compounds for preparing high-quality metal layers or layers containing metal M on a surface of a substrate. This is, in particular, attributable to their preparation based on a method in accordance with one of the embodiments described above, namely using alkali metal H-dihydroazulenides, obtained or obtainable according to a method for preparing alkali metal H-dihydroazulenides in accordance with one of the exemplary embodiments described above. In addition, the metal complexes or solutions or suspensions to be provided according to step A), and comprising such metal complexes, can be prepared in a particularly simple and comparatively cost-effective manner by a method for preparing such compounds or solutions or suspensions according to one of the embodiments described above. The latter enables the use thereof on an industrial scale.

In one embodiment of the uses described herein or of the methods claimed herein for carrying out a chemical reaction or for preparing at least one metal layer consisting of the metal M or at least one layer containing a metal M, metal complexes of the general formula M(L_{K})_{f}(AzuH)ₘ (III) are provided.

According to yet another embodiment of the claimed uses or of the claimed methods, the central metal atom M of the metal complex of the general formula M(L_{K})_{f}(AzuH)ₘ (III) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed uses or of the claimed methods provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed uses or of the claimed method, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed uses or of the claimed methods provides that the central metal atom M has a formal oxidation state of 1, 2, 3, 4, 5, 6, or 7. According to an alternative or supplementary embodiment of the claimed uses or of the claimed methods, it is provided that the index m and the formal oxidation state of the central metal atom M of the metal complex of the general formula M(L_{K})_{f}(AzuH)ₘ (III) are identical, i.e., are the same natural number, zero being excluded. Thus, it is possible that m=1, 2, 3, 4, 5, 6, or 7.

According to a further embodiment variant of the claimed uses or of the claimed method, a metal complex of the general formula M(L_{K})_{f}(AzuH)ₘ (III) is provided, wherein the central metal atom M has a formal oxidation state of 1, 2, 3, or 4, advantageously of 1, 2 or 3, in particular of 1 or 2. In an alternative or supplementary embodiment variant of the claimed uses or of the claimed methods, the index m is 1, 2, 3, or 4, advantageously 1, 2 or 3, in particular 1 or 2. A further alternative or supplementary embodiment of the claimed uses or of the claimed methods provides that the index f, which indicates the number of neutral ligands L_{K} in a metal complex of the general formula M(L_{K})_{f}(AzuH)ₘ (III), is zero, 1, 2, 3, 4, or 5, advantageously zero, 1, 2, 3, or 4, in particular zero, 1, 2 or 3.

In another embodiment variant of the claimed uses or of the claimed methods, the sum of the number m of ligands AzuH and the number f of neutral ligands L_{K}, i.e., (f+m), is 2, 3, 4, 5, 6, or 7. Another embodiment provides that the sum of the number m of ligands AzuH and the number f of neutral ligands L_{K}, i.e., Σ(f+m), is 2, 3, 4, 5, or 6, advantageously 2, 3, 4, or 5, in particular 2, 3 or 4.

A further embodiment provides that the neutral sigma-donor ligand L_{K} or pi-donor ligand L_{K} is selected from the group consisting of monodentate and polydentate phosphorus donor ligands, alkenes, cyclic dienes and cyclic polyenes, and mononuclear arenes, polynuclear arenes, mononuclear heteroarenes and polynuclear heteroarenes, and derivatives thereof.

The term “phosphorus donor ligand” is defined above. An exemplary selection of phosphorus donor ligands is also given in a non-limiting manner above.

Further examples of the ligands L_{K} are the alkenes ethene, propene, butene, pentene, hexene, heptene, octene, nonene, decene, and isomers thereof, the bicyclic alkene bicyclo[2.2.1]hept-2-ene, the cyclic diene cycloocta-1,5-diene (COD), the bicyclic diene bicyclo[2.2.1]hepta-2,5-diene (NBD), the monocyclic cycloocta-1,3,5,7-tetraene (COT).

Examples of a monocyclic arene and derivatives of a mononuclear arene are benzene and benzene derivatives, e.g., toluene, p-cymene and halogenated benzenes. Naphthalene and naphthalene derivatives are examples of a polycyclic arene and a derivative of a polynuclear arene. One example of a heteroarene is pyridine. A binuclear or bicyclic heteroarene is, for example, indole. The mononuclear arenes, polynuclear arenes, mononuclear heteroarenes and polynuclear heteroarenes may also be substituted, in particular alkyl groups and/or alkenyl groups and/or alkynyl groups and/or aryl groups and/or heteroaryl groups and/or halogen substituents.

A further advantageous embodiment of the uses described herein or of the methods claimed herein for carrying out a chemical reaction or for preparing at least one metal layer consisting of the metal M or at least one layer containing a metal M provides that the central metal atom M of the metal complex of the general formula M(L_{K})_{f}(AzuH)ₘ (III) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In a further embodiment of the uses described herein or of the methods claimed herein for carrying out a chemical reaction or for preparing at least one metal layer consisting of the metal M or at least one layer containing a metal M, metal complexes of the general formula M(L_{N})(AzuH)_{q} (IV) are provided.

According to yet another embodiment of the claimed uses or of the claimed methods, the central metal atom M of the metal complex of the general formula M(L_{N})(AzuH)_{q} (IV) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed uses or of the claimed methods provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed uses or of the claimed method, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed uses or of the claimed methods provides that the central metal atom M has a formal oxidation state of 2, 3, 4, 5, 6, or 7. According to an alternative or supplementary embodiment of the claimed uses or of the claimed methods, it is provided that w₂ and the formal oxidation state of the central metal atom M of the metal complex of the general formula M(L_{N})(AzuH)_{q} (IV) are identical, i.e., are the same natural number, zero being excluded. Consequently, it is possible that w₂=2, 3, 4, 5, 6, or 7.

According to a further embodiment variant of the claimed uses or of the claimed methods, metal complexes of the general formula M(L_{N})(AzuH)_{q} (IV) are provided, wherein the central metal atom M has a formal oxidation state of 2, 3, 4, 5, or 6, advantageously of 2, 3, 4, or 5, in particular of 2, 3 or 4. In an alternative or supplementary embodiment variant of the claimed uses or of the claimed methods, w₂=2, 3, 4, 5, or 6, advantageously w₂=2, 3, 4, or 5, in particular w₂=2, 3 or 4. A further alternative or supplementary embodiment of the claimed uses or of the claimed method provides that |u|, i.e., the absolute value of the sum of the negative charges of all anionic ligands L_{N} in a metal complex of the general formula M(L_{N})(AzuH)_{q} (IV), is 1, 2, 3, 4, 5, or 6. In yet another embodiment variant, |u|, i.e., the absolute value of the sum of the negative charges of all anionic ligands L_{N} in a metal complex of the general formula M(L_{N})(AzuH)_{q} (IV), is 1, 2, 3, 4, or 5, advantageously 1, 2, 3, or 4, in particular 1, 2 or 3.

In another embodiment variant of the claimed uses or of the claimed methods, the sum of the number q of ligands AzuH and the number of anionic ligands L_{N} is 2, 3, 4, 5, 6, or 7. A further embodiment provides that the sum of the number q of ligands AzuH and the number of anionic ligands L_{N} is 2, 3, 4, 5, or 6, advantageously 2, 3, 4, or 5, in particular 2, 3 or 4.

Another embodiment of the claimed uses or of the claimed methods provides metal complexes of the general formula M(L_{N})(AzuH)_{q}(IV), wherein the anionic sigma-donor ligand L_{N} or pi-donor ligand L_{N} is advantageously a monoanionic ligand which is selected from the group consisting of anions of cyclopentadiene and derivatives thereof, alkyl anions and aryl anions. Alternatively or additionally, a fluoride anion can be provided as at least one of the monoanionic ligands L_{N}.

Examples of the anionic ligands L_{N} are the cyclopentadienyl anion C₅H₅⁻ (Cp⁻) and the 1,2,3,4,5-pentamethylcyclopentadienyl anion C₅Me₅⁻ (Cp*), the methyl anion CH₃⁻ (Me⁻) and the mesityl anion Me₃C₆H₂⁻ (Mes⁻). The aforementioned anions can act as monoanionic pi-donor ligands or sigma-donor ligands L_{N} in the context of the preparation of neutral sandwich or half-sandwich complexes of the type M(L_{N})(AzuH)_{q} (IV).

A further advantageous embodiment of the uses described herein or of the methods claimed herein for carrying out a chemical reaction or for preparing at least one metal layer consisting of the metal M or at least one layer containing a metal M provides that the central metal atom M of the metal complex of the general formula M(L_{N})(AzuH)_{q} (IV) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In another embodiment of the uses described herein or of the methods claimed herein for carrying out a chemical reaction or for preparing at least one metal layer consisting of the metal M or at least one layer containing a metal M, metal complexes of the general formula [M(L_{S})_{g}(AzuH)ᵥ]X (V) are provided.

According to a further embodiment of the claimed uses or of the claimed methods, the central metal atom M of the metal complex of the general formula [M(L_{S})_{g}(AzuH)ᵥ]X (V) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed uses or of the claimed methods provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed uses or of the claimed method, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed uses or of the claimed methods provides that the central metal atom M has a formal oxidation state of 2, 3, 4, 5, 6, or 7. According to an alternative or supplementary embodiment of the claimed uses or of the claimed methods, it is provided that w₃ and the formal oxidation state of the central metal atom M of the metal complex of the general formula [M(L_{S})_{g}(AzuH)ᵥ]X (V) are identical, i.e., are the same natural number, zero being excluded. Consequently, it is possible that w₃=2, 3, 4, 5, 6, or 7.

According to a further embodiment variant of the claimed uses or of the claimed methods, metal complexes of the general formula [M(L_{S})_{g}(AzuH)ᵥ]X (V) are provided, wherein the central metal atom M has a formal oxidation state of 2, 3, 4, 5, or 6, advantageously of 2, 3, 4, or 5, in particular of 2, 3 or 4. In an alternative or supplementary embodiment variant of the claimed uses or of the claimed methods, w₃=2, 3, 4, 5, or 6, advantageously w₃=2, 3, 4, or 5, in particular w₃=2, 3 or 4. A further alternative or supplementary embodiment of the claimed uses or of the claimed methods provides that the index g, which indicates the number of neutral ligands L_{S} in a metal complex of the general formula [[M(L_{S})_{g}(AzuH)ᵥ]X (V), is zero, 1, 2, 3, 4, 5, or 6. In yet another embodiment variant, the index g, which indicates the number of neutral ligands L_{S} in a metal complex of the general formula [M(L_{S})_{g}(AzuH)ᵥ]X (V), is zero, 1, 2, 3, 4, or 5, advantageously zero, 1, 2, 3, or 4, in particular zero, 1, 2 or 3.

In another embodiment variant of the claimed uses or of the claimed methods, the sum of the number v of ligands AzuH and the number g of neutral ligands L_{S}, i.e., (g+v), is 2, 3, 4, 5, 6, or 7. A further embodiment provides that the sum of the number v of ligands AzuH and the number g of neutral ligands L_{S}, i.e., (g+v), is 2, 3, 4, 5, or 6, advantageously 2, 3, 4, or 5, in particular 2, 3 or 4.

In a further variant of the claimed uses or of the claimed methods, the neutral sigma-donor ligand L_{S} or the neutral pi-donor ligand L_{S} is selected from the group consisting of monodentate and polydentate phosphorus donor ligands, alkenes, cyclic dienes and cyclic polyenes, and mononuclear arenes, polynuclear arenes, mononuclear heteroarenes and polynuclear heteroarenes, and derivatives thereof.

The term “phosphorus donor ligand” is defined above. An exemplary selection of phosphorus donor ligands is also given in a non-limiting manner above.

Further examples of the neutral, in particular pi-donor ligands L_{S} are the alkenes ethene, propene, butene, pentene, hexene, heptene, octene, nonene, decene, and isomers thereof, the bicyclic alkene bicyclo[2.2.1]hept-2-ene, the cyclic diene cycloocta-1,5-diene (COD), the bicyclic diene bicyclo[2.2.1]hepta-2,5-diene (NBD), the monocyclic cycloocta-1,3,5,7-tetraene (COT).

Examples of a monocyclic arene and derivatives of a mononuclear arene are benzene and benzene derivatives, e.g., toluene, p-cymene and halogenated benzenes. Naphthalene and naphthalene derivatives are examples of a polycyclic arene and a derivative of a polynuclear arene. One example of a heteroarene is pyridine. A binuclear or bicyclic heteroarene is, for example, indole. The mononuclear arenes, polynuclear arenes, mononuclear heteroarenes and polynuclear heteroarenes may also be substituted, in particular alkyl groups and/or alkenyl groups and/or alkynyl groups and/or aryl groups and/or heteroaryl groups and/or halogen substituents.

A further advantageous embodiment of the claimed uses or of the claimed methods provides that the central metal atom M of the metal complex of the general formula [M(L_{S})_{g}(AzuH)ᵥ]X (V) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In yet another embodiment of the uses described herein or of the methods claimed herein for carrying out a chemical reaction or for preparing at least one metal layer consisting of the metal M or at least one layer containing a metal M, metal complexes of the general formula [M(L_{T})(AzuH)_{z}]X (VI) are provided.

According to a further embodiment of the claimed uses or of the claimed methods, the central metal atom M of the metal complex of the general formula [M(L_{T})(AzuH)_{z}]X (VI) is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Another variant of the claimed uses or of the claimed methods provides that the central metal atom M is selected from the group consisting of chromium, molybdenum, tungsten, manganese, rhenium, iron, ruthenium, cobalt, rhodium, nickel, platinum, copper, silver, zinc, and cadmium. According to yet another embodiment of the claimed uses or of the claimed method, the central metal atom M is selected from the group consisting of chromium, molybdenum, tungsten, manganese, rhenium, iron, ruthenium, cobalt, rhodium, nickel, platinum, copper, silver, and zinc, in particular from the group consisting of chromium, molybdenum, tungsten, manganese, iron, ruthenium, cobalt, rhodium, platinum, copper, and zinc.

A further embodiment of the claimed uses or of the claimed methods provides that the central metal atom M has a formal oxidation state of 3, 4, 5, 6, or 7. According to an alternative or supplementary embodiment of the claimed compounds or the claimed methods, it is provided that w₄ and the formal oxidation state of the central metal atom M of the metal complex of the general formula [M(L_{T})(AzuH)_{z}]X (VI) are identical, i.e., are the same natural number, zero being excluded. Consequently, it is possible that w₄=3, 4, 5, 6, or 7.

According to a further embodiment variant of the claimed uses or of the claimed methods, metal complexes of the general formula [M(L_{T})(AzuH)_{z} are provided, wherein the central metal atom M has a formal oxidation state of 3, 4, 5, or 6, in particular 3, 4 or 5. In an alternative or supplementary embodiment variant of the claimed uses or of the claimed methods, w₄=3, 4, 5, or 6, in particular w₄=3, 4 or 5. A further alternative or supplementary embodiment of the claimed uses or of the claimed method provides that |h|, i.e., the absolute value of the sum of negative charges of all anionic ligands L_{T} in a metal complex of the general formula [M(L_{T})(AzuH)_{z}]X (VI), is 1, 2, 3, or 4, in particular 1, 2 or 3.

In another embodiment variant of the claimed uses or of the claimed methods, the sum of the number z of ligands AzuH and the number of anionic ligands L_{T} is 2, 3, 4, 5, or 6. A further embodiment provides that the sum of the number z of ligands AzuH and the number of anionic ligands L_{T} is 2, 3, 4, or 5, in particular 2, 3 or 4.

A further embodiment of the claimed uses or of the claimed methods provides metal complexes of the general formula [M(L_{T})(AzuH)_{z}]X (VI), wherein the ligand L_{T} is a monoanionic ligand selected from the group consisting of anions of cyclopentadiene and derivatives thereof and a fluoride anion, or a dianionic ligand. A dianionic ligand L_{T} is selected, for example, from the group consisting of an oxidoligand O²⁻, an imidoligand (NR^{Q})²⁻ and an alkylidene ligand (CR^{P}R^{V})²⁻. In this case, R^{Q}, R^{P} and R^{V} are independently selected from primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene, wherein the substituents R^{P} and R^{V} may optionally form a ring. The radicals R^{Q}, R^{P} and RV can also be substituted independently of one another, in particular halogenated.

Examples of anions of cyclopentadiene (Cp) are the cyclopentadienyl anion C₅H₅⁻ (Cp⁻) and the 1,2,3,4,5-pentamethylcyclopentadienyl anion C₅Me₅⁻ (Cp*). The aforementioned anions can be provided as planar pi-donor ligands L_{T} in cationic sandwich complexes of the type [M(L_{T})(AzuH)_{z}]X (VI).

A further advantageous embodiment of the claimed uses or of the claimed methods provides that the central metal atom M of the metal complex of the general formula [M(L_{T})(AzuH)_{z}]X (VI) is selected from group 8, group 9, group 10, group 11, or group 12. The central metal atom M is in this case advantageously selected from the group consisting of iron, ruthenium, osmium, cobalt, rhodium, iridium, nickel, palladium, platinum, copper, silver, gold, zinc, cadmium, and mercury. The central metal atom M is even more advantageously selected from the group consisting of iron, ruthenium, cobalt, rhodium, nickel, platinum, copper, silver, zinc, and cadmium. The central metal atom M is particularly advantageously selected from the group consisting of iron, ruthenium, cobalt, rhodium, nickel, platinum, copper, silver, and zinc, in particular from the group consisting of iron, ruthenium, cobalt, rhodium, platinum, copper, and zinc.

In one embodiment of the uses described herein or of the methods claimed herein for carrying out a chemical reaction or for preparing at least one metal layer consisting of the metal M or at least one layer containing a metal M, the metal complex is selected from the group consisting of Fe(GuaH)₂, Ru(GuaH)₂, Ru(Cp*)(GuaH), [Ru(p-cymene)(GuaH)]PF₆, Co(GuaH)₂, [Co(GuaH)₂]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH), and mixtures thereof, advantageously from the group consisting of Ru(Cp*)(GuaH), [Ru(p-cymene)(GuaH)]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH), and mixtures thereof, particularly advantageously from the group consisting of Ru(Cp*)(GuaH), Zn(Mes)(GuaH) and PtMe₃(GuaH). In particular, the metal complex is PtMe₃(GuaH).

In another embodiment of the method claimed herein for preparing a metal layer or a layer containing metal M, the deposition of the metal layer or the layer containing metal M is carried out in step B) by means of a vapor deposition method. Advantageously, the metal layer or the layer containing metal M is deposited by means of an ALD method or an MOCVD method, in particular by means of an MOVPE method. Alternatively, a sol-gel method can be used, wherein the sol can be deposited on one or more surfaces of the substrate by means of spin coating or dip coating, for example.

A further variant of the use described herein or of the methods claimed provides a sequential deposition of multiple metal layers and/or metal-containing layers on the surface of the substrate. In this case, step B) is repeated, wherein the respective metal-containing layers and/or metal layers are deposited in succession. The first layer is deposited directly on the surface of the substrate, whereas the further layers are deposited on the surface of the previously deposited layer in each case.

The substrate may, for example, comprise or be manufactured from one non-metal or multiple non-noble metals. Alternatively or additionally, the substrate may comprise one or more non-metallic materials or consist entirely of one non-metallic material or multiple such materials. Corundum foils or thin metallic foils can, for example, be used as the substrate. The substrate itself can be part of a component. In one embodiment of the aforementioned use of a metal complex as precursor compound for preparing a metal layer or a layer containing metal M, or in one embodiment of the method for preparing a metal layer or a layer containing metal M on a surface of a substrate, the substrate is a wafer. The wafer may comprise silicon, silicon carbide, germanium, gallium arsenide, indium phosphide, a glass, such as SiO₂, and/or a plastic, such as silicone, or consist entirely of one or more such materials. The wafer can also have one or more wafer layers, each having one surface. The production of a metal layer or a layer containing metal M may be provided on the surface of one or more wafer layers.

Substrates obtained or obtainable by means of the use claimed herein or the method described herein, comprising a metal layer or a layer containing metal M, in particular a platinum layer or a layer containing platinum, optionally comprising metal nanoparticles or consisting of metal nanoparticles, can be used particularly well for the production of an electronic component, in particular an electronic semiconductor component, or a redox-active electrode for a fuel cell, due to the high purity of the metal layer or the layer containing metal M. In the latter case, the platinum layer or the layer containing platinum nanoparticles acts as a catalytic layer.

The object is also achieved by a substrate having
i. at least one metal layer consisting of the metal M
or
ii. at least one layer containing a metal M,
on at least one surface,
wherein the at least one metal layer consisting of the metal M or the at least one layer containing a metal M is producible or produced using
a metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI)
or a solution or suspension comprising such a metal complex and at least one, in particular aprotic polar, solvent which is miscible with or identical to the solvent S_{P},
   according to an embodiment of the compounds described above
or
   obtained or obtainable by a method for preparing such metal complexes or solutions or suspensions according to one of the embodiments described above.

In this case, M, L_{K}, f, m, L_{N}, q, L_{S}, g, v, L_{T}, z, X⁻, AzuH and Azu are as defined above.

Regarding the selection of usable metal complexes according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI) and of solutions or suspensions comprising such a metal complex and at least one, in particular aprotic polar, solvent which is miscible with or identical to the solvent S_{P}, reference is made to the statements relating to the method described above for preparing such a substrate.

A definition of the term “miscible” has already been given above.

With regard to the advantages of such a substrate, reference is made to the advantages mentioned for the method described above for the production of such a substrate.

In an advantageous embodiment of the substrate claimed herein, the at least one metal layer consisting of the metal M or the at least one layer containing a metal M is producible or produced using a metal complex according to one of the formulae M(L_{K})_{f}(AzuH)ₘ (III), M(L_{N})(AzuH)_{q} (IV), [M(L_{S})_{g}(AzuH)ᵥ]X (V) and [M(L_{T})(AzuH)_{z}]X (VI), where Azu=Gua=7-iso-propyl-1,4-dimethylazulene and AzuH=GuaH=7-isopropyl-1,4-dimethyl-8-H-dihydroazulene.

Other characteristics, details, and advantages of the invention follow from the exact wording of the claims, as well as from the following description of the embodiment examples based upon the illustrations. The following are shown:

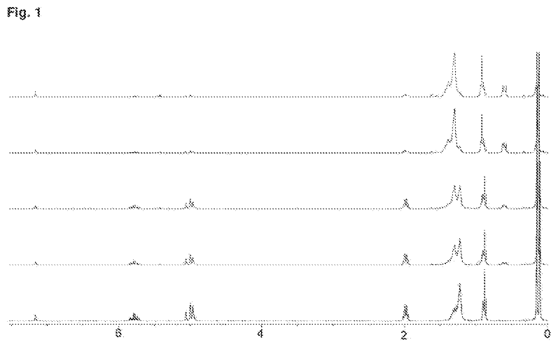

FIG. 1 ¹H-NMR spectra for determining the conversion of the hydrosilylation reaction of 1-octene with pentamethylsiloxane using 5 ppm PtMe₃(GuaH) as catalyst, where GuaH=7-iso-propyl-1,4-dimethyl-8-H-dihydroazulene, and

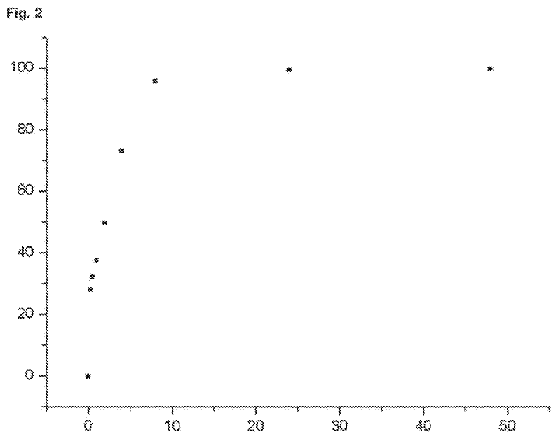

FIG. 2 a diagram relating to the conversion of the hydrosilylation reaction of 1-octene with pentamethylsiloxane using 5 ppm of PtMe₃(GuaH) as catalyst.

The ¹H NMR spectra shown in FIG. 1 were recorded in C₆D₆ at 298 K and 300 MHz. The chemical shift δ is plotted in ppm on the x-axis.

During the hydrosilylation reaction of 1-octene with pentamethylsiloxane using 5 ppm PtMe₃(GuaH) as catalyst (cf. Example 15, NMR experiments with 5 ppm Pt), the ¹H NMR spectra shown in FIG. 1 were recorded at predefined time intervals. The lowest ¹H NMR spectra were recorded at time 0 h, i.e., before the hydrosilylation reaction started. Above this ¹H NMR spectrum are shown—in increasing order—the ¹H NMR spectra recorded after approximately 0.25 h, 1 h, 8 h, and 48 h. Further ¹H NMR spectra, not shown here, were recorded after approximately 0.5 h, 2 h, 4 h, and 24 h in C₆D₆ at 298 K and 300 MHz.

The reaction equation for the hydrosilylation of 1-octene is as follows:

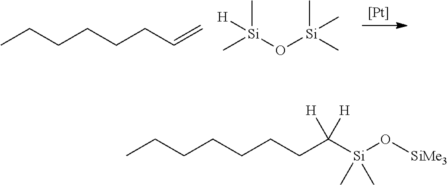

In each case, the conversion was determined based on the CH₂ group of the product (highlighted in gray in the product molecule) with a shift of 0.60 ppm. The calculation of the above conversions also took into account the ¹H NMR spectra recorded after approximately 0.50 h, 2 h, 4 h, and 24 h in C₆D₆ at 298 K and 300 MHz. Table 1 lists the calculated conversions of the hydrosilylation reaction of 1-octene with pentamethylsiloxane using 5 ppm PtMe₃(GuaH) as catalyst (see column 2).

TABLE 1

| Time in h | Conversion in % |
|---|---|
| 0 | 0.0 |
| 0.25 | 28.0 |
| 0.50 | 32.3 |
| 1 | 37.6 |
| 2 | 49.8 |
| 4 | 73.1 |
| 8 | 95.8 |
| 24 | 99.5 |
| 48 | 100.0 |

The graphical evaluation of the results listed in Table 2 is shown in FIG. 2. The time in hours (h) is plotted on the abscissa, and the conversion in percent (%) on the ordinate.

It can be concluded that the hydrosilylation reaction using 5 ppm PtMe₃(GuaH) as catalyst is almost complete after about 8 h. Consequently, a satisfactory reaction rate is achieved.

Advantageously, the Pt(IV) compound PtMe₃(GuaH) is present as a liquid and shows an absorption in the visible range. The latter is a further advantage of the Pt(IV) compound used here. This is because light-induced platinum-catalyzed hydrosilylation reactions regularly involve the use of UV-Vis light, which usually requires special safety measures to reduce the risk of skin cancer. Such safety measures are not mandatory when using PtMe₃(GuaH).

According to the established teaching, photolysis of a known catalyst containing a cyclopentadienyl anion, such as CpPtMe₃ and (MeCp)PtMe₃, in the presence of a silane, such as pentamethylsiloxane, leads to the formation of a platinum colloid as active hydrosilylation catalyst. (L. D. Boardman, Organometallics 1992, 11, 4194-4201) Boardman gives a catalyst concentration of 10 ppm platinum as CpPtMe₃ for the hydrosilylation reaction of 1-octene with pentamethylsiloxane (equimolar mixture).

When using the precatalyst PtMe₃(GuaH) presented for the first time in the present invention, complete conversion of the substrates 1-octene and pentamethylsiloxane is observed already at 50% of the catalyst concentration chosen in the literature, i.e., at a catalyst concentration of 5 ppm platinum as PtMe₃(GuaH).

A further advantage of the compound PtMe₃(GuaH) used here as a precatalyst over Pt(IV) compounds containing cyclopentadienyl anions consists in the fact that the guaiazulene required for the preparation thereof is synthesized using renewable raw materials instead of petroleum. As a result, the preparation of the Pt(IV) complex PtMe₃(GuaH) can be achieved in a comparatively sustainable, simple and inexpensive manner.

Consequently, the half-sandwich complex PtMe₃(GuaH) used in the context of the present invention as a precatalyst for the hydrosilylation reaction of 1-octene with pentamethylsiloxane constitutes a relatively sustainable and cost-effective alternative to previously known hydrosilylation catalysts such as CpPtMe₃ and (MeCp)PtMe₃.

Operating procedures for synthesis of Li(GuaH), Na([15]-crown-5)(GuaH), K([18]-crown-6)(GuaH), Fe(GuaH)₂, Ru(GuaH)₂, Ru(Cp*)(GuaH), [Ru(p-cymene)(GuaH)]PF₆, Co(GuaH)₂, [Co(GuaH)₂]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH)

(GuaH)⁻=7-iso-propyl-1,4-dimethyl-8-H-dihydroazulenyl, C₁₅H₁₉⁻

Cp*=1,2,3,4,5-pentamethylcyclopentadienyl, C₅Me₅⁻

### Materials and Methods

All reactions were carried out in a standard inert gas atmosphere. The solvents and reagents used were purified and dried according to standard procedures. In the case of reagents which were used as solutions, the contents were determined by titration or ICP-MS/OES.

All nuclear magnetic resonance spectroscopic measurements were carried out using a Bruker AV II 300, Bruker AV II HD 300, DRX 400, or AV III 500 instrument. ¹³C NMR spectra were measured as standard using ¹H broadband decoupling at 300 K. ¹H and ¹³C-NMR spectra were calibrated to the corresponding residual proton signal of the solvent as an internal standard: ¹H: DMSO[d₆]: 2.50 ppm; ¹³C: DMSO[d₆]: 39.52 ppm. The chemical shifts are indicated in ppm and refer to the 6 scale. All signals are given the following abbreviations according to their splitting pattern: s (singlet), d (doublet), t (triplet), q (quartet), sept (septet), m (multiplet), br (broad signal).

In substance, the measurements of infrared spectra were usually performed on an Alpha ATR-IR spectrometer made by Bruker. The absorption bands are indicated in wave number (cm⁻¹), and the intensity is described with the following abbreviations: w (weak), m (medium strong), st (strong), vst (very strong), br (broad). The spectra were always normalized to the band with the highest intensity.

High-resolution LIFDI mass spectra were obtained using an AccuTOF GCv-TOF mass spectrometer (JEOL).

The elemental analyses were carried out on a vario MICRO cube combustion device made by Elementar. Sample preparation was carried out in a glove box flooded with nitrogen by weighing the substance in tin crucibles, which were cold-welded and stored in a protective gas atmosphere until measurement. The elements of hydrogen, carbon and nitrogen were determined by means of a combustion analysis, wherein the information is always given in mass percent.

Data collection for crystal structure analysis was carried outed using a Stoe Stadivari diffractometer or a Bruker D8 Quest diffractometer by the Department of Chemistry, University of Marburg, Germany. After the solution process (SHELXT) and refinement process (SHELXL 2017/1), the data were validated using Platon. The molecular structures were graphically illustrated using Diamond 4.

### Example 1: Preparation of Li(GuaH)

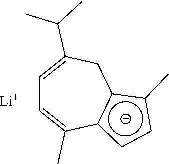

Method A. Guaiazulene (5.00 g, 25.0 mmol, 1.00 eq.) and lithium triethylborohydride (1.7 M in THF) (15 mL, 25.5 mmol, 1.02 eq.) were added to a flask flooded with argon gas, and the solvent was removed in vacuo. After addition of Et₂O (150 mL), the reaction mixture was heated to 40° C. and stirred at this temperature for three days. The disappearance of the blue color indicated that the reaction was complete. The precipitated colorless solid was separated off by filtration, washed with Et₂O (3×15 mL) and pentane (3×15 mL), and dried in vacuo. Li(GuaH) was obtained in a yield of about 60%.

Method B. Guaiazulene (5.00 g, 25.0 mmol, 1.00 eq.) and LiAlH₄ (950 mg, 25.0 mmol, 1.00 eq.) were added to a flask flooded with argon and suspended in THF (150 mL). The reaction mixture was heated to 60° C. and stirred for 24 h at this temperature. The disappearance of the blue color indicated that the reaction was complete. Aluminum hydride was captured by adding 1,4-diazabicyclo[2.2.2]octane (DABCO®). The precipitated solid was separated off by filtration and the solvent was removed in vacuo. Et₂O (150 mL) was added to the residue, and the undissolved colorless-grayish solid was isolated by filtration, washed with Et₂O (3×15 mL) and pentane (3×15 mL), and dried in vacuo. Li(GuaH) was obtained in a yield of about 60%.

Method C. Guaiazulene (5.00 g, 25.0 mmol, 1.00 eq.), LiH (2.00 g, 250 mmol, ˜10 eq.), and LiAlH₄ (48 mg, 1.26 mmol, 0.05 eq., 5 mol %) were placed in a flask flooded with argon and suspended in THF (150 mL). The reaction mixture was heated to 60° C. and stirred at this temperature for 7 days. The disappearance of the blue color indicated that the reaction was complete. Excess lithium hydride was separated off by filtration and the solvent was removed in vacuo. Et₂O (150 mL) was added to the residue, and the undissolved colorless-grayish solid was isolated by filtration, washed with Et₂O (3×15 mL) and pentane (3×15 mL), and dried in vacuo. Li(GuaH) was obtained in a yield of about 60%.

¹H-NMR (300.1 MHz, [D₆]DMSO): δ_{H}=5.37 (q, ⁴J_{HH}=2.91 Hz, 2H), 5.30 (d, ³J_{HH}=6.87 Hz, 1H), 4.87 (d, ³J_{HH}=6.41 Hz, 1H), 2.77 (s, 2H), 2.32 (sept, ³J_{HH}=6.41 Hz, 1H), 2.01 (s), 1.96 (s), 1.01 (d, ³J_{HH}=6.85 Hz, 6H) ppm; ¹³C-NMR (75.5 MHz, [D₆]DMSO): δ_{C}=136.7 (s, 1C), 135.4 (s, 1C), 121.9 (s, 1C), 118.8 (s, 1C), 115.0 (s, 1C), 108.5 (s, 1C), 106.9 (s, 1C), 106.7 (s, 1C), 100.3 (s, 1C), 36.0 (s, 1C), 29.1 (s, 1C), 24.2 (s, 1C), 22.4 (s, 2C), 13.8 (s, 1C) ppm.

### Note:

The compound Li(GuaH) can also be prepared by reacting guaiazulene with lithium tri-sec-butyl borohydride (L-Selectride® solution, 1.0 M in THF).

The compounds Na(GuaH) and K(GuaH) can be prepared by reacting guaiazulene with sodium triethylborohydride (e.g., 1.0 M in THF), sodium tri-sec.-butyl borohydride solution (N-Selectride® solution, 1.0 M in THF), potassium triethyl borohydride (e.g., 1.0 M in THF), or potassium tri-sec.-butyl borohydride (K-Selectride® solution, 1.0 M in THF). An isolatable solid was obtained by adding the corresponding crown ether in each case, thus forming Na([15]-crown-5)(GuaH) and K([18]-crown-6)(GuaH). Yellow needles of K([18]-crown-6)(GuaH) suitable for crystal structure analysis were obtained from a saturated THF solution overlaid with pentane at −20° C.

### Example 2: Preparation of Fe(GuaH)₂

Li(GuaH) (500 mg, 2.42 mmol, 2.0 eq.) and FeCl₂(154 mg, 1.21 mmol, 1.0 eq.) were suspended in diethyl ether (40 mL), and the suspension was stirred at room temperature for 20 h. The solvent was removed in vacuo. The residue was taken up in pentane, and the inorganic salts were separated off by filtration. The remaining red oil was purified by column chromatography (Al₂O₃, CH₂Cl₂). By recrystallization of the isolated product from ethyl acetate or methanol at −20° C. overnight, the rac diastereomer was obtained as a red solid and isolated by filtration (72%).

¹H-NMR (300.1 MHz, CDCl₃): δ_{H}=5.99 (d, ³J_{HH}=6.52 Hz, 2H), 5.57 (d, ³J_{HH}=6.57 Hz, 2H), 4.10 (d, ⁴J_{HH}=2.39 Hz, 2H), 3.76 (d, ⁴J_{HH}=2.56 Hz, 2H) 3.06 (m, 4H), 2.36 (sept., ³J_{HH}=6.8 Hz, 2H), 2.23 (s, 6H), 1.97 (s, —CH₃, 6H), 1.03 (m, 12H) ppm; ¹³C-NMR (75.5 MHz, CDCl₃): δ_{C}=145.49 (s, 2C), 136.80 (s, 2C), 123.74 (s, 2C), 120.14 (s, 2C), 85.81 (s, 2C), 81.34 (s, 2C), 81.31 (s, 2C), 71.32 (s, 2C), 66.25 (s, 2C), 36.54 (s, 2C), 27.35 (s, 2C), 23.32 (s, 2C), 21.89 (s, 2C), 21.56 (s, 2C), 11.69 (s, 2C) ppm; HR-MS (El(+)): m/z [FeC₃₀H₃₈] detected: 454.1879 [M], calculated: 454.2177; Elemental analysis calculated (%) for C₃₀H₃₈Fe (454.48 g/mol): C, 79.28; H, 8.43; detected: C, 79.12, H, 8.32; IR (KBr compact): \tilde{v}=2957 (s), 2898 (m), 2866 (m), 1631 (vw), 1593 (w), 1448 (m), 1345 (w), 1310 (w), 1275 (w), 1194 (w), 1181 (w), 1094 (m), 1078 (s), 1042 (w), 1026 (w), 987 (w), 952 (w), 863 (w), 841 (s), 815 (s), 803 (vs), 768 (vs), 694 (m), 590 (s), 551 (m), 538 (s), 511 (vw), 489 (m), 478 (w), 452 (vs), 445 (s), 423 (w) cm¹.

### Example 3: Preparation of Ru(GuaH)₂

Li(GuaH) (500 mg, 2.42 mmol, 2.0 eq.) and Ru(tht)₄Cl₂ (636 mg, 1.21 mmol, 1.0 eq.) or Ru(dmso)₄Cl₂ (586 mg, 1.21 mmol, 1.0 eq) were suspended in THF (40 mL), and the suspension was stirred at room temperature for 20 h. The solvent was removed in vacuo. The residue was taken up in pentane, and the precipitated inorganic salts were separated off by filtration. The solvent was removed in vacuo, and the raw product that remained was purified by column chromatography (Al₂O₃, CH₂Cl₂). By recrystallization of the isolated product from ethyl acetate or methanol at −20° C. overnight, the rac diastereomer was obtained as a colorless solid and isolated by filtration (62%).

¹H-NMR (300.1 MHz, CDCl₃): δ_{H}=5.94 (d, ³J_{HH}=5.9 Hz, 2H), 5.61 (d, ³J_{HH}=5.8 Hz, 2H), 4.49 (d, ⁴J_{HH}=2.2 Hz, 2H), 4.31 (d, ⁴J_{HH}=2.1 Hz, 2H), 2.92 (d, ²J_{HH}=14.3 Hz, 2H), 2.83 (d, ²J_{HH}=14.4 Hz, 2H), 2.39 (sept, ³J_{HH}=6.7 Hz, 2H), 2.06 (s, 6H), 1.88 (s, 6H), 1.05 (dd, ³J_{HH}=6.8 Hz, ⁴J_{HH}=1.8 Hz, 12H) ppm; ¹³C-NMR (75.5 MHz, CDCl₃): δ_{C}=146.52 (s, 2C), 135.82 (s, 2C), 122.95 (s, 2C), 120.33 (s, 2C), 90.47 (s, 2C), 86.15 (s, 2C), 84.29 (s, 2C), 73.82 (s, 2C), 68.14 (s, 2C), 36.50 (s, 2C), 27.23 (s, 2C), 23.24 (s, 2C), 21.94 (s, 2C), 21.64 (s, 2C), 12.06 (s, 2C) ppm; HR-MS (EI(+)): m/z [RuC₃₀H₃₈] detected: 500.1545 [M], calculated: 500.1871; Elemental analysis calculated (%) for C₃₀H₃₈Ru (499.71 g/mol): C, 72.11; H, 8.08; N, 7.67; detected: C, 71.98, H, 7.59; IR (KBr compact): \tilde{v}=2995 (w), 2958 (s), 2895 (m), 2965 (m), 1631 (w), 1598 (w), 1481 (w), 1461 (s), 1447 (s), 1366 (m), 1343 (w), 1310 (w), 1278 (w), 1193 (w), 1180 (w), 1159 (w), 1140 (w), 1107 (w), 1094 (w), 1077 (w), 1043 (m), 1026 (s), 953 (m), 891 (w), 860 (w), 841 (w), 827 (s), 815 (vs), 803 (s), 761 (w), 694 (m), 677 (w), 657 (w), 588 (m), 549 (w), 535 (m), 466 (w), 428 (s), 411 (w) cm¹.

### Example 4: Preparation of Ru(Cp*)(GuaH)

Li(GuaH) (200 mg, 0.97 mmol, 1.0 eq.) and [Ru(Cp*)Cl]4 (264 mg, 0.24 mmol, 0.25 eq.) were stirred in THF (20 mL) for 20 h at room temperature. The solvent was removed in vacuo. The residue was taken up in dichloromethane, and the precipitated inorganic salts were separated off by filtration. The solvent was removed in vacuo, and the raw product that remained was purified by column chromatography (Al₂O₃, CH₂Cl₂). The fraction which caused a yellow band contained the desired product. Ru(Cp*)(GuaH) was isolated as a brown oil after removal of the solvent in vacuo.

¹H-NMR (300.1 MHz, C₆D₆): δ_{H}=6.05 (d, J=6.8 Hz, 1H), 5.74 (d, J=6.2 Hz, 1H), 4.21 (d, J=2.3 Hz, 1H), 3.98 (d, J=2.3 Hz, 1H), 2.86 (d, J=4.4 Hz, 1H), 2.38 (m, J=5.6 Hz, 1H), 1.79 (s, 1H), 1.78 (s, 1H), 1.07 (s, 1H), 1.05 (s, 1H) ppm; HR-MS (FD(+)): m/z [RuC₂₅H₃₄] detected: 436.1721 [M], calculated: 436.1637.

### Example 5: Preparation of [Ru(p-cymene)(GuaH)]PF₆

The reactant [Ru(MeCN)₂(p-cymene)Cl]PF₆ was prepared according to the following literature specifications: F. B. McCormick, D. D. Cox, W. B. Gleason, Organometallics 1993, 12, 610-612; S. B. Jensen, S. J. Rodger, M. D. Spicer, J. Organomet. Chem. 1998, 556, 151-158; L. Biancalana et al., New J. Chem. 2018, 42, 17574-17586.

Li(GuaH) (200 mg, 0.97 mmol, 1.0 eq.) and [Ru(MeCN)₂(p-cymene)Cl]PF₆ (353 mg, 0.97 mmol, 1.0 eq.), produced from [Ru(p-cymene)RuCl)₂]₂ were stirred in THF (20 mL) for 20 h at room temperature. The solvent was removed in vacuo, and the residue was taken up in dichloromethane to precipitate the inorganic salts and separate them off by filtration. The solvent was removed and the raw product was taken up in acetonitrile. The concentrated solution was overlaid with diethyl ether and stored at 0° C. overnight. The product precipitated as a colorless solid and was isolated by filtration (69%).

¹H-NMR (300.1 MHz, DMSO-d₆): δ_{H}=6.25 (d, ³J_{HH}=6.1 Hz, 1H), 6.21 (d, ³J_{HH}=6.2 Hz, 1H), 6.15 (d, ³J_{HH}=6.1 Hz, 1H), 6.09 (d, ³J_{HH}=6.1 Hz, 1H), 6.03 (d, ³J_{HH}=6.0 Hz, 1H), 5.74 (d, ³J_{HH}=6.0 Hz, 1H), 5.40 (d, ⁴J_{HH}=2.3 Hz, 1H), 5.25 (d, ⁴J_{HH}=2.2 Hz, 1H), 3.14 (d, ²J_{HH}=14.4 Hz, 1H), 2.69 (sept, ³J_{HH}=6.9 Hz, 1H), 2.62 (d, ²J_{HH}=15.0 Hz, 1H), 2.42 (sept, ³J_{HH}=6.7 Hz, 1H), 2.14 (s, 1H), 2.05 (s, 1H), 1.21 (d, ³J_{HH}=4.7 Hz, 3H), 1.19 (d, ³J_{HH}=4.7 Hz, 6H), 1.02 (t, ³J_{HH}=6.0 Hz, 6H) ppm; ¹³C-NMR (75.5 MHz, DMSO-d₆): δ_{C}=147.35 (s, 1C), 130.53 (s, 1C), 128.96 (s, 1C), 120.96 (s, 1C), 111.30 (s, 1C), 101.19 (s, 1C), 99.83 (s, 1C), 95.49 (s, 1C), 95.20 (s, 1C), 88.08 (s, 1C), 87.79 (s, 1C), 84.98 (s, 1C), 84.87 (s, 1C), 80.62 (s, 1C), 75.24 (s, 1C), 36.07 (s, 1C), 31.49 (s, 1C), 26.04 (s, 1C), 23.58 (s, 1C), 23.20 (s, 1C), 22.77 (s, 1C), 21.87 (s, 1C), 21.68 (s, 1C), 18.06 (s, 1C), 12.21 (s, 1C) ppm; HR-MS (FD(+)): m/z [RuC₂₅H₃₃⁺] detected: 435.1619 [M], calculated: 435.1553; Elemental analysis calculated (%) for C₂₅H₃₃F₆PRu (579.57 g/mol): C, 51.81; H, 5.74; detected: C, 51.72, H, 5.63; IR (KBr compact): \tilde{v}=2968 (w), 1478 (w), 1447 (w), 1390 (w), 1059 (vw), 908 (w), 884 (m), 834 (vs), 696 (vw), 679 (vw), 590 (w), 557 (s), 523 (vw), 449 (w), 421 (m) cm⁻¹.

### Example 6: Preparation of Co(GuaH)₂

A Suspension of Li(GuaH) (500 mg, 2.42 mmol, 2.0 eq.) and COCl₂ (157 mg, 1.21 mmol, 1.0 eq.) were stirred in diethyl ether (40 mL) for 4 h at room temperature. A green-blue solution was obtained. The inorganic salts were separated off by filtration. Co (GuaH)₂ was isolated as green-blue oil.

### Example 7: Preparation of [Co(GuaH)₂]PF₆

For the synthesis of [Co(GuaH)₂]PF₆, a method was developed based on that of Vanicek et al. (Vanicek, S.; Kopacka, H.; Wurst, K.; Müller, T.; Schottenberger, H.; Bildstein, B., Organometallics 2014, 33, 1152-1156) and Bockman and Kochi (Bockman, T. M.; Kochi, J. K., J. Am. Chem. Soc. 1989, 111, 4669-4683):

A Suspension of Li(GuaH) (500 mg, 2.42 mmol, 2.0 eq.) and CoCl₂ (157 mg, 1.21 mmol, 1.0 eq.) were stirred in diethyl ether (40 mL) for 4 h at room temperature. A green-blue solution was obtained. The inorganic salts were separated off by filtration. Hot water (50 mL) was added to the filtrate, and the reaction mixture was stirred for 18 h. After separation of a brown solid, a yellow aqueous solution was obtained which contained the product. The brown solid was washed several times with water. The combined aqueous solutions were washed twice with diethyl ether, decolorized with activated carbon. The aqueous solution was concentrated on a rotary evaporator to a minimum of volume (10 mL). An aqueous solution of KPF₆ (334 mg in 20 mL H₂O, 1.81 mmol, 1.5 eq.) was added, and crystallization was facilitated by cooling in an ice bath. The raw yellow product was separated off by filtration, washed thoroughly, once with ice water and twice with diethyl ether, and dried in vacuo. After recrystallization from acetonitrile, overlaid with ethyl acetate, [Co(GuaH)₂]PF₆ was separated off by filtration and dried in vacuo (60%).

¹H-NMR (300.1 MHz, CDCl₃): δ_{H}=6.47 (d, ³J_{HH}=6.5 Hz, 2H), 5.77 (d, ³J_{HH}=6.5 Hz, 2H), 5.45 (br s, 2H), 5.36 (br s, 2H), 3.08 (d, ²J_{HH}=14.1 Hz, 2H), 2.78 (d, ²J_{HH}=14.1 Hz, 2H), 2.44 (sept., ³J_{HH}=6.1 Hz, 2H), 2.24 (s, 6H), 1.96 (s, 6H), 1.06 (m, 12H) ppm; ¹³C NMR (75.5 MHz, CDCl₃): δ_{C}=145.37 (s, 2C), 133.08 (s, 2C), 128.36 (s, 2C), 121.31 (s, 2C), 102.63 (s, 2C), 96.96 (s, 2C), 94.78 (s, 2C), 83.27 (s, 2C), 77.81 (s, 2C), 36.55 (s, 2C), 26.05 (s, 2C), 23.16 (s, 2C), 21.70 (s, 2C), 21.43 (s, 2C), 10.64 (s, 2C) ppm; HR-MS (FD(+)): m/z [CoC₃₀H₃₈⁺] detected: 457.23157, calculated: 457.23055; Elemental analysis calculated (%) for CoC₃₀H₃₈PF₆ (602.53 g/mol): C, 59.80; H, 6.36; detected: C, 59.67, H, 6.24; IR (KBr compact): \tilde{v}=2964 (w), 1465 (w), 1386 (w), 1363 (w), 1285 (w), 1187 (vw), 1084 (vw), 1043 (vw), 958 (vw), 922 (vw), 876 (m), 832 (vs), 699 (vw), 614 (w), 594 (m), 457 (w), 422 (w) cm⁻¹.

### Note:

The preparation of [Co(GuaH)₂]PF₆ can be carried out in a similar manner starting from isolated Co(GuaH)₂.

### Example 8: Preparation of Rh(nbd)(GuaH)

Li(GuaH) (200 mg, 0.97 mmol, 1.0 eq.) and [Rh(nbd)Cl]2 (224 mg, 0.48 mmol, 0.5 eq.) were stirred in THF (20 mL) for 20 h at room temperature. The solvent was removed in vacuo and the residue was taken up in dichloromethane, diethyl ether or pentane to precipitate the inorganic salts and separate them off by filtration. The solvent was removed and the oily product was stored in the refrigerator for a couple of days. Rh(nbd)(GuaH) was then present as a yellow solid (quantitative yield).

¹H-NMR (300.1 MHz, DMSO-d₆): δ_{H}=5.80 (d, ³J_{HH}=6.3 Hz, 1H), 5.60 (d, ³J_{HH}=6.2 Hz, 1H), 5.29 (d, ⁴J_{HH}=2.5 Hz, 1H), 4.83 (d, ⁴J_{HH}=2.7 Hz, 1H), 3.32 (m, 2H), 2.91 (m, 6H), 2.39 (sept, ³J_{HH}=6.1 Hz, 1H), 1.99 (s, 3H), 1.84 (s, 3H), 1.03 (m, 6H), 0.84 (m, 2H) ppm; ¹³C-NMR (126 MHz, DMSO-d₆): δ_{C}=146.80 (s, 1C), 144.09 (s, 1C), 132.97 (s, 1C), 129.54 (s, 1C), 121.25 (s, 1C), 119.88 (s, 1C), 112.13 (s, 1C), 103.97 (d, ¹J_{RhC}=4.5 Hz, 1C), 99.92 (d, ¹J_{RhC}=4.1 Hz, 1C), 95.40 (d, ¹J_{RhC}=4.3 Hz, 1C), 85.18 (d, ¹J_{RhC}=4.6 Hz, 1C), 77.36 (d, ¹J_{RhC}=4.6 Hz, 1C), 56.10 (d, ¹J_{RhC}=6.9 Hz, 1C), 46.40 (d, ¹J_{RhC}=2.4 Hz, 1C), 35.75 (s, 1C), 32.40 (d, ¹J_{RhC}=10.3 Hz, 1C), 31.89 (d, ¹J_{RhC}=10.2 Hz, 1C), 26.34 (s, 1C), 23.37 (s, 1C), 21.73 (s, 1C), 21.63 (s, 1C), 11.50 (s, 1C) ppm; HR-MS (FD(+)): m/z [RhC₂₂H₂₇] detected: 394.11539 [M], calculated: 394.11678; Elemental analysis calculated (%) for RhC₂₂H₂₇ (394.36 g/mol): C, 67.00; H, 6.90; detected: C, 66.87, H, 6.86; IR (KBr compact): \tilde{v}=3041 (w), 3027 (w), 2991 (m), 2955 (m), 2923 (s), 2886 (m), 2860 (m), 2842 (m), 1627 (w), 1588 (m), 1456 (m), 1444 (m), 1435 (m), 1407 (w), 1370 (m), 1295 (m), 1276 (w), 1261 (w), 1224 (w), 1196 (w), 1172 (w), 1158 (w), 1101 (w), 1086 (w), 1051 (w), 1044 (w), 1028 (m), 1019 (m), 992 (w), 958 (w), 923 (w), 910 (w), 890 (w), 857 (w), 837 (s), 810 (vs), 792 (s), 779 (s), 764 (m), 757 (m), 691 (w), 660 (w), 619 (w), 587 (w), 556 (w), 531 (w), 507 (w), 494 (w), 472 (w), 440 (w) cm¹.

### Example 9: Preparation of Rh(cod)(GuaH)

Li(GuaH) (200 mg, 0.97 mmol, 1.0 eq.) and [Ru(Cp*)Cl]2 (239 mg, 0.48 mmol, 0.5 eq.) were stirred in THF (20 mL) for 20 h at room temperature. The solvent was removed in vacuo and the residue was taken up in dichloromethane, diethyl ether or pentane to precipitate the inorganic salts and separate them off by filtration. The solvent was removed and the oily product was stored in the refrigerator for a couple of days. Rh(nbd)(GuaH) was then present as a yellow solid (quantitative yield).

¹H-NMR (300.1 MHz, DMSO-d₆): δ_{H}=5.99 (d, ³J_{HH}=5.8 Hz, 1H), 5.77 (d, ³J_{HH}=6.3 Hz, 1H), 5.08 (d, ⁴J_{HH}=2.6 Hz, 1H), 4.70 (d, ⁴J_{HH}=2.7 Hz, 1H), 3.69 (m, 2H), 3.63 (m, 2H), 2.85 (d, ²J_{HH}=14.1 Hz, 1H), 2.71 (d, ²J_{HH}=14.1 Hz, 1H), 2.34 (sept, ³J_{HH}=6.7 Hz, 1H), 2.24 (m, 4H), 2.10 (s, 3H), 2.00 (m, 4H), 1.76 (s, 3H), 1.03 (dd, ³J_{HH}=6.8 Hz, ⁴J_{HH}=0.6 Hz, 6H) ppm; ¹³C-NMR (75.5 MHz, DMSO-d₆): δ_{C}=143.98 (s, 1C), 132.98 (s, 1C), 122.55 (s, 1C), 120.89 (s, 1C), 106.74 (d, ¹J_{RhC}=3.9 Hz, 1C), 100.76 (d, ¹J_{RhC}=3.2 Hz, 1C), 97.40 (d, ¹J_{RhC}=3.7 Hz, 1C), 87.54 (d, ¹J_{RhC}=4.1 Hz, 1C), 79.86 (d, ¹J_{RhC}=4.2 Hz, 1C), 68.14 (d, ¹J_{RhC}=14.0 Hz, 2C), 67.88 (d, ¹J_{RhC}=14.1 Hz, 2C), 36.83 (s, 1C), 33.15 (s, 2C), 32.73 (s, 2C), 26.56 (s, 1C), 23.56 (s, 1C), 22.07 (s, 1C), 21.99 (s, 1C), 11.41 (s, 1C) ppm; HR-MS (FD(+)): m/z [RhC₂₃H₃₁] detected: 410.1484 [M], calculated: 410.1408; Elemental analysis calculated (%) for RhC₂₃H₃₁ (410.41 g/mol): C, 67.31; H, 7.61; detected: C, 67.12, H, 7.60; IR (KBr compact): \tilde{v}=2996 (w), 2982 (m), 2962 (s), 2952 (s), 2932 (s), 2910 (s), 2889 (s), 2862 (s), 2820 (s), 1587 (m), 1444 (s), 1405 (m), 1380 (m), 1371 (m), 1358 (m), 1320 (m), 1294 (m), 1279 (w), 1261 (w), 1235 (w), 1201 (m), 1179 (m), 1153 (m), 1080 (m), 1045 (m), 1026 (m) 992 (m), 955 (m), 884 (w), 868 (s), 841 (s), 813 (vs), 791 (s), 776 (m), 762 (m), 693 (w), 678 (w), 580 (w), 537 (w), 485 (w), 469 (w), 437 (w) cm⁻¹.

### Example 10: Preparation of [Rh(Cp*)(GuaH)]PF₆

Li(GuaH) (200 mg, 0.97 mmol, 1.0 eq.) and [RhCp*Cl₂]₂ (300 mg, 0.48 mmol, 0.5 eq.) were stirred in THF (20 mL) for 20 h at room temperature. NH₄PF₆ was then added and the reaction mixture was stirred for a further 2 h. The solvent was removed in vacuo and the residue was taken up in dichloromethan to precipitate and then separate off NH₄Cl by filtration. The solvent of the filtrate was removed in vacuo. The resulting yellow product was obtained in good yield (72%) after washing with pentane and diethyl ether. [Rh(Cp*)(GuaH)]PF₆ was recrystallized from a concentrated solution in dichloromethane, overlaid with pentane, and obtained in the form of yellow crystalline blocks. These were separated off by filtration and dried in vacuo.

¹H-NMR (300.1 MHz, DMSO-d₆): δ_{H}=6.34 (d, ³J_{HH}=6.3 Hz, 1H), 5.76 (d, ³J_{HH}=6.2 Hz, 1H), 5.68 (d, ⁴J_{HH}=2.4 Hz, 1H), 5.46 (d, ⁴J_{HH}=2.0 Hz, 1H), 3.17 (d, ²J_{HH}=14.4 Hz, 1H), 2.44 (sept, ³J_{HH}=7.0 Hz, 1H), 2.40 (d, ²J_{HH}=13.8 Hz, 2H), 2.03 (s, 3H), 1.97 (s, 3H), 1.94 (s, 15H), 1.03 (t, ³J_{HH}=6.7 Hz, 6H) ppm; ¹³C-NMR (75.5 MHz, DMSO-d₆): δ_{C}=145.71 (s, 1C), 129.49 (s, 1C), 127.89 (s, 1C), 120.35 (s, 1C), 105.62 (d, ¹J_{RhC}=7.0 Hz, 1C), 99.63 (d, ¹J_{RhC}=7.8 Hz, 5C), 98.77 (d, ¹J_{RhC}=6.9 Hz, 1C), 96.07 (d, ¹J_{RhC}=6.5 Hz, 1C), 88.10 (d, ¹J_{RhC}=7.5 Hz, 1C), 81.81 (d, ¹J_{RhC}=7.6 Hz, 1C), 35.59 (s, 1C), 24.08 (s, 1C), 21.36 (s, 1C), 21.19 (s, 1C), 21.10 (s, 1C), 9.49 (s, 1C), 8.99 (s, 5C), ppm; HR-MS (FD(+)): m/z [RhC₂₅H₃₄] detected: 437.17261 [M], calculated: 437.17155; Elemental analysis calculated (%) for RhC₂₅H₃₄PF₆ (582.42 g/mol): C, 51.56; H, 5.88; detected: C, 51.52, H, 5.84;

IR (KBr compact): \tilde{v}=2960 (w), 1464 (w), 1385 (w), 1031 (vw), 874 (w), 836 (vs), 764 (w), 739 (w), 699 (w), 611 (w), 591 (w), 557 (s), 506 (w), 492 (w), 462 (w), 438 (w) cm⁻¹.

### Example 11: Preparation of PtMe₃(GuaH)

Li(GuaH) (500 mg, 2.42 mmol, 1.0 eq,) and [PtMe₃I]4 (890 mg, 0.61 mmol, 0.25 eq,) were suspended in diethyl ether (40 mL), and the suspension was stirred at 40° C. for 30 min, then at room temperature for 4 h. A yellow solution was obtained. The solvent was removed in vacuo. It is very important to remove the solvent completely, because otherwise lithium iodide remains in solution and contamination of the product cannot be ruled out. The oily residue is taken up in pentane (40 mL), and inorganic salts and any unreacted reactants are separated off by filtration. The solvent of the filtrate is removed in vacuo, and PtMe₃(GuaH) is obtained as a yellow oil in good yield (82%). Further purification of the product can be carried out by means of column chromatography (silica, hexane).

¹H-NMR (300.1 MHz, DMSO-d₆): δ_{H}=6.00 (d, ³J_{HH}=6.3 Hz, 1H), 5.73 (d, ⁴J_{HH}=2.8 Hz, 1H), 5.56 (d, ³J=6.2 Hz, 1H,), 5.38 (d, ³J=3.0 Hz, 1H), 2.98 (d, ²J_{HH}=14.3 Hz, 1H), 2.53 (d, 1H, ²J_{HH}=14.3 Hz, 1H), 2.40 (sept, ³J_{HH}=6.8 Hz, 1H), 1.94 (s, 3H), 1.90 (s, 3H), 1.03 (d, ³J_{HH}=6.8 Hz, 3H), 1.01 (d, ³J_{HH}=6.8 Hz, 3H), 0.66 (s, J_{195Pt-1H}=80.8 Hz, 9H, PtMe₃) ppm; ¹³C-NMR (75.5 MHz, DMSO-d₆): δ_{C}=144.79 (s, 1C), 130.01 (s, 1C), 123.75 (s, 1C), 119.74 (s, 1C), 110.77 (s, 1C), 106.83 (s, 1C), 106.18 (s, 1C), 91.60 (s, 1C), 90.04 (s, 1C), 35.81 (s, 1C), 24.10 (s, 1C), 22.06 (s, 1C), 21.56 (s, 1C), 21.26 (s, 1C), 9.54 (s, 1C), −14.76 (PtMe₃); HR-MS (FD(+)): m/z [PtC₁₈H₂₈] detected: 439.18065 [M], calculated: 439.18387; IR (KBr compact): \tilde{v}=2957 (vs), 2891 (vs), 2809 (m), 1634 (vw), 1598 (w), 1461 (m), 1431 (m), 1376 (m), 1359 (s), 1314 (s), 1285 (m), 1251 (w), 1210 (w), 1192 (s), 1095 (w), 1081 (w), 1028 (s), 998 (s), 955 (s), 886 (vs), 839 (m), 812 (w), 786 (w), 759 (w), 693 (w), 673 (w), 653 (w), 583 (w), 555 (s), 533 (m), 504 (w), 469 (w), 425 (m) cm⁻¹.

### Example 12: Preparation of [Pt(cod)(GuaH)]PF₆

Li(GuaH) (200 mg, 0.97 mmol, 1.0 eq.) and [Pt(cod)Cl₂] (363 mg, 0.97 mmol, 1.0 eq.) were stirred in THF (20 mL) for 24 h at room temperature. The reaction mixture changed color to orange during the reaction time. NH₄PF₆ was added. After further stirring for 2 h, the solvent was removed in vacuo, acetonitrile (20 mL) was added, and NH₄Cl was separated off by filtration. The solvent of the filtrate was removed in vacuo. [Pt(cod)(GuaH)]PF₆ was obtained as an orange solid in good yield (78%). [Pt(cod)(GuaH)]PF₆ can be recrystallized at −20° C. from THF overlaid with pentane.

¹H NMR (300.1 MHz, DMSO-d₆): δ_{H}=6.31 (d, ³J_{HH}=6.3 Hz, 1H), 6.30-6.14 (m, 2H), 5.83 (d, ³J_{HH}=6.4 Hz, 1H), 5.28-4.95 (m, 4H), 3.24 (d, ²J_{HH}=14.6 Hz, 1H), 2.78 (d, ²J_{HH}=14.6 Hz, 1H), 2.42 (m, 7H), 2.18 (s, 3H), 2.11 (s, 3H), 1.09 (d, ⁴J_{HH}=0.9 Hz, 3H), 1.07 (d, ⁴J_{HH}=0.9 Hz, 3H) ppm; ¹³C-NMR (75.5 MHz, DMSO-d₆): δ_{C}=146.36 (s, 1C), 128.54 (s, 1C), 127.40 (s, 1C), 120.63 (s, 1C), 115.07 (s, 1C), 111.05 (s, 1C), 109.92 (s, 1C), 93.42 (s, 1C), 87.76 (s, 1C), 82.72 (s, 2C), 81.73 (s, 2C), 35.72 (s, 1C), 31.90 (s, 1C), 31.56 (s, 2C), 24.92 (s, 1C), 22.19 (s, 1C), 21.39 (s, 1C), 21.37 (s, 1C), 10.14 (s, 1C) ppm; HR-MS (FD(+)): m/z [PtC₂₃H₃₁] detected: 501.20506 [M], calculated: 501.20524; Elemental analysis calculated (%) for PtC₂₃H₃₁PF₆ (647.55 5 g/mol): C, 42.66; H, 4.83; detected: C, 42.55, H, 4.78; IR (KBr compact): \tilde{v}=2964 (w), 1435 (w), 1386 (w), 1363 (w), 1285 (w), 1032 (vw), 874 (w), 826 (vs), 697 (w), 556 (s), 471 (vw) cm⁻¹.

### Example 13: Preparation of Cu(PPh₃)(GuaH)

Li(GuaH) (200 mg, 0.97 mmol, 1.0 eq,) and [Cu(PPh₃)Cl]4 (350 mg, 0.24 mmol, 0.25 eq,) were stirred in THF at −78° C. for about 3 h. The reaction mixture was slowly warmed to room temperature overnight while stirring. In the process, it changed color to green-yellow. The solvent was removed in vacuo, and diethyl ether was added to precipitate and separate off inorganic salts by filtration. The solvent of the filtrate was removed in vacuo. The residue was washed with pentane, and Cu(PPh₃)(GuaH) pale yellow solid was obtained in near quantitative yield.

¹H NMR (300.1 MHz, C₆D₆): δ_{H}=7.35 (m, 6H), 6.99 (m, 9H), 6.22 (d, ³J_{HH}=3.0 Hz, 1H), 6.17 (d, ³J_{HH}=3.0 Hz, 1H), 6.06 (dd, ³J_{HH}=6.3 Hz, ⁴J_{HH}=2.4 Hz, 1H), 5.85 (d, ³J_{HH}=6.2 Hz, 1H), 3.33 (d, ²J_{HH}=15.1 Hz, 1H), 3.23 (d, ²J_{HH}=15.1 Hz, 1H), 2.45 (s, 3H), 2.38 (s, 3H), 2.33 (sept, ³J_{HH}=6.8 Hz, 1H), 0.95 (d, ³J_{HH}=6.8 Hz, 3H), 0.90 (d, ³J_{HH}=6.8 Hz, 3H) ppm; ¹³C-NMR (75.5 MHz, C₆D₆): δ_{C}=145.04 (s, 1C), 135.27 (s, 3C), 134.07 (d, ²J_{PC}=15.8 Hz, 6C), 133.37 (d, ¹J_{PC}=43.5 Hz, 3C), 130.35 (s, 1C), 128.76 (d, 3J_{PC}=10.4 Hz, 6C), 120.94 (s, 1C), 118.50 (s, 1C), 116.14 (s, 1C), 115.42 (s, 1C), 103.64 (s, 1C), 94.73 (s, 1C), 89.24 (s, 1C), 37.11 (s, 1C), 28.17 (s, 1C), 24.43 (s, 1C), 22.32 (s, 1C), 22.11 (s, 1C), 13.19 (s, 1C) ppm; HR-MS (FD(+)): m/z [C₃₃H₃₄CuP] detected: 524.17053 [M], calculated: 524.16941; Elemental analysis calculated (%) for C₃₃H₃₄CuP (525.15 g/mol): C, 75.48; H, 6.53; detected: C, 75.34, H, 6.49; IR (KBr compact): \tilde{v}=2963 (m), 2871 (w), 1632 (w), 1593 (w), 1464 (m), 1435 (m), 1385 (m), 1362 (m), 1315 (w), 1284 (w), 1246 (w), 1199 (w), 1186 (w), 1083 (w), 1043 (w), 1029 (w), 996 (w), 958 (w), 872 (m), 798 (vs), 696 (m), 592 (w), 548 (m), 499 (w), 455 (w), 420 (w) cm⁻¹.

### Example 14: Preparation of Zn(Mes)(GuaH)

Li(GuaH) (200 mg, 0.97 mmol, 1.0 eq,) and ZnCl₂ (66 mg, 0.48 mmol, 0.5 eq,) were suspended in THF (20 mL) and stirred at room temperature for 24 h. A yellow solution was obtained. The inorganic salts were separated off by filtration. ZnMes₂ (146 mg, 0.48 mmol, 0.5 eq,) was added to the filtrate, which contained the desired zinconcene-type intermediate Zn(GuaH)₂. The reaction mixture was stirred for 3 h before the solvent was removed in vacuo. The residue was taken up in pentane, and the solution was stored overnight at −80° C. to precipitate any unreacted Zn(GuaH)₂ and ZnMes₂. After filtration through a syringe filter, the solvent of the filtrate was removed in vacuo. Zn(Mes)(GuaH) was obtained as yellow-orange oil in good yield (80%).

¹H-NMR (300.1 MHz, C₆D₆): δ_{H}=6.78 (s, 1H), 6.02 (q, ⁴J_{HH}=2.4 Hz, 1H), 6.00 (d, ⁴J_{HH}=3.1 Hz, 1H), 5.97 (d, ⁴J_{HH}=3.0 Hz, 1H), 5.71 (d, ³J_{HH}=6.2 Hz, 1H), 3.12 (d, ²J_{HH}=14.0 Hz, 1H), 2.86 (d, ²J_{HH}=14.0 Hz, 1H), 2.27 (sept, ³J_{HH}=6.8 Hz, 1H), 2.20 (s, 3H), 2.17 (s, 3H), 2.16 (s, 6H), 0.91 (t, ³J_{HH}=6.4 Hz, 6H) ppm; ¹³C-NMR (75.5 MHz, C₆D₆): δ_{C}=147.11 (s, 1C), 145.64 (s, 1C), 140.55 (s, 1C), 137.27 (s, 2C), 133.54 (s, 1C), 126.18 (s, 2C), 122.72 (s, 1C), 122.07 (s, 1C), 120.94 (s, 1C), 119.82 (s, 1C), 110.58 (s, 1C), 101.31 (s, 1C), 93.76 (s, 1C), 36.98 (s, 1C), 28.42 (s, 1C), 27.01 (s, 2C), 23.88 (s, 1C), 22.05 (s, 1C), 22.03 (s, 1C), 21.25 (s, 1C), 12.18 (s, 1C) ppm; HR-MS (FD(+)): m/z [C₂₄H₃₀Zn] detected: 382.16545 [M], calculated: 382.16390; IR (KBr compact): \tilde{v}=2957 (s), 2914 (s), 2865 (m), 2724 (w), 1631 (w), 1594 (w), 1553 (w), 1443 (s), 1373 (m), 1359 (w), 1335 (w), 1313 (w), 1288 (w), 1236 (w), 1193 (w), 1081 (s), 953 (m), 844 (s), 815 (s), 771 (s), 756 (vs), 702 (m), 659 (w), 619 (w), 584 (w), 564 (w), 537 (m), 484 (w), 468 (w), 418 (w).

### Example 15: Photohydrosilylation of 1-Octene with Pentamethylsiloxane Using PtMe₃ (GuaH) as Catalyst

To a solution of PtMe₃(GuaH) (cf. Example 11) in cyclohexane (25 mL; 10 ppm=2.5×10⁻⁵ mol/L) were added 661 mg of pentamethylsiloxane (4.45 mmol) and 500 mg 1-octene (4.45 mmol). The solution was irradiated with UV light with stirring for 30 min, and then stirred for a further 18 h. The raw product was purified by column chromatography (hexane). According to ¹H NMR spectrum, the isolated product had no impurities.

Yield according to ¹H NMR spectrum (before purification): quantitative; isolated yield about 80%.

NMR experiments with 5 ppm Pt:

### Stock Solution (1.78 M):

500 mg 1-octene (4.45 mmol), 661 mg pentamethylsiloxane (4.45 mmol), 2.5 mL C₆D₆

Pt complex solution (0.0889 mM=0.0005 mol % compared to stock solution):

0.391 mg PtMe₃(GuaH), 5 mL C₆D₆

0.25 mL stock solution and 0.25 mL Pt complex solution were filled into an NMR tube. The tube was shaken and then irradiated with UV light (Osram Ultra Vitalux, 300 W, 220 V, plant lamp) for 5 min. ¹H NMR spectra were recorded at time 0 h and after about 0.25 h, 0.50 h, 1 h, 2 h, 4 h, 8 h, 24 h and 48 h.

The invention is not limited to one of the embodiments described above but may be modified in many ways.

It can be seen that the invention relates to a method for preparing compounds of the general formula M^{A}Yₙ(AzuH) (I), where M^{A}=alkali metal, Y=neutral ligand, n=0, 1, 2, 3, or 4 and AzuH is azulene (bicyclo[5.3.0]decapentaene) or an azulene derivative that bears a hydride anion H⁻ in the 4, 6 or 8 position in addition to an H atom. The invention additionally provides compounds obtainable by this method, and a method using such compounds for preparation of complexes of metals of groups 6 to 12. The invention further relates to complexes of middle transition metals (groups 6, 7 and 8) and later transition metals (groups 9, 10, 11 and 12) which each have at least one H-dihydroazulenyl anion (AzuH)¹⁻, and to the use of all the aforementioned transition metal complexes as precatalysts or catalysts or electron transfer reagents in a chemical reaction or as precursor compounds for production of a layer containing a metal M, or of a metal layer consisting of the metal M, especially on at least one surface of a substrate. The invention also provides a substrate obtainable by such a method, i.e., using a metal complex according to one of the formulae M(L_{K})_{f}(AzuH)ₘ (III), M(L_{N})(AzuH)_{q}(IV), [M(L_{S})_{g}(AzuH)ᵥ]X (V) and [M(L_{T})(AzuH)_{z}]X (VI).

The method described allows defined alkali metal H-dihydroazulenyl compounds of the type M^{A}Yₙ(AzuH) (I) to be prepared in a simple, cost-effective and reproducible manner in high purity and good yield. The method can also be carried out on an industrial scale. After their isolation, without complex purification, the compounds usually do not have any NMR spectroscopically detectable impurities. Owing to their high purity, they are suitable as reactants for the preparation of transition metal complexes, in particular of metals of group 6, group 7, group 8, group 9, group 10, group 11, and group 12. The method described herein allows such metal complexes of middle and late transition metals to be obtained in a simple, reproducible and comparatively cost-effective manner, and in good (isomeric) purity and good to very good yields. They are a relatively cost-effective and, and in some cases, particularly sustainable alternative to metal complexes containing cyclopentadienyl ligands. This applies in particular to use as precatalysts, catalysts and electron transfer reagents in chemical reactions. Furthermore, they are particularly suitable as precursor compounds for preparing high-quality substrates which have at least one metal-containing layer or at least one metal layer on at least one surface. The metal or the metals are in this case selected from group 6, group 7, group 8, group 9, group 10, group 11, and group 12.

All features and advantages resulting from the claims, the description and the figures, including constructive details, spatial arrangements and method steps, can be essential to the invention, both in themselves and in the most diverse combinations.

1. A method for preparing compounds of the general formula
M^{A}Yₙ(AzuH) (I),
wherein
M^{A} is an alkali metal,
Y is a neutral ligand which is bonded or coordinated to M^{A} via at least one donor atom, wherein H₂O is excluded,
n=0, 1, 2, 3, or 4
and
AzuH=azulene or an azulene derivative that bears a hydride anion in the 4, 6 or 8 position in addition to an H atom,
wherein
Azu=azulene according to the formula 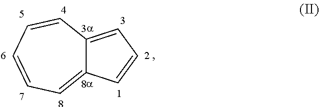
or
Azu=an azulene derivative having an azulene scaffold according to formula II consisting of a five-membered ring and a seven-membered ring,
wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom,
comprising the following steps:
A. providing
i. azulene or an azulene derivative having an azulene scaffold according to formula II consisting of a five-membered ring and a seven-membered ring,
wherein
at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
at least one carbon atom of the azulene scaffold, selected from the group consisting of the carbon atoms C4, C6 and C8, bears an H atom,
and
ii. at least one hydridic reducing agent Z,
B. reacting the azulene or the azulene derivative with the at least one hydride reducing agent Z in a solvent S_{P},
and
when using at least one alkali metal aluminum tetrahydride M^{A}AlH₄ as a first hydride reducing agent Z₁—
C. providing
i. at least one second hydride reducing agent Z₂ selected from the group consisting of alkali metal hydrides M^{A}H
and/or
ii. at least one electron pair donor E, wherein
the electron pair donor E has at least one donor atom,
wherein H₂O is excluded,
and
D. optionally adding a neutral ligand Y, if Y is not equal to S_{P} and Y is not equal to E.

2. The method according to claim 1, wherein at least one hydride reducing agent Z is selected from the group consisting of alkali metal hydrides M^{A}H, alkali metal borotetrahydrides M^{A}BH₄, alkali metal trialkylborohydrides M^{A}[(R)^{C})₃BH], alkali metal aluminum tetrahydrides M^{A}AlH₄, alkali metal trialkylaluminum hydrides M^{A}[(R)^{D})₃AlH], alkali metal dihydrido-bis(dialkoxy)aluminates M^{A}[AlH₂(OR^{E})₂], and mixtures thereof, wherein
i. the radicals R^{C} and R^{D} are each selected independently of one another from the group consisting of primary, secondary, tertiary alkyl, alkenyl and alkynyl radicals having 1 to 10 carbon atoms,
wherein in each case two substituents R^{C} or two substituents R^{D} can optionally form a ring,
and
ii. the radicals OR^{E} are each independently of one another a corresponding base of a glycol ether R^{E}OH.

3. The method according to claim 2, wherein the glycol ethers R^{E}OH are independently selected from the group consisting of monooxomethylene monoethers, monoethylene glycol monoethers, monopropylene glycol monoethers, and mixtures of isomers thereof, and mixtures thereof.

4. The method according to claim 1, wherein
the solvent S_{P} and the neutral ligand Y
and/or
the neutral ligand Y and the electron pair donor E
and/or
the solvent S_{P} and the electron pair donor E
are miscible or identical.

5. The method according to claim 1, wherein the electron pair donor E is a base selected from the group consisting of organic, organometallic and inorganic bases, and mixtures thereof.

6. The method according to claim 1, wherein in step A. an azulene derivative is provided, wherein at least
on the carbon atoms C4 and C6
or
on the carbon atoms C8 and C6
or
on the carbon atom C4 and/or on the carbon atom C8
of the azulene skeleton, an H atom is provided.

7. The method according to claim 1, wherein after the reaction in step B. or after step C., a step is carried out which comprises isolation of M^{A}Yₙ(AzuH) (I):
as a suspension or solution comprising M^{A}Yₙ(AzuH) (I) and at least one solvent S_{P},
or
as a liquid or solid.

8. A solution or suspension comprising M^{A}Yₙ(AzuH) (I) and at least one solvent S_{P}, obtained or obtainable by a method according to claim 1.

9. Compounds of the general formula M^{A}Yₙ(AzuH) (I), obtained or obtainable by a method according to claim 1.

10. Compounds of the general formula M^{A}Yₙ(AzuH) (I),
wherein
M^{A} is an alkali metal,
Y is a neutral ligand which is bonded or coordinated to M^{A} via at least one donor atom, wherein H₂O is excluded,
n=0, 1, 2, 3, or 4
and
AzuH=azulene or an azulene derivative that bears a hydride anion in the 4, 6 or 8 position in addition to an H atom,
wherein
Azu=azulene according to the formula 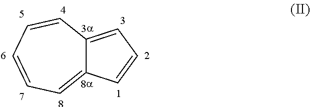
or
Azu=an azulene derivative having an azulene scaffold according to formula II consisting of a five-membered ring and a seven-membered ring,
wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom,
wherein
the compounds Li(O(C₂H₅)₂)ₙ(AzulenH) and Li(O(C₂H₅)₂)ₙ(GuaH),
wherein
n=0, 1 or 2,
AzulenH=azulene that bears a hydride anion in the 4, 6 or 8 position in addition to an H atom,
GuaH=7-isopropyl-1,4-dimethyl-8-H-dihydroazulene
are excluded.

11. Compounds according to claim 10, wherein Azu=an azulene derivative and the compound of the general formula M^{A}Yₙ(AzuH) (I) is isomerically pure.

12. Compounds according to claim 10, wherein Azu=an azulene derivative, and wherein at least the carbon atoms C1, C4 and C7 of the azulene skeleton bear a substituent R^{F}, and isomers thereof.

13. Compounds according to claim 10, wherein the alkali metal M^{A} is selected from the group consisting of Li, Na and K.

14. Compounds according to claim 10, wherein the neutral ligand Y is
a) an aprotic polar solvent
or
b) a crown ether
which is selected from the group consisting of macrocyclic polyethers and the aza-, phospha- and thia-derivatives thereof,
wherein an inner diameter of the crown ether and an ion radius of M^{A} correspond to each other.

15. Compound according to claim 10, having the formula 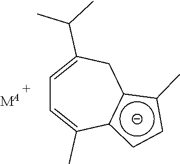
where M^{A} is an alkali metal, in particular selected from the group Li, Na or K.

16. A method for preparing metal complexes of the general formula
M(L_{K})_{f}(AzuH)ₘ (III)
or
M(L_{N})(AzuH)_{q} (IV)
or
[M(L_{S})_{g}(AzuH)ᵥ]X (V)
or
[M(L_{T})(AzuH)_{z}]X (VI),
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or 8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or monovalent weakly coordinating anion or monovalent non-coordinating anion,
wherein
Azu=azulene according to the formula 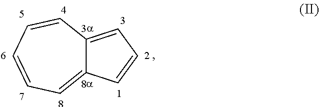
or
Azu=an azulene derivative which has an azulene skeleton according to formula II, consisting of a five-membered ring and a seven-membered ring, wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom,
using
a compound according to claim 1 having the general formula M^{A}Yₙ(AzuH) (I),
or
a solution or a suspension,
comprising a compound of the general formula M^{A}Yₙ(AzuH) (I) and at least one solvent S_{P},
wherein
M^{A} is an alkali metal,
Y is a neutral ligand which is bonded or coordinated to M^{A} via at least one donor atom, wherein H₂O is excluded,
n=0, 1, 2, 3, or 4
and
AzuH and Azu are as defined above,
comprising the steps of:
A. providing the compound of the general formula M^{A}Yₙ(AzuH) (I) or the solution or the suspension comprising the compound of the general formula M^{A}Yₙ(AzuH) (I) and the at least one solvent S_{P},
and
B. synthesis of the metal complex
M(L_{K})_{f}(AzuH)ₘ (III)
or
M(L_{N})(AzuH)_{q} (IV)
or
[M(L_{S})_{g}(AzuH)ᵥ]X (V)
or
[M(L_{T})(AzuH)_{z}]X (VI)
using the compound according to the general formula M^{A}Yₙ(AzuH) (I) as reactant.

17. The method according to claim 16, wherein the synthesis in step B comprises at least one salt metathesis reaction and/or at least one oxidation reaction.

18. The method according to claim 16, wherein M is selected from the group consisting of chromium, molybdenum, tungsten, manganese, technetium, rhenium, iron, ruthenium, osmium, cobalt, rhodium, iridium, nickel, palladium, platinum, copper, silver, gold, zinc, cadmium, and mercury.

19. The method according to claim 16, wherein
the ligands L_{K} and L_{S} are independently selected from the group consisting of monodentate and polydentate phosphorus donor ligands, alkenes, cyclic dienes and cyclic polyenes,
and mononuclear arenes, polynuclear arenes, mononuclear heteroarenes and polynuclear heteroarenes, and derivatives thereof,
and/or
the ligand L_{N} is a monoanionic ligand selected from the group consisting of anions of cyclopentadiene and derivatives thereof, alkyl anions, aryl anions and a fluoride anion
and/or
the ligand L_{T} is a monoanionic ligand selected from the group consisting of anions of cyclopentadiene and derivatives thereof and a fluoride anion, or a dianionic ligand.

20. Metal complexes of the general formula
M(L_{K})_{f}(AzuH)ₘ (III)
or
M(L_{N})(AzuH)_{q} (IV)
or
[M(L_{S})_{g}(AzuH)ᵥ]X (V)
or
[M(L_{T})(AzuH)_{z}]X (VI),
or
solutions or suspensions comprising a metal complex of the general formula
M(L_{K})_{f}(AzuH)ₘ (III)
or
M(L_{N})(AzuH)_{q} (IV)
or
[M(L_{S})_{g}(AzuH)ᵥ]X (V)
or
[M(L_{T})(AzuH)_{z}]X (VI)
and at least one solvent which is miscible with or identical to the solvent Sp,
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or 8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or monovalent weakly coordinating anion or monovalent non-coordinating anion,
wherein
Azu=azulene according to the formula 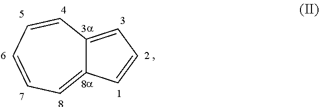
or
Azu=an azulene derivative which has an azulene skeleton according to formula II, consisting of a five-membered ring and a seven-membered ring, wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom,
obtained or obtainable according to a method according to claim 15.

21. Metal complexes of the general formula
M(L_{K})_{f}(AzuH)ₘ (III)
or
M(L_{N})(AzuH)_{q} (IV)
or
[M(L_{S})_{g}(AzuH)ᵥ]X (V)
or
[M(L_{T})(AzuH)_{z}]X (VI)
wherein
M=central metal atom selected from group 6, group 7, group 8, group 9, group 10, group 11, or group 12,
L_{K}=optional neutral sigma donor ligand or optional neutral pi donor ligand,
f=number of L_{K} ligands, where f=0, 1, 2, 3, 4, 5, or 6,
AzuH=azulene or an azulene derivative that bears a hydride anion in the 4, 6 or 8 position in addition to an H atom,
m=number of AzuH ligands, where m=1, 2, 3, 4, 5, 6, or 7,
L_{N}=at least one anionic sigma donor ligand or at least one anionic pi donor ligand, where a sum u of the negative charges of all L_{N} ligands is −1, −2, −3, −4, −5 or −6,
q=number of AzuH ligands, where q=w₂−|u|,
where w₂>|u| and w₂=2, 3, 4, 5, 6, or 7, and where |u| is an absolute value of the sum of the negative charges of all L_{N} ligands, where |u|=1, 2, 3, 4, 5, or 6,
L_{S}=optional neutral sigma donor ligand or optional neutral pi donor ligand,
g=number of L_{S} ligands, where g=0, 1, 2, 3, 4, 5, or 6,
v=number of AzuH ligands, where v=w₃−1, where w₃=2, 3, 4, 5, 6, or 7,
L_{T}=at least one anionic sigma donor ligand or at least one anionic pi donor ligand, where a sum h of the negative charges of all L_{T} ligands is −1, −2, −3, −4 or −5,
z=number of AzuH ligands, where z=w₄−(|h|+1), where w₄>(|h|+1) and w₄=3, 4, 5, 6, or 7, and where |h| is an absolute value of the sum of the negative charges of all L_{T} ligands, where |h|=1, 2, 3, 4, or 5,
X⁻=halide anion or monovalent weakly coordinating anion or monovalent non-coordinating anion,
wherein
Azu=azulene according to the formula 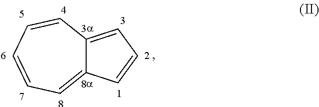
or
Azu=an azulene derivative which has an azulene skeleton according to formula II, consisting of a five-membered ring and a seven-membered ring, wherein
a) at least one carbon atom of the azulene scaffold selected from the group consisting of the carbon atoms C1, C2, C3, C4, C5, C6, C7 and C8, bears a substituent R^{F}
wherein the substituents R^{F} are selected independently of one another from the group consisting of primary, secondary, tertiary alkyl, alkenyl and alkynyl radicals having 1 to 10 carbon atoms, cyclic alkyl radicals having 3 to 10 carbon atoms, a benzyl radical, a mononuclear or polynuclear arene and a mononuclear or polynuclear heteroarene,
wherein two substituents R^{F} can optionally form a ring,
and
b) at least one carbon atom of the azulene scaffold, selected from the group consisting of the carbon atoms C4, C6 and C8, bears an H atom,
wherein the compound Fe(AzulenH)₂ and Cr(AzulenH)₂, and isomers thereof, are excluded.

22. Metal complex according to claim 20, comprising a metal complex and at least one solvent which is miscible with or identical to the solvent Sp, wherein the metal complex is selected from the group consisting of Fe(GuaH)₂, Ru(GuaH)₂, Ru(Cp*)(GuaH), [Ru(p-cymene)(GuaH)]PF₆, Co(GuaH)₂, [Co(GuaH)₂]PF₆, Rh(nbd)(GuaH), Rh(cod)(GuaH), [Rh(Cp*)(GuaH)]PF₆, PtMe₃(GuaH), [Pt(cod)(GuaH)]PF₆, Cu(PPh₃)(GuaH), Zn(GuaH)₂ and Zn(Mes)(GuaH).

23. A use of at least one metal complex according to claim 20, as a
i. pre-catalyst or pre-catalyst-containing solution or suspension in a chemical reaction
and/or
ii. catalyst or catalyst-containing solution or suspension in a chemical reaction
and/or
iii. electron transfer reagent or solution or suspension containing electron transfer reagent in a chemical reaction
and/or
iv. precursor compound, or solution or suspension containing precursor compound, for preparing at least one layer containing a metal M, or at least one metal layer consisting of the metal M on at least one surface of a substrate.

24. A method for carrying out a chemical reaction using at least one metal complex according to claim 20,
comprising the steps of:
A) providing
the at least one metal complex
or
the at least one solution or suspension comprising a metal complex and at least one solvent which is miscible with or identical to the solvent Sₚ,
and
B) carrying out the chemical reaction using the at least one metal complex as a precatalyst, as a catalyst or as an electron transfer reagent.

25. A method for preparing
i. at least one metal layer consisting of a metal M
or
ii. at least one layer containing a metal M,
on at least one surface of a substrate using at least one metal complex according to claim 20,
comprising the steps of:
A) providing
the at least one metal complex
or
the at least one solution or suspension comprising a metal complex and at least one solvent which is miscible with or identical to the solvent Sₚ,
and
B) depositing
i. the at least one metal layer consisting of the metal M
or
ii. the at least one layer containing the metal M,
on the at least one surface of the substrate using the metal complex as precursor compound.

26. The method according to claim 1,
where Azu=Gua=7-iso-propyl-1,4-dimethylazulene and AzuH=GuaH=7-iso-propyl-1,4-dimethyl-8-H-dihydroazulene.
